(19) United States
(12) Patent Application Publication
(10) Pub. No.: US 2014/0372133 A1
(43) Pub. Date: Dec. 18, 2014

(54) SYSTEM AND METHOD FOR INCENTIVE-BASED HEALTH IMPROVEMENT PROGRAMS AND SERVICES

(71) Applicant: RedBrick Health Corporation, Minneapolis, MN (US)

(72) Inventors: Kristin Austrum, St. Louis Park, MN (US); Kurt Cegielski, Stillwater, MN (US); David Dickey, Edina, MN (US); Kyle Rolfing, Edina, MN (US); Abir Sen, Minneapolis, MN (US); Patrick Sukhum, Minneapolis, MN (US)

(73) Assignee: RedBrick Health Corporation, Minneapolis, MN (US)

(21) Appl. No.: 14/159,878

(22) Filed: Jan. 21, 2014

Related U.S. Application Data
(63) Continuation of application No. 12/713,013, filed on Feb. 25, 2010, now abandoned.
Application No. 12/713,013 is a continuation of application No. 12/571,898, filed on Oct. 1, 2009, now abandoned.
(60) Provisional application No. 61/101,889, filed on Oct. 1, 2008.
(60) Provisional application No. 61/101,885, filed on Oct. 1, 2008.
(60) Provisional application No. 61/101,888, filed on Oct. 1, 2008.

(51) Int. Cl. G06F 19/00

(52) U.S. Cl. CPC G06F 19/3475
USPC 705/2

(57) ABSTRACT

The present disclosure relates to a system for healthcare services having a behavior-based financing framework. The system includes a computer for creating an incentive budget. The system also includes means for acquiring and understanding an individual's health status and an individualized health management map focusing on the individual's modifiable health conditions and lifestyle behaviors determined from the acquired health status and providing means for tracking the individual's progress toward improved health. An incentive program is provided that conforms to the incentive budget and provides incentives for the individual to engage in their health and well-being.

### CROSS-REFERENCE TO RELATED APPLICATIONS

This application is a continuation of U.S. Ser. No. 12/713,013 filed Feb. 25, 2010, which is a continuation of U.S. Ser. No. 12/571,898 filed Oct. 1, 2009, which claims priority to U.S. Provisional Pat. App. No. 61/101,889, “SYSTEM AND METHOD FOR CONSUMER-OWNED HEALTHCARE SERVICES”; U.S. Provisional Pat. App. No. 61/101,885, “INDIVIDUALIZED HEALTH MANAGEMENT MAP”; and U.S. Provisional Pat. App. No. 61/101,888, “SYSTEM AND METHOD FOR HEALTHCARE BASED INCENTIVES”, which were filed on Oct. 1, 2008, and which are hereby incorporated by reference herein in their entirety.

### FIELD OF THE INVENTION

The present disclosure relates to healthcare services, and particularly, systems and methods to design and administer incentive-based, consumer-owned healthcare services and management programs.

### BACKGROUND OF THE INVENTION

Unpredictable costs, unhealthy behavior, lost productivity, lack of personalized service, and disjointed health management programs continue to characterize the healthcare marketplace. For employers, the cost of providing healthcare has become staggering—over $9,600 annually per employee for larger organizations. About 50-70% of healthcare costs are directly related to discretionary and modifiable individual behavior. For most people, however, learning about and adopting healthier behaviors can require considerable and sometimes daunting amounts of internal motivation. Current health plans do little to help, providing little encouragement or incentive for individual change. For instance, an equitable financing structure remains absent from most health plans, unlike most other forms of insurance such as auto or home, where adopting less risky behavior may reduce premiums. Thus, individuals in group plans that choose not to take better care of their health are in effect subsidized by those that do, solidifying an unfair and unbalanced culture that lacks motivation and positive enforcement for improved health, and thus, fails to effectively manage healthcare costs.

Most healthcare cost solutions only use claim and health assessments to drive identification, stratification, predictive modeling, and gaps-in-care analyses. While this approach has had some success, it does not fully deliver on its intended goals.

Thus, there exists a need in the art for systems and methods for developing and administering consumer-owned healthcare services. Further, there exists a need in the art for systems and methods for designing and administering a behavior-based financing framework, wherein the individual or employee share of healthcare costs depends on how that individual engages in their health and wherein it is easy for individuals or employees to become engaged and maintain engagement. Further, there exists a need in the art for a dynamic, interactive individualized health management map to increase individual engagement in personal health and well-being. Further, there exists a need in the art for systems and methods to motivate individuals or employees to embrace effective change in their behavior and ownership of their health. Further yet, there exists a need in the art for a method of efficient allocation of an employer's incentive resources.

### BRIEF SUMMARY OF THE INVENTION

In one embodiment, the present disclosure relates to a system for developing a health management map for a user. The system includes a computer for receiving data related to one or more health conditions or lifestyle behaviors for the user and developing an interactive health management map for the user based on the data received. The health management map can be accessible over a network and includes an integration of tools available for use by the user to monitor and manage his/her health or well-being.

In another embodiment, the present disclosure relates to a system for developing an incentive-based healthcare program. The system includes a computer for receiving data including budget information for the program and developing a program for providing incentives to a user enrolled in the program to improve the user's health or well-being, wherein the incentives are based on the data received.

In yet another embodiment, the present disclosure relates to a system for healthcare services having a behavior-based financing framework. The system includes a computer for creating an incentive budget. The system also includes means for acquiring and understanding an individual's health status and an individualized health management map focusing on the individual's modifiable health conditions and lifestyle behaviors determined from the acquired health status and providing means for tracking the individual's progress toward improved health. An incentive program is provided that conforms to the incentive budget and provides incentives for the individual to engage in their health and well-being.

While multiple embodiments are disclosed, still other embodiments of the present disclosure will become apparent to those skilled in the art from the foregoing summary, and following drawings and detailed description, which show and describe illustrative embodiments of the invention. As will be realized, the invention is capable of modifications in various obvious aspects, all without departing from the spirit and scope of the present disclosure. Accordingly, the foregoing summary and following drawings and detailed description are to be regarded as illustrative in nature and not restrictive.

### BRIEF DESCRIPTION OF THE DRAWINGS

FIG. 1 is a diagram conceptually illustrating an overview of an example embodiment of the present disclosure of a system for designing and administering a behavior-based financing framework.

FIG. 2 is a diagram of an embodiment of the present disclosure of a computing system for designing and administering a behavior-based healthcare financing framework.

FIG. 3A is a diagram showing an example embodiment of the present disclosure of a process of stratification of employee populations.

FIG. 3B, including FIGS. 3B1 and 3B2 in combination, is a diagram showing an example embodiment of the present disclosure of identifying conditions.

FIG. 3C, including FIGS. 3C1 and 3C2 in combination, is a diagram showing an example embodiment of the present disclosure of stratification.

FIG. 3D is a diagram showing an example embodiment of the present disclosure of individual prioritization.

FIG. 3E is a diagram showing an example embodiment of the present disclosure of population prioritization.

FIG. 3F is a diagram showing an example embodiment of the present disclosure of budget application.

FIG. 4A, including FIGS. 4A1, 4A2, and 4A3 in combination, depicts an example embodiment of the present disclosure of an individualized health management map that may be assembled and composed automatically by a computing device.

FIGS. 4B-4K show illustrative portions of an example embodiment of the present disclosure of an on-line individualized health management map, which may be accessed through the Internet or other network. FIG. 4B includes FIGS. 4B1, 4B2, and 4B3 in combination. FIG. 4C includes FIGS. 4C1, 4C2, and 4C3 in combination. FIG. 4D includes FIGS. 4D1, 4D2, and 4D3 in combination. FIG. 4E includes FIGS. 4E1, 4E2, and 4E3 in combination. FIG. 4F includes FIGS. 4F1, 4F2, and 4F3 in combination. FIG. 4G includes FIGS. 4G1, 4G2, and 4G3 in combination. FIG. 4H includes FIGS. 4H1, 4H2, and 4H3 in combination. FIG. 4I includes FIGS. 4I1, 4I2, and 4I3 in combination. FIG. 4J includes FIGS. 4J1, 4J2, and 4J3 in combination. FIG. 4K includes FIGS. 4K1, 4K2, 4K3, 4K4, and 4K5 in combination.

FIG. 4L is a diagram of an example embodiment of the present disclosure of a personal fitness activity tracker.

FIG. 5 is a diagram of an example embodiment of the present disclosure of an incentive structure designed to promote adoption of healthy behaviors.

FIG. 6A is a diagram of an example embodiment of the present disclosure of method of gathering and processing awareness, education, and activation data from an employee.

FIG. 6B, including FIGS. 6B1 and 6B2 in combination, is a diagram of an example embodiment of the present disclosure of method processing action and behavior change incentives for an employee.

FIG. 6C is a diagram of an example embodiment of the present disclosure of method of processing incentives for achieving health standards goals.

FIG. 7 is a diagram conceptually illustrating a method of developing a healthcare management program plan and/or budget of an example embodiment of the present disclosure.

FIG. 8, including FIGS. 8A and 8B in combination, is an example modeled healthcare management program plan and budget for healthcare programs of an example embodiment of the present disclosure.

FIG. 9 is a flow diagram for a method of using an incentive-based, consumer-owned healthcare services and management program in accordance with an embodiment of the present disclosure.

### DETAILED DESCRIPTION OF THE INVENTION

The present disclosure relates to novel and advantageous systems and methods for incentive-based, consumer-owned healthcare services. More particularly, the present disclosure relates to novel and advantageous systems and methods for designing and administering a behavior-based healthcare financing framework, wherein an individual's or employee's share of healthcare costs depends on how that individual engages in their health, and wherein it is easier for individuals or employees to become engaged and maintain engagement. More particularly, the present disclosure relates to novel and advantageous systems and methods for designing and administering a program for healthcare-based incentives that motivate individuals to embrace effective change in their behavior and ownership in their health.

While generally described herein with respect to an employee/employer relationship, it is recognized that the various embodiments of the present disclosure relate to incentive-based, consumer-owned healthcare services involving any suitable healthcare relationship with individuals or employees, including but not limited to, health plans, co-ops, third-party administrators, health plan administrators, human resources outsourcers, labor unions, etc. In the present disclosure, the term “employer” as used herein may encompass entities, such as but not limited to, entities listed above who have a suitable healthcare relationship with individuals and employees. Embodiments of the present disclosure may be extended to spouses, partners, children and other dependents of an individual on a particular health plan. Similarly, it is recognized that the various embodiments of the present disclosure may also be used at the consumer level, and any individual consumer may elect to be part of the healthcare services programs described herein, including but not limited to, those consumers whose healthcare or health insurance is not tied to an employer, labor union, etc. In the present disclosure, the term “employee” as used herein may encompass any healthcare plan user, including but not limited to, the types of individual healthcare plan users listed above.

Using the systems and methods disclosed herein, an effective health program strategy can be implemented that provides a simple, engaging health experience for an employee and can transform the financing of healthcare from current unsustainable models reacting to illness to sustainable models that reward employees for engaging in their health and wellness, i.e., behavior-based financing or underwriting of healthcare.

The systems and methods disclosed herein provide a situation wherein most every entity involved (e.g., employer, employee, healthcare insurance provider) can generally obtain benefits. For example, an employer has the opportunity for healthcare cost savings, in some cases great financial savings, due to an increase in the personal health and well-being of its employee population and the decreased used of critical and expensive treatments or procedures for preventable health conditions. Similarly, the individual or employee, upon participating in the health program, can be provided with incentives to engage in and increase their personal health and well-being. Particularly, employees will be able to access incentive dollars, reduce their financial burden, and assume greater personal ownership of their health. This further leads to a healthier lifestyle for the employee. As an effect of better personal health and well-being for insured employees, the healthcare insurance provider may recognize a drop in claims submitted, thus also providing the insurance provider with healthcare cost savings.

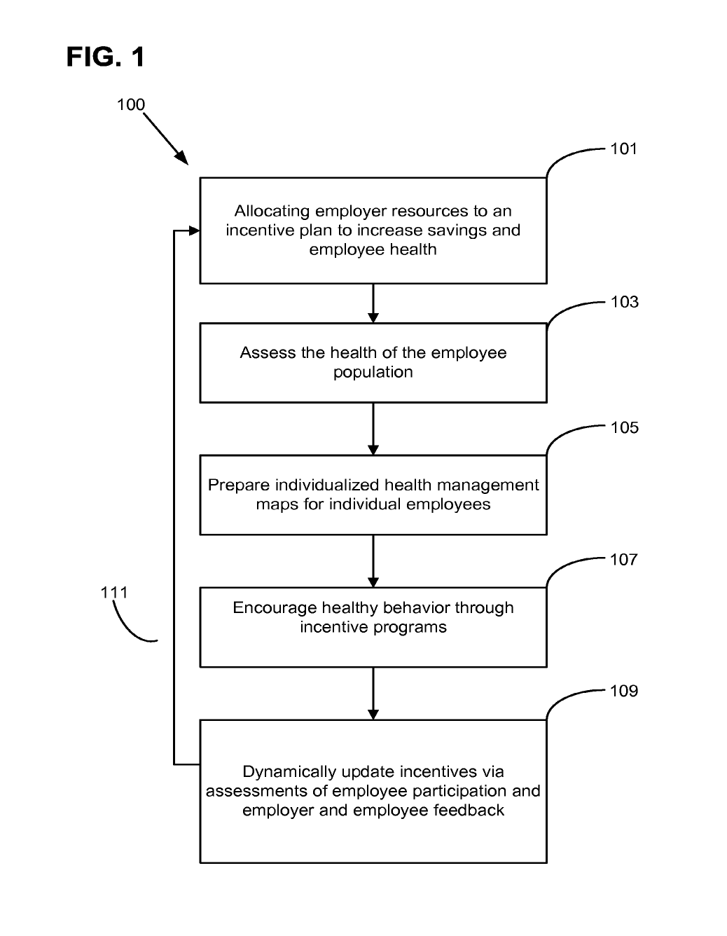

FIG. 1 is a diagram conceptually illustrating an overview of an example embodiment of the present disclosure of a method 100 for designing and administering a behavior-based healthcare financing framework. Typically, method 100 can include allocating employer resources to an incentive plan to increase savings and employee health, as shown in step 101. As discussed more fully below, typically resource allocation may be based on a variety of factors, including but not limited to, an employer's goals, size, budget, employee composition, and culture of the employer.

Method 100 may further include a step of assessing the health of an employee population, as shown in step 103, and may also include preparing individualized health management maps for individual employees, as shown in step 105. Individualized health management maps may be a document, available on paper and/or an electronic display, that may be used to track an individual's engagement in their health through highly personalized and generally easy-to-use information or interfaces relating to that individual's health and wellness. As described more fully below, individualized health management maps may in some embodiments be dynamic and/or interactive electronic displays or interfaces allowing for individual input and responsive to such input. In further embodiments, individualized health management maps may provide access and contact information for health coaches and health advisors. Individualized health management maps, and the generation and content thereof, are described more fully below.

Method 100 may further include encouraging employees' healthy behavior through incentive programs, as shown in step 107 and described more fully below. Incentive programs may be administered through an individualized health management map in some embodiments. Method 100 may also include dynamically updating incentives provided by an employer, for example, via assessments of employee participation and employer and employee feedback, as shown in step 109, and may further include iteratively 111 adjusting one or more of steps 101, 103, 105, 107, and/or 109 to achieve increased employee participation, health, and employee/employer savings as method 100 continues to be used by an employer.

While illustrated in FIG. 1 as having steps 101, 103, 105, 107, 109, and 111, it is recognized that not every step is required and additional steps may be included. Similarly, the steps 101, 103, 105, 107, 109, and 111 do not necessarily need to be performed in the order illustrated. Furthermore, in some embodiments, one or more of the steps shown in FIG. 1 or portions thereof, or data used in one or more of the steps shown in FIG. 1 or portions thereof, may be performed or provided by one or more third-party entities.

The systems and methods disclosed herein can be carried out in part by computer programs running on standard or specialized computer system components, and in some embodiments, various parts of the systems and methods may be carried out by different and unrelated entities. For example but not limited to, in some embodiments, data and programs may be stored on one or more remote servers and accessed online by employers and employees over a network, such as but not limited to, the Internet, a LAN (local area network), or WAN (wide area network).

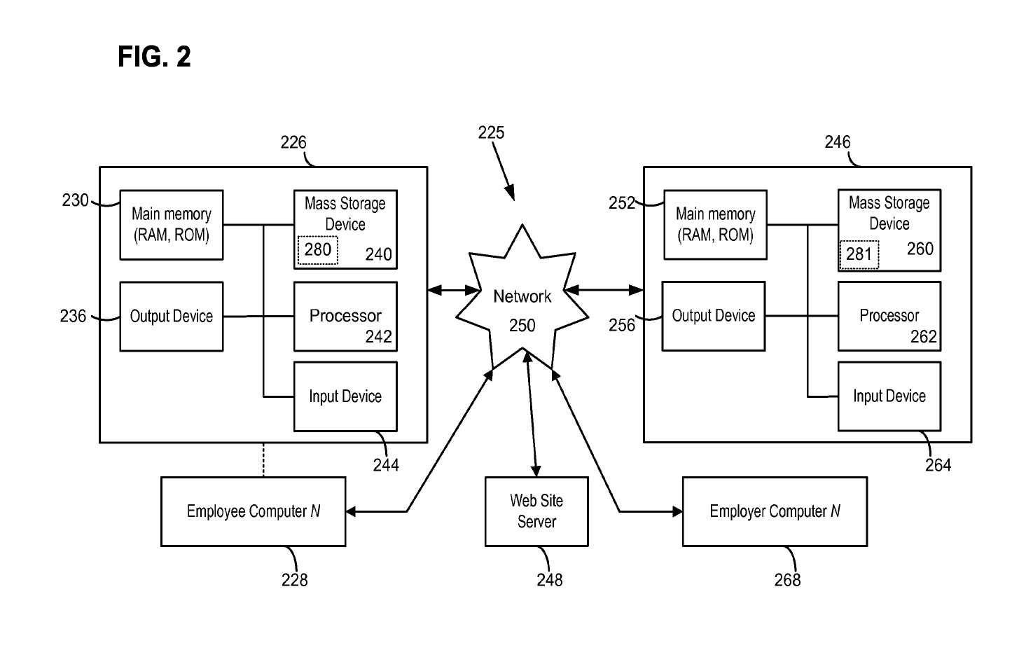

FIG. 2 is a diagram of an embodiment of a computing system environment 225 for designing and administering a behavior-based healthcare financing framework. System environment 225 may include a plurality of computers, such as but not limited to personal computers, 226 and 228 connected with a network 250 such as the Internet. Employees using computers 226 and 228 can interact with a server 246 in order to input and receive information, for example but not limited to, viewing and updating employee profiles; completing health risk assessments (HRAs), which are described more fully below; and viewing and interacting with individualized health management maps.

System environment 225 may also include the ability to access one or more web site servers 248 in order to obtain content from the Internet for use with employees' individualized health management maps and HRAs. While only two computers 226 and 228 are shown for illustrative purposes, system environment 225 may include a plurality of computers and may be scalable to add or delete computers to or from a network.

FIG. 2 illustrates typical components of an embodiment of a computer 226. Computer 226 may typically include a main memory 230, one or more mass storage devices 240, a processor 242, one or more input devices 244, and one or more output devices 236. Main memory 230 may include random access memory (RAM), read-only memory (ROM) or similar types of memory. One or more programs or applications 280, such as a web browser, and/or other applications may typically be stored in one more data storage devices 240. Programs or applications 280 may be loaded in part or in whole into main memory 230 or processor 242 during execution by processor 242. Mass storage device 240 may include, but is not limited to, a hard disk drive, floppy disk drive, CD-ROM drive, smart drive, flash drive or other types of non-volatile data storage, a plurality of storage devices, or any combination of storage devices. Processor 242 may execute applications or programs to run systems or methods of the present disclosure, or portions thereof, stored as executable programs or program code in memory 230 or mass storage device 240, or received from the Internet or other network 250. Input device 244 may include any device for entering information into machine 226, such as but not limited to, a microphone, digital camera, video recorder or camcorder, keyboard, mouse, cursor-control device, touch-tone telephone or touch-screen, a plurality of input devices or any combination of input devices. Output device 236 may include any type of device for presenting information to a user, including but not limited to, a computer monitor or flat-screen display, a printer, and speakers or any device for providing information in audio form, such as a telephone, a plurality of output devices or any combination of output devices.

Applications 280, such as a web browser may be used to access information for HRAs and individualized health management maps and display them in web pages, and allow information to be updated, for example. Any commercial or freeware web browser or other application capable of retrieving content from a network and displaying pages or screens may be used. In some embodiments, a customized application 280 may be used to access, display and update information for a user.

Examples of computers for interacting with the system include personal desktop computers, laptop computers, notebook computers, palm top computers, network computers, or any processor-controlled device capable of executing a web browser or other type of application for interacting with the system, including mobile devices such as cellular phones.

Server 246 may typically include a main memory 252, one or more mass storage devices 260, a processor 262, one or more input devices 264, and one or more output devices 256. Main memory 252 may include random access memory (RAM), read-only memory (ROM) or similar types of memory. One or more programs or applications 281, such as a web browser and/or other applications, may typically be stored in one or more mass storage devices 260. Programs or applications 281 may be loaded in part or in whole into main memory 252 or processor 262 during execution by processor 262. Mass storage device 260 may include, but is not limited to, a hard disk drive, floppy disk drive, CD-ROM drive, smart drive, flash drive or other types of non-volatile data storage, a plurality of storage devices, or any combination of storage devices. Processor 262 may execute applications or programs to run systems or methods of the present disclosure, or portions thereof, stored as executable programs or program code in memory 252 or mass storage device 260, or received from the Internet or other network 250. Input device 264 may include any device for entering information into server 246, such as but not limited to, a microphone, digital camera, video recorder or camcorder, keyboard, mouse, cursor-control device, touch-tone telephone or touch-screen, a plurality of input devices or any combination of input devices. Output device 256 may include any type of device for presenting information to a user, including but not limited to, a computer monitor or flat-screen display, a printer, and speakers or any device for providing information in audio form, such as a telephone, a plurality of output devices or any combination of output devices.

Server 246 may store a database structure in mass storage device 260, for example, for storing and maintaining claim data, HRA information, and other outside data. Any type of data structure can be used, such as a relational database or an object-oriented database.

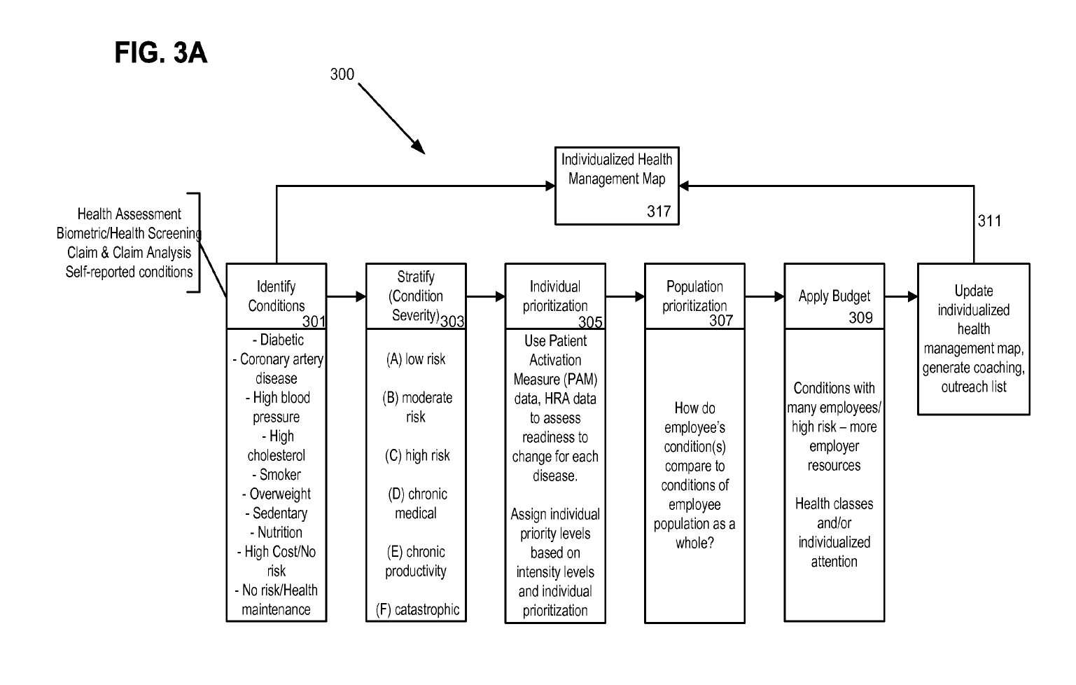

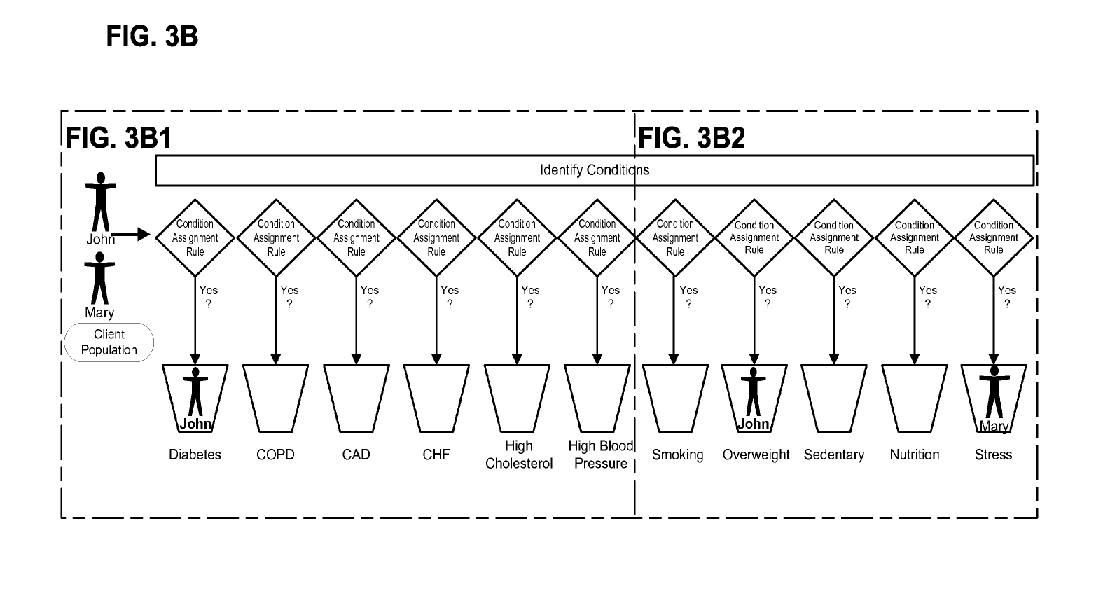

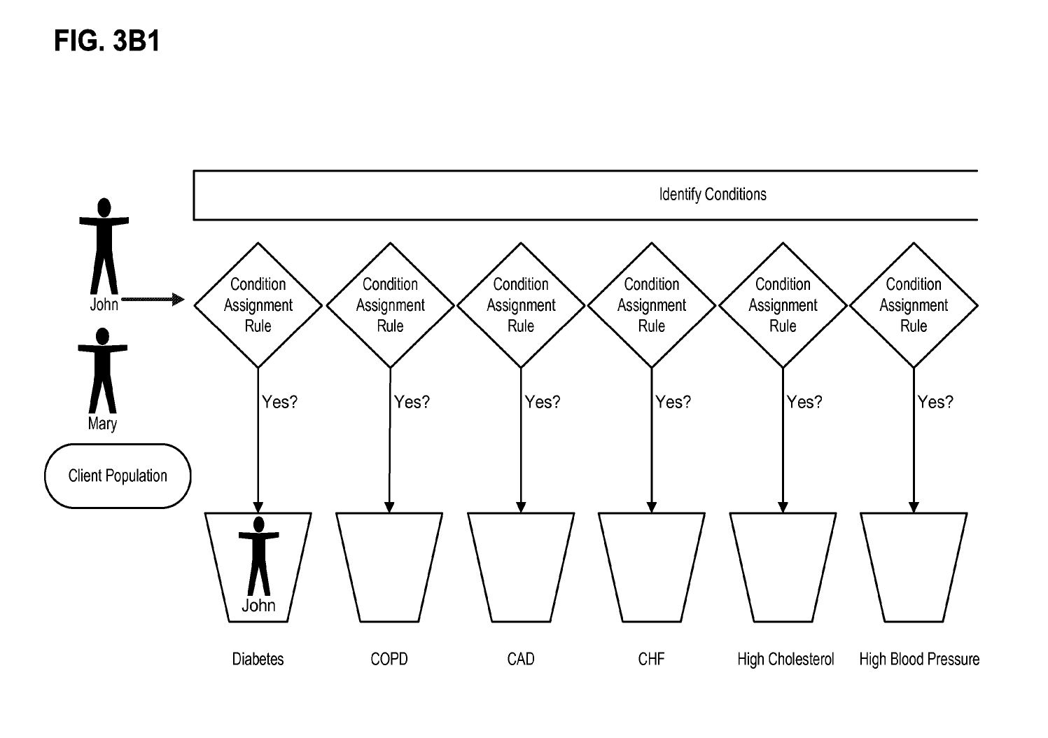

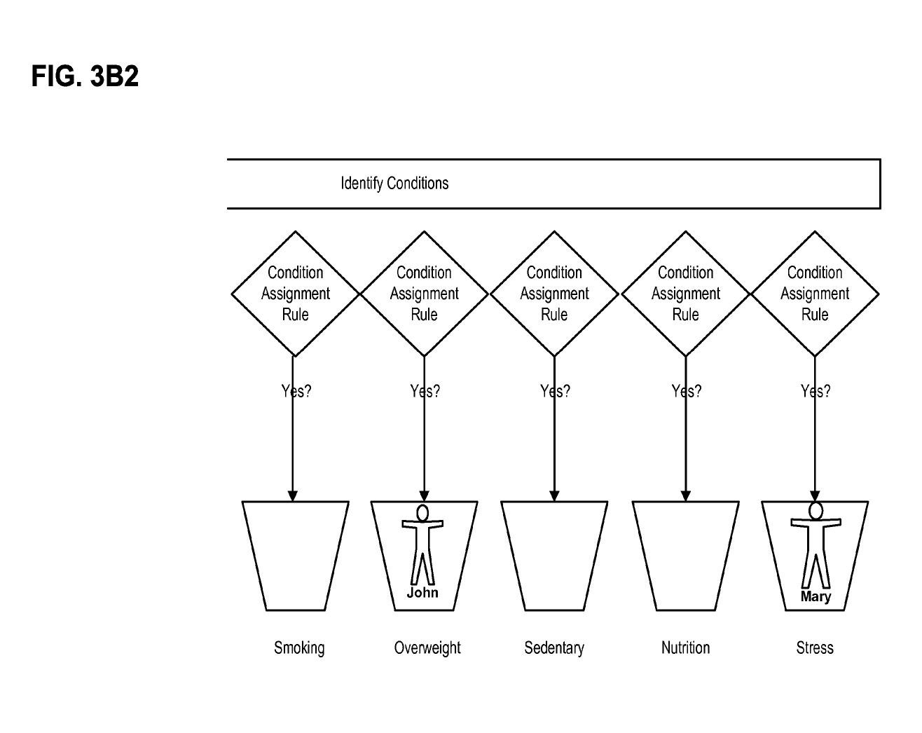

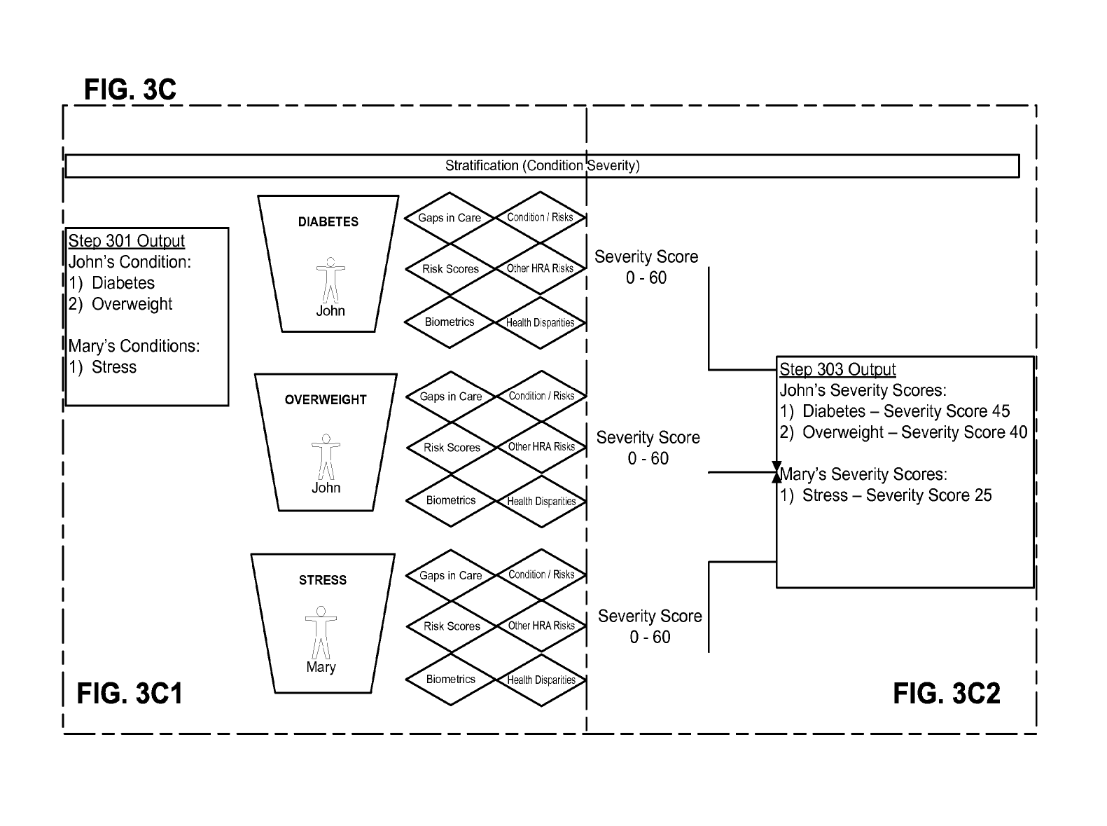

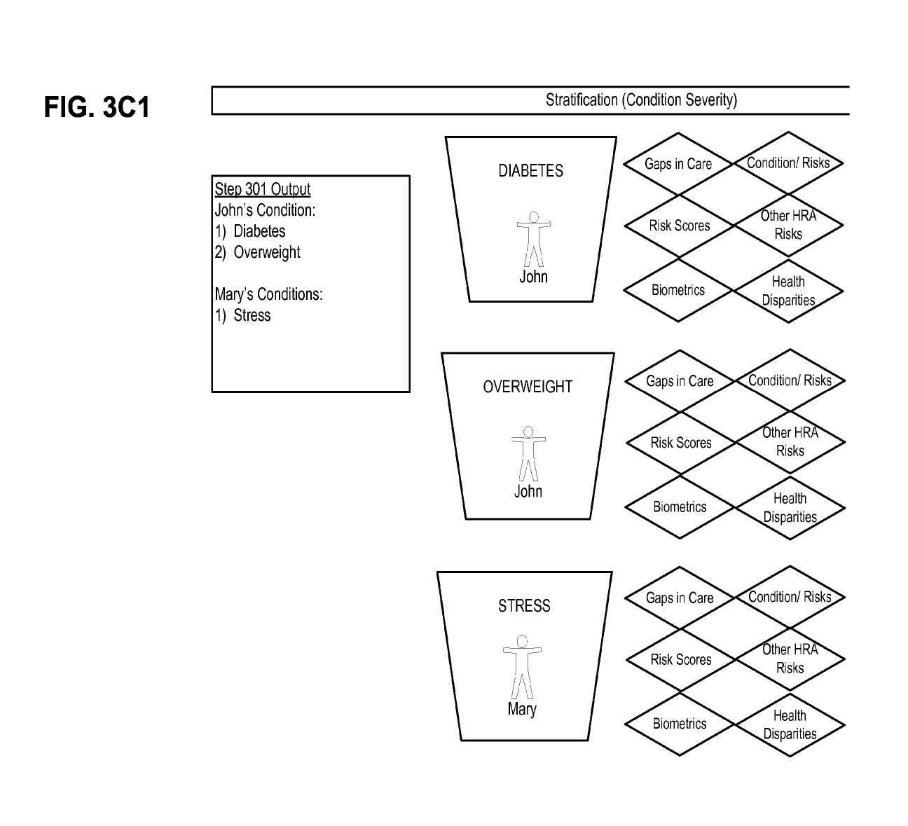

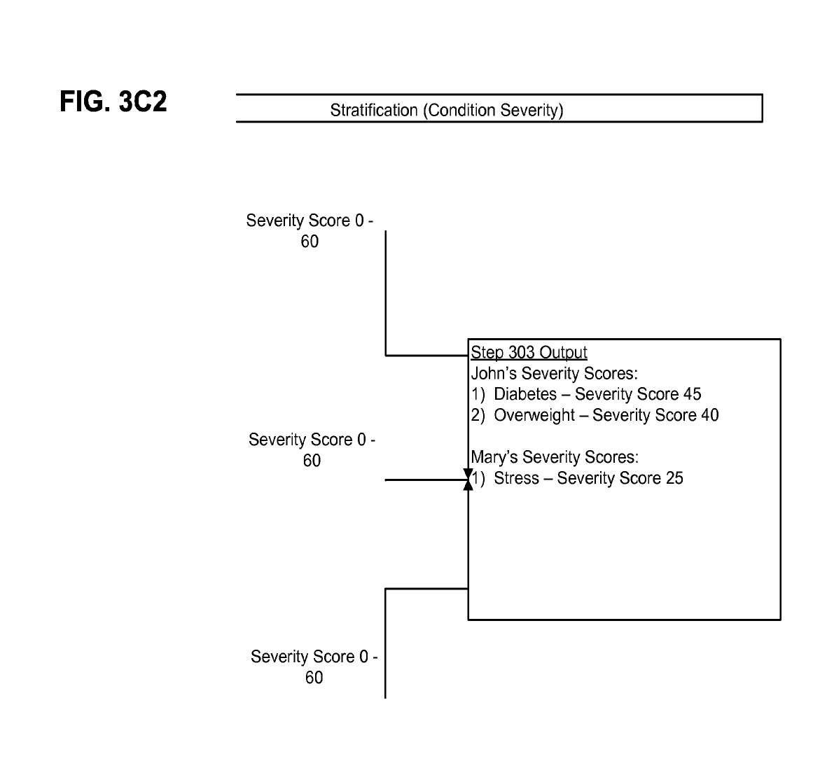

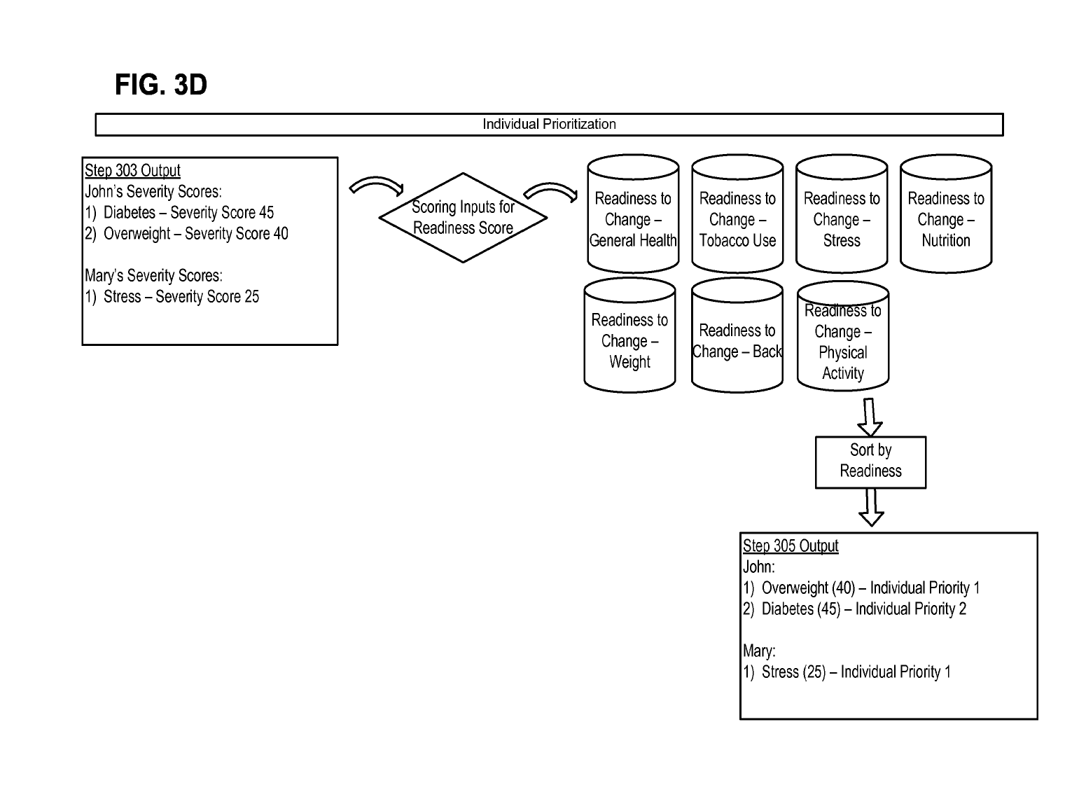

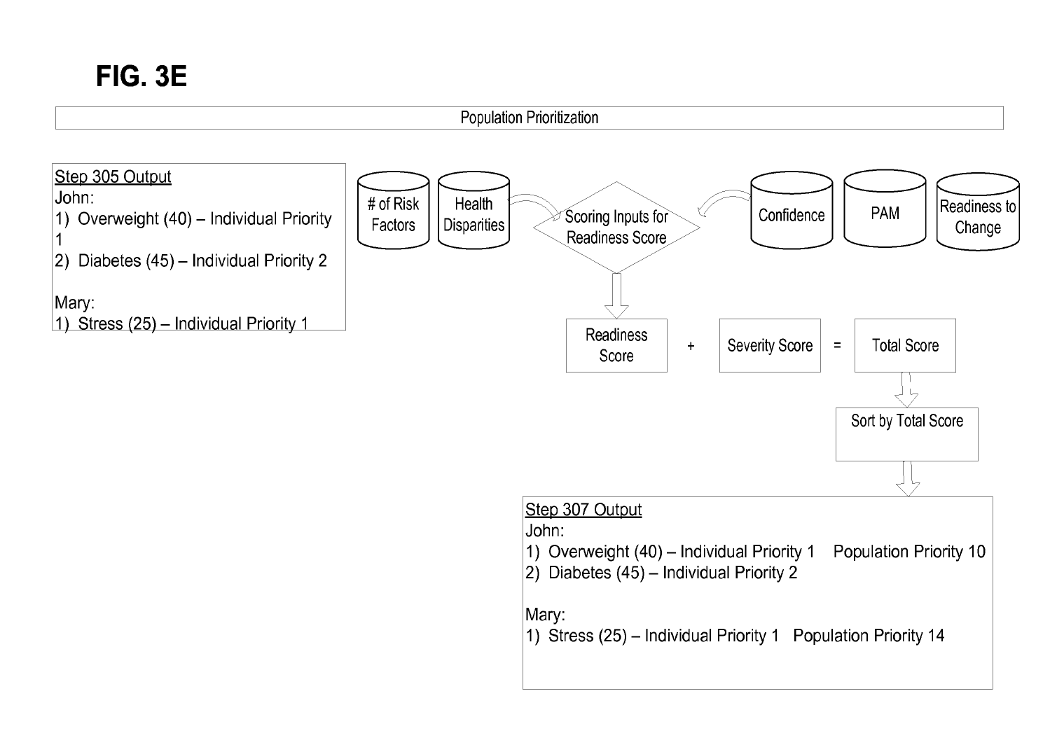

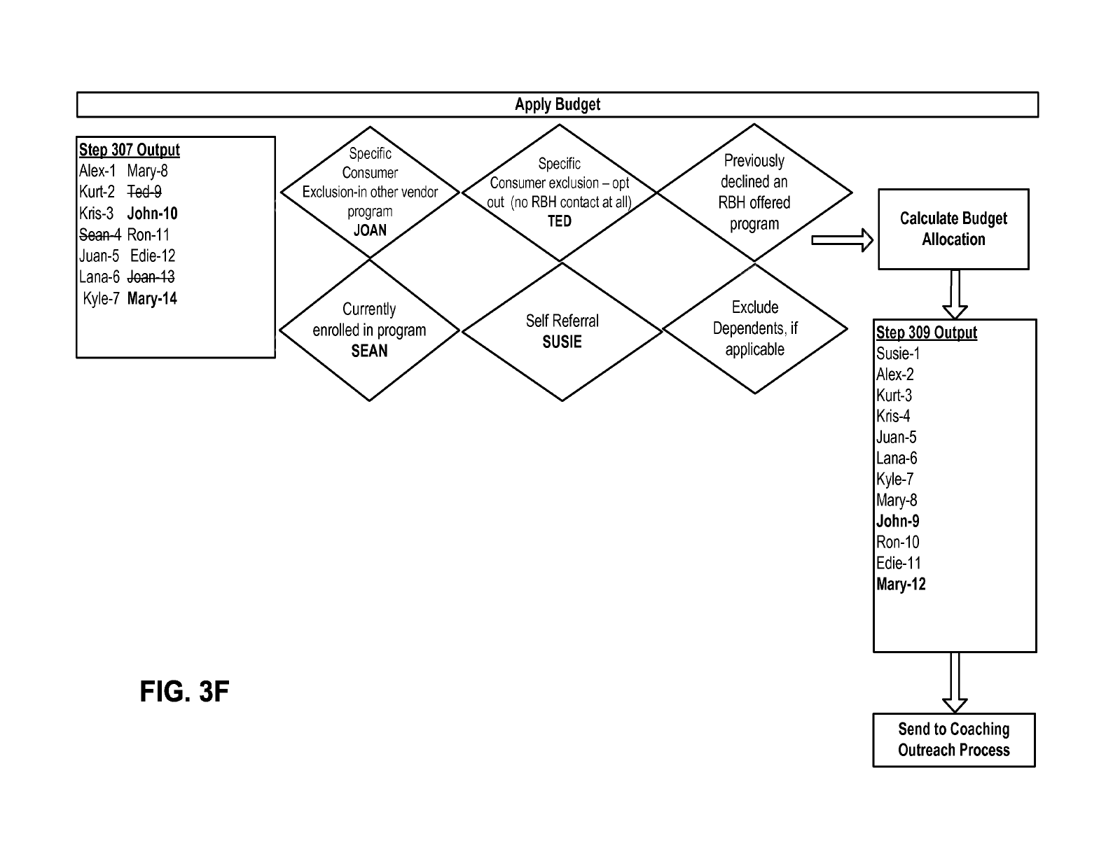

Processors 242, 262 may, alone or in combination, execute one or more applications 280, 281 in order to provide some or all of the functions, or portions thereof, shown in the flow charts of FIGS. 3-6, described in detail below.

Employers may monitor system performance, input data, modify parameters of incentive programs, etc., using output devices 256 and input devices 264 of server 246, or may use one or more remote computers, such as but not limited to personal computers, 268, which may communicate to server 246 directly, or via a network 250, for example.

Now referring back to step 101 of FIG. 1, in some embodiments of the methods and systems of the present disclosure, an employee incentive structure and/or health management budget (which are described more fully below) may be calculated for an employer, upon input or information provided by the employer, for example, relating to the employer's goals, size, budget, employee composition, and/or workplace culture. An employer may, for instance, want to provide health coaching resources and/or tailor incentives to achieve certain employer goals, such as reducing employee tobacco use, or encouraging an increase in overall employee fitness level. A small employer may provide resources toward less expensive health management tools, and lesser incentives, whereas a larger employer may provide more expensive programs and incentives. Similarly, the budget allotted for incentive-based healthcare management for a particular employer may affect the structuring of health management programs and incentives. The particular composition of an employer's workforce may also affect the particular incentives and health management programs offered, for instance if a particular workforce has an atypical distribution of age, gender, particular employee health conditions and the like. Workplace culture may also affect the particular health management programs and incentives offered, for example, some workplaces may have a strong team “competition” culture in place, and incentive and health management programs may be designed to incorporate employee teams and competitions.

As described fully below, a particular incentive structure and budget may be updated and adjusted periodically in response to various factors, including, for example, employee participation, healthcare savings, and/or incentive program costs. The methods and systems of the present disclosure may be implemented as part of a defined contribution health plan, in which employers contribute a fixed amount per employee for healthcare costs, or a traditional fee-for-service health plan, or health plans that have features of both, i.e., employers contribute a part of expected healthcare costs as a defined sum (less, in some cases, an employee's deductible) and the remaining health costs may be paid on a fee-for-service model.

Referring now back to step 103 of FIG. 1, in some embodiments of the present invention, assessing the health of an employee population can be accomplished by, among other things, having an individual complete a health risk assessment (HRA), a health screening and/or biometric screening, by obtaining pharmacy and/or medical claims data, and/or by obtaining other outside data such as data self-reported by the individual.

A HRA may include leading an individual employee through a set of scientifically validated health and well-being questions that provide an in-depth look at the individual's daily activities. In one embodiment, a third-party, such as but not limited to, JourneyWell, a division of HealthPartners, which is headquartered in Bloomington, Minn., may be used to perform the HRA. However, in other embodiments, any general or customized HRA questions or question sets may be used and may vary in complexity and/or length. For example, a HRA may be very involved and include over 100 questions. Alternatively, a HRA may be generally simple to fill out and include, for example, only a handful of questions. Using answers given by the employee, medically approved algorithms may be used to identify individuals with behavior risks and increased risks for disease. For example, one or more HRA questions may relate to whether an employee has a history of hypertension or whether an employee has common symptoms of hypertension, and may further include one or more questions that ask the employee to rate their frequency and/or severity. An algorithm may identify the employee as having high blood pressure or have a risk for developing heart disease, if any of the following conditions are true, based on the employee's answers: (1) the employee has a history of hypertension; (2) the employee has 2 or more symptoms of hypertension; (3) the employee has any hypertension symptom over a certain severity. Other algorithms may be used to identify employees with hypertension, or other health conditions, and may be similar, simpler, or more complex than the example discussed above.

A HRA may also gather in-depth information relating to, but not limited to, personal demographics, family health history, self-care, personal health, women's health, nutrition, physical activity, alcohol and tobacco use, and ability to change behavior. An HRA may be completed by an individual by any suitable means to input data, for example but not limited to: a paper questionnaire; online, through a web browser 280 on a computer 226, 228 connected to a server 246 through a computer network 250 or the Internet; using input software 280 loaded into the main memory 230 or one or more mass storage device 240 of an individual's computer 226 or electronic input device; by telephonic inputs, using voice recognition or touch-tone inputs; by formal interview in person or via a telephone, or other voice communication device, etc.

Example question topics in an HRA may include, but are not limited to, questions that may elicit biometric information known by an employee, such as but not limited to, an employee's age, gender, height, weight, inches around the wrist between the wrist bone and hand, inches around the waist at belly button in indoor clothes, inches around the neck, and body frame, etc. Questions may elicit current health information known to an employee, such as body mass index (BMI), blood pressure, and/or serum triglyceride and glucose concentrations. In this or other embodiments, some or all of this information may be obtained or updated through health and/or biometric screening as described more fully below.

Other questions that may be asked in a HRA may include an employee's education and/or job function; the employee's family history of cancer, diabetes, heart problems, high blood pressure, high cholesterol, or stroke; whether the employee has a health condition such as allergies, angina, asthma, back pain, cancer, chronic bronchitis/emphysema, depression, diabetes, heart disease, high cholesterol, hypertension, kidney disease, liver disease, migraines, osteoporosis, past stroke, or a thyroid condition; whether medication is being taken to treat a health condition; how many times in the past 12 months or other suitable timeframe has the employee had a routine physical, gone to the emergency room, stayed overnight in a hospital, used a 1-800 number for medical advice, used a self-care book, or been treated with alternative medicine (for example, acupuncture, chiropractic care); whether the employee is pregnant and if so, in which trimester and whether she is under a doctor's care; whether a female employee is planning a pregnancy within the next 12 months or other suitable timeframe; whether the employee knows what steps to take at home to treat health problems such as back pain, colds, flu, constipation, diarrhea, headaches, indigestion, rashes, sore throats, or sprains; whether the employee has ever been told by a doctor, nurse, or other health professional that he or she is obese; whether the employee uses or has used tobacco or illegal drugs (and how often and how much), and whether the employee is still using tobacco or illegal drugs; the number of alcoholic drinks the employee consumes in a week or other suitable timeframe, and the maximum number in one day; whether the employee has driven or ridden in a car when the driver had perhaps too much to drink; the amount of daily calories consumed and/or how many calories burned through routine activities; the number of glasses of water consumed daily; how many servings of food eaten in a day that are high in fiber, cholesterol, and/or fat; how often is salt added to food, or how often are salty foods or fast foods consumed; the employee's blood pressure, total cholesterol level, low density lipoprotein (LDL), and/or high density lipoprotein (HDL) cholesterol level; how often does the employee exercise per week or other suitable timeframe, or participate in any strength building or stretching exercises; whether during the past 30 days or other suitable timeframe the employee's mental health was not good; how many days in the past 30 days or other suitable timeframe did poor physical or mental health keep the employee from doing usual activities, work, or recreation; the number of hours of sleep the employee usually gets at night; the general level of satisfaction with one's life; how often the employee feels tense, anxious, or depressed; how often does the employee use drugs or medication (including prescription drugs) that affect mood or help the employee relax; whether the employee has suffered a personal loss or misfortune in the past year or other suitable timeframe; the number of days in the past year or other suitable timeframe the employee's emotional health kept him or her from working all or most of the day; the number of days in the past year or other suitable timeframe an illness or injury kept the employee from working all or most of the day; how the employee would consider his or her overall physical health; whether the employee has experienced frequent urination, excessive thirst or hunger, dramatic weight loss, irritability, weakness, fatigue, nausea, vomiting, persistent indigestion, or difficulty swallowing; whether the employee has experienced chest discomfort, shortness of breath, numbness or weakness of the face, arm, or leg, trouble walking, dizziness, loss of balance, sudden severe headaches without known cause, breaking out in a cold sweat, nausea, or lightheadedness; whether the employee has experienced unusual bleeding or discharge, change in bowel or bladder habits, nagging cough or hoarseness, persistent indigestion or difficulty swallowing, obvious change in skin such as a freckle, mole or wart, any sore that does not heal, or thickening or lump in the breast or elsewhere; when the last time the employee received a flu, pneumonia, or tetanus shot; whether a male employee has been told by a doctor, nurse or healthcare professional that he has or had colorectal, lung, prostate, or testicular cancer; whether a male employee has been examined for testicular lumps, or checked for prostate (using, for example, a prostate-specific antigen, finger rectal exam, or transrectal ultrasound) or colorectal (using, for example, a finger rectal exam, fecal occult blood test) cancer by a physician; whether a female employee has ever been told by a doctor, nurse or healthcare profession that she has or had breast, cervical, colorectal, or lung cancer; how many women in a female employee's natural family have had breast cancer; whether a female employee performs a monthly self-exam of the breast for lumps; whether a female employee over age 35 has ever had a mammogram; whether a female employee has ever had a pap smear (and length of time since the last pap smear); the age at which a female employee first started menstruating; whether a female employee has been checked for colorectal cancer (using, for example, a finger rectal exam, fecal occult blood test, or sigmoidoscopy) by a physician; whether the employee is satisfied with his or her job; whether the employee is creating a balance between personal, couple, family and career goals; how strong the employee's social ties are with family and/or friends; whether the employee schedules quiet, rejuvenating time each day; whether the employee schedules time, daily or weekly, separately from his or her spouse and/or each child; whether the employee leaves his or her job worries at the office and the family worries at home; what changes the employee has done in the past 12 months, or plans to do in the next 6 months, to enhance his or her health, including, for example, increase physical activity, lose weight, reduce alcohol use, quit or cut down on smoking, reduce fat and/or cholesterol intake, lower blood pressure, lower cholesterol level, or cope better with stress.

A HRA may also include a patient activation measure (PAM) survey, which can assess patient knowledge, skill and confidence for self-management of health issues. For example, PAM surveys may include an evaluation of various self-motivation factors, such as but not limited to whether the employee: (1) believes that their role in their own health is important, (2) possesses confidence and knowledge necessary to take action; (3) actually has taken action to maintain and improve health; and/or (4) has an ability to stay the course even under stress. Although four factors are shown here, more or fewer relevant factors to patient self-motivation may also be included in a PAM survey. In some embodiments, PAM surveys may ask questions that are designed to capture employee attitudes about self-motivation to change health behaviors in general, or may be tailored to capture individual attitude about changing behaviors in relation to one or more specific health conditions an employee may have. In one embodiment, a third-party, such as but not limited to, Insignia Health, based in Portland, Oreg., may be used to perform the health screening.

Health screening, for example, administering one or more medical tests (which may or may not be invasive) to obtain medical data about individual employees, may be used to gather current information relating to one or more of cholesterol levels, diabetes, blood pressure, and other medical information. Relevant medical tests may include for example but not limited to, lipid tests to screen for blood cholesterol levels, blood glucose measurements to screen for diabetes, blood pressure measurements, as well as nicotine levels, PSA (prostate-specific antigen), skin cancer tests, bone density tests, and others. Biometric screening, that is, height, weight, body mass index (BMI) and other such outwardly measurable physiological traits of individual employees may also be used. In one embodiment, a third-party, such as but not limited to, Kronos Optimal Health Company, which is headquartered in Phoenix, Ariz., may be used to perform the health screening.

Outside data sources that may be used to gather additional employee health information may include medical and pharmacy claims data from health insurance providers. Outside data sources may include, but are not limited to, information from an employee or individual's doctor or other healthcare providers, employer or third-party medical and pharmacy claims analyses, as well as self-reported data from the individual.

Health data collected from a HRA, PAM, health and/or biometric screening, and/or claims data or other outside data may be used in some embodiments of the present disclosure to generate a personal health score, for example. Accompanying the personal health score may be a report describing the employee's personal health score and what it reveals about major threats to the employee's health, how the employee's health history impacts their score, and personalized recommendations based on age, gender, personal history, calculated health risks or readiness for change. A personal health score may be combined with or used in an individualized health management map as described further below. A personal health score may be updated at any time after an initial input of health information to incorporate changes in behavior, updated health information, or to model potential impacts to the score in response to changes in health behaviors or updated health information.

The personal health score may be computed, at least in part, using all or a subset of answers to questions asked during administration of a HRA. In one embodiment, scores may be assigned to particular answers, and a mathematical combination of particular scores assigned to each answer may be used to produce a personal health score. A scale or possible score range for a personal health score may be from 0-1000, although other smaller or larger score ranges are possible. Other suitable scales, which may make more or less finer distinctions, such as a 1-10 or 1-100 scale, or a letter grade scale, may also be used. In one embodiment, a personal health score may be based on an index constructed from numerical scores assigned to answers to questions relating to weight, diabetes, coronary artery disease, high blood pressure, high cholesterol, smoking habit, and/or back pain. The construction of a personal health score from more, fewer or other relevant questions is possible.

In some embodiments, employee health and health consumer data collected may be used to identify employees who have health conditions or lifestyle behaviors that could be addressed through coaching services, health programs, education or other helpful and available means. In one embodiment, employees may be stratified into intervention intensity levels for each condition/risk factor they have. These stratifications may typically be based on answers given in HRAs, biometric and/or health screenings, and/or claims or other outside data, and/or a health potential score that may have been computed from the collected health data. The identification and stratification of employees into intervention intensity levels may be used to tailor coaching services, health programs, education or other helpful and available means to a particular employee's intervention intensity level for a particular disease or condition, and to combine services for employees with like conditions and/or intervention severity levels for more efficient allocation of employer resources.

FIG. 3A is a diagram showing an example embodiment of a process of stratification 300 of employee populations. As illustrated in FIG. 3A, the process 300 may include one or more of identifying conditions 301, stratification 303, individual prioritization 305, populations prioritization 307, budget application 309, and/or updating individualized health management maps 311. While steps 301, 303, 305, 307, 309, and 311 are shown for illustrative purposes, it is recognized that not all steps are required and that additional steps may be included. Similarly, steps 301, 303, 305, 307, 309, and 311 do not necessarily need to be performed in the order shown, and some steps may be combined as a single step.

As shown in step 301, based on the results of a HRA, health and/or biometric screening, claim analysis, and/or self-reported conditions or other outside data, one or more health conditions possessed by an employee may be identified. As illustrated in FIG. 3B, possible health conditions may include, but are not limited to, diabetes, chronic obstructive pulmonary disease (COPD), coronary artery disease (CAD), congestive heart failure (CHF), high cholesterol, high blood pressure, smoking, obese or overweight, sedentary, poor nutrition, and stress. In some embodiments, employees not falling into any disease category may be categorized, for example, as high cost/no risk, if no serious disease or medical conditions are indicated from a HRA, health screening data, and claim data, etc., but claims exceeding a certain amount were made in the previous year, or as no risk/health maintenance, if no serious disease or medical conditions are indicated. It is recognized that other suitable categorizations may also be used. Individual employees may be categorized as having none, one, or more disease conditions. For example, as illustrated in FIG. 3B, “John” has been identified as having diabetes and being overweight, while “Mary” has been identified as stressed. Identified conditions may be added, in some embodiments, to an individualized health management map 317, which is described more fully below.

For each condition identified in step 301, an employee population may be further stratified, into one or more condition severity levels 303, such as but not limited to, low risk, moderate risk, high risk, chronic medical, chronic productivity, and catastrophic, based on HRA data, health and/or biometric screening, claim data, self-reported conditions, and/or other outside data. In addition, or alternatively, in one embodiment, an employee population may be further stratified by condition severity, which may include determining a severity score for each of an employee's condition. The severity score may be determined using any suitable algorithm for distinguishing varying amounts of condition severity. For example, in one embodiment, the severity score for each condition may be calculated as a score between 0-60, or other suitable range. As an example algorithm only, in one embodiment, a severity score between 0-60 for obesity or weight problem may be determined as follows:
1. Cost Level (up to 10 points)—if the annual medical/drug cost for this condition is:
   less than $2,000, then add 2 points;
   between $2,000 and $5,000, then add 6 points; or
   greater than $5,000, then add 10 points.
2. Biometrics (up to 8 points)—if body mass index (BMI) is:
   between 26-29, then add 2 points;
   between 30-34, then add 4 points;
   between 35-39, then add 6 points; or
   greater than 40, then add 8 points.
3. Conditions/Risks (up to 10 points)—if individual has:
   0 or 1 risk factors, then add 2 points;
   2 risk factors, then add 4 points;
   3 risk factors, then add 6 points;
   4 risk factors, then add 8 points; or
   5 or more risk factors, then add 10 points.
Risk factors may include but are not limited to:
   smoking;
   high blood pressure;
   high cholesterol;
   physical inactivity level;
   high stress; and
   individual's own perception of health
It is recognized that additional or alternative risk factors may be used.
4. Heart and Diabetes Risk (up to 10 points)—risks relating to a heart or diabetes condition:
   if a heart condition is AT RISK, then add 5 points;
   if a diabetes condition is AT RISK, then add 5 points; or
   if both are AT RISK, then add 10 points.
5. Other Risks Determined from HRA (up to 12 points)—determinations made from an HRA relating to other risks may be used to calculate the severity score, and include but are not limited to risks relating to prescription drug use, chronic back pain, nutrition, physical impairments, work impairments, weight management, etc. Allocation of the points may be done in any suitable or desirable manner.
6. Health Disparities (up to 10 points)—may include but are not limited to the disparities below:
AGE
   less than 40 years old, then add 1 point;
   between 40 and 49 years old, then add 2 points; or
   50 years old or older, then add 3 points.
RACE/ETHNICITY
   if African-American, Native American, Asian-Pacific Islander, or Hispanic, then add 3 points.
INCOME
   if greater than $75,000/yr, then no points added;
   if between $40,000/yr and $75,000/yr, then add 1 point; or
   if less than $40,000/yr, then add 2 points.
EDUCATION LEVEL
   if greater than 12th grade level, then no points added;
   if between an 8th grade and 12th grade level, then add 1 point; or
   if less than an 8th grade level, then add 2 points.
GEOGRAPHY
   if in West or Northeast regions, then no points added;
   if in Mid-West region, then add 1 point; or
   if in Southern region, then add 2 points.

As stated above, the above-described algorithm is provided as an example algorithm only. It is recognized that any suitable or desirable algorithm may be used and that the algorithm may be different for each condition and may rely on additional or different factors than those described above. Furthermore, while the above severity score is described as a value between 0 and 60, it is recognized that any range or other value system may be used for the severity score, including but not limited to a grading system. Also, the points need not be distributed in the distribution shown in the example; any suitable distribution may be used.

In one example, as illustrated in FIG. 3C, “John” has been identified as having diabetes and being overweight. Based on his HRA, health and/or biometric screening, claim analysis, and/or self-reported conditions or other outside data, it may be determined that he has a severity score of 45 out of 60 for diabetes and a severity score of 40 out of 60 for his weight problem. Similarly, “Mary,” who has been identified as stressed, may be have a severity score of 25 out of 60 for her stress condition. Health conditions and risk/severity levels may link employees to specific health behavior management programs. Supplemental categorizations for employees or individuals with pre-disease conditions may be created within any condition severity level.

In further embodiments, individual priority (or readiness) levels for each condition may be created, as shown in step 305. Individual priority levels can be used to prioritize and order each of an employee's conditions, such that, in general, conditions with higher priority may be managed in preference to conditions of lower priority. Individual priority levels may be based on, for example but not limited to, PAM survey data, individual preference, risk category level, and/or other suitable data. In some embodiments, individual preference may be ascertained by system 300 by an employee ranking his or her conditions in order of importance to him or her. In some embodiments, priority levels generally may follow employee preference, but may be superseded or overridden by conditions that have a high risk category level, but which were given a low importance by the employee.

In some embodiments, individual priority levels for each condition possessed by an employee may be assigned in whole or in part by using Patient Activation Measure (PAM) data and HRA data to assess readiness to change for each disease, along with risk intensity levels and individual prioritization. For example, as shown in FIG. 3D, “John” has two conditions, (1) diabetes, with a severity score of 45, and (2) overweight, with a severity score of 40. Based on his PAM and/or HRA answer data, he may be more ready to change and monitor his weight problem than he is his diabetes. Thus, his weight condition may be assigned an individual priority of 1, meaning he will be more willing to attempt to change this condition first, and his diabetes may be assigned an individual priority of 2, meaning he will be more willing to attempt to change this condition second. Similarly, “Mary,” who has been identified as having only one condition, e.g., stressed, may have this condition assigned an individual priority of 1. In some embodiments, conditions with higher risk or severity score may be assigned higher individual priorities despite individual readiness to change for that particular condition.

Priority (or readiness) level scores can be used to prioritize each condition associated with each employee identified in 301 to create an individual program that first addresses the conditions the employee is most likely to change and/or the most serious conditions, as indicated in 303. Additionally, the readiness to change of each individual can be evaluated to determine an appropriate health intervention prioritization for each individual in 305.

In some embodiments, priority level scores for each health condition for each employee may be combined to give population prioritization scores for each condition over an entire employee population, as shown in step 307. Population prioritization scores typically may be arithmetic combinations of severity scores and priority level scores for the same or similar conditions across the employee population that allow for comparison of population prioritization scores between conditions. Priority level scores may, in some embodiments, be based on information about employee preference to treat a particular condition, condition risk, employee readiness to change behaviors associated with a condition, PAM results, etc. Accordingly, population prioritization scores may thus give information about which conditions in the employee population as a whole are the most serious, most important to employees, and/or most amenable to change. For example, as shown in FIG. 3E, for the population as a whole, a population priority of 10 may be assigned to the condition of obesity while a population priority of 14 may be assigned to the condition of stress. That is, for the population as a whole, more emphasis may be on addressing the condition of obesity than stress.

In some embodiments, the identified conditions, stratifications, individual prioritizations, and/or population prioritization scores may be used to help prioritize a budget for health management services, as shown in step 309 and illustrated in FIG. 3F. Health management services, such as but not limited to, in-person or online health coaching classes, outreach, and/or educational materials, each have a certain cost. Health management services may be concentrated on conditions with higher population prioritization scores because this score may indicate, depending on how it was constructed in 307 from individualized priority scores, conditions that were more severe (on average), more important (on average) to the employees, and/or more likely to change for the better, given employees have more willingness to change, giving health management services directed to such conditions the most “bang for the buck.” In other embodiments, health management services may be assigned based on numbers of employees with a particular condition. For example, where health coaching opportunities for employees may be limited because of budgetary constraints, health coaches may be assigned, in part based on the numbers of employees with the condition. In some embodiments, health management services may also be based on the budgetary concerns of an employer. Coaching programs for this or any other population can involve in-person interactions, or web-based or phone-based courses focusing on lifestyle behavior change, health promotion and disease self-management.

Coaching programs or other health management services assigned to individual conditions identified and prioritized through steps 301, 303, 305, 307, and 309 can be incorporated into an individualized health management map, as shown in step 317. Coaching and/or outreach lists can also be generated to help employers monitor employee use of health coaching, outreach programs, and/or other health management services.

Returning to FIG. 1, step 105, according to one embodiment, taking action to maintain and improve health of an individual employee can be accomplished by, among other things, providing an individualized health management map to increase the individual's engagement through personalized or highly personalized and generally easy-to-use information relating to the individual's health and wellness. Unlike existing health and well-being programs, an individualized health management map can be used to address the full continuum of health-modifying behavior at an individual level.

In one embodiment, providing an individualized health management map can include information from a completed or partially completed HRA, results from health and/or biometric screening, and/or claim data or other outside data. An individualized health management map may be developed for each individual based on the individual's HRA, health and/or biometric screening results, claim data or other outside data, and/or identification in one or more modifiable condition/lifestyle behavior subsets, as described above. An individualized health management map may include a focus on a variety of modifiable conditions and lifestyle behaviors that contribute to increased costs and reduced productivity. In one embodiment, a computing system environment, such as but not limited to system environment 225, may be used to develop the health management map using data input to the system relating to information from a completed or partially completed HRA, results from health and/or biometric screening, and/or claim data or other outside data.

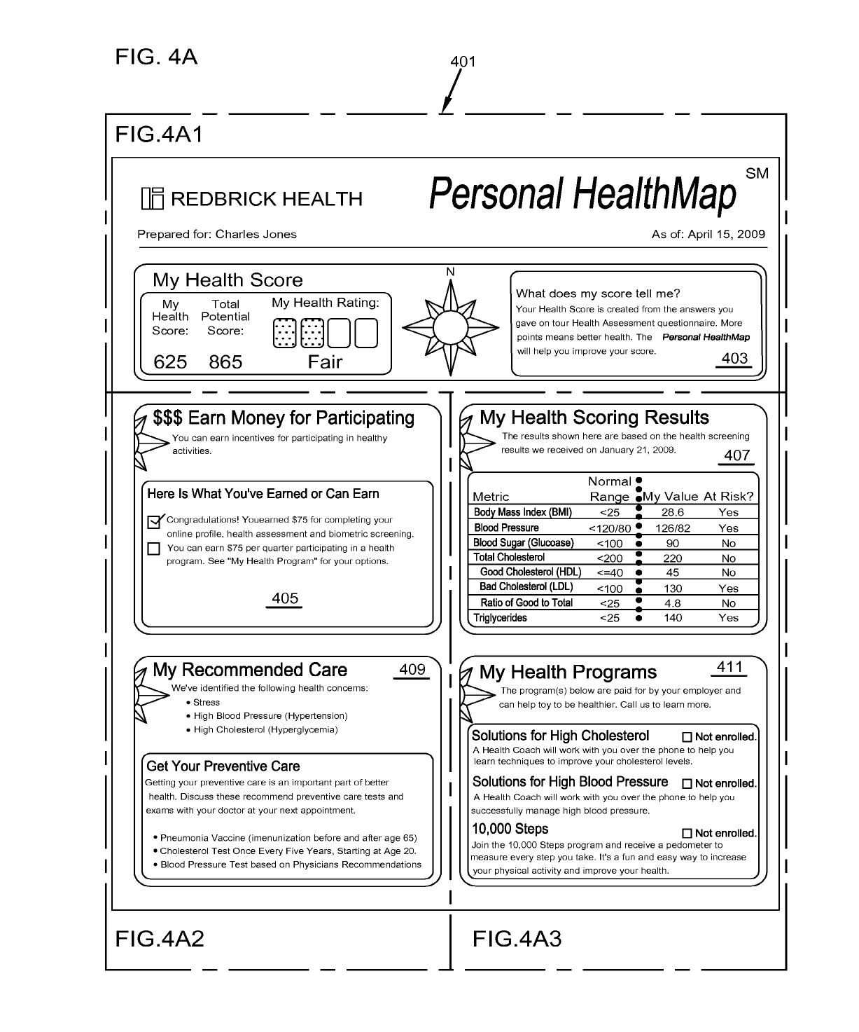

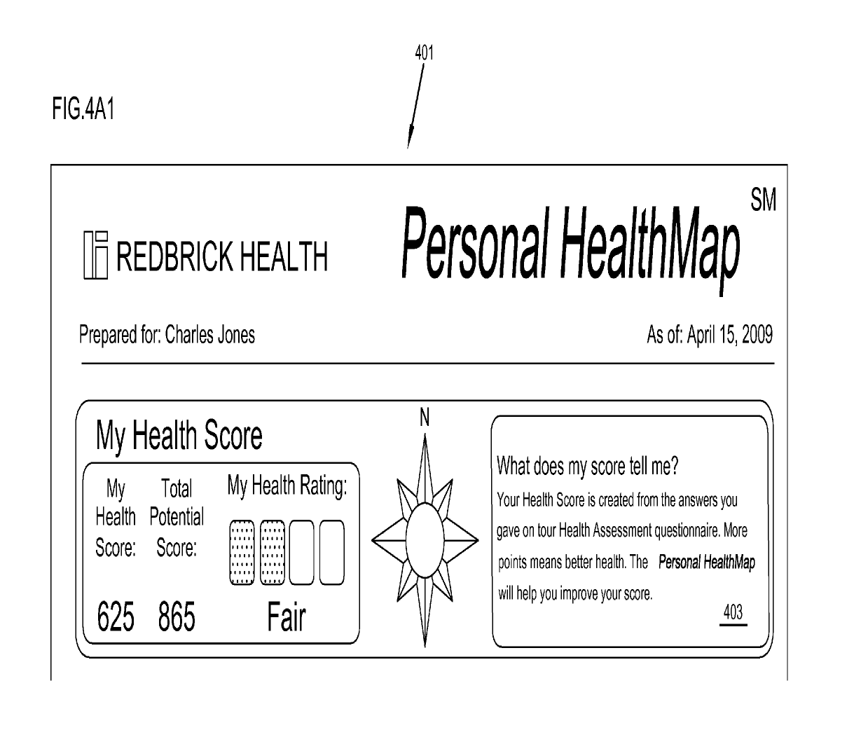

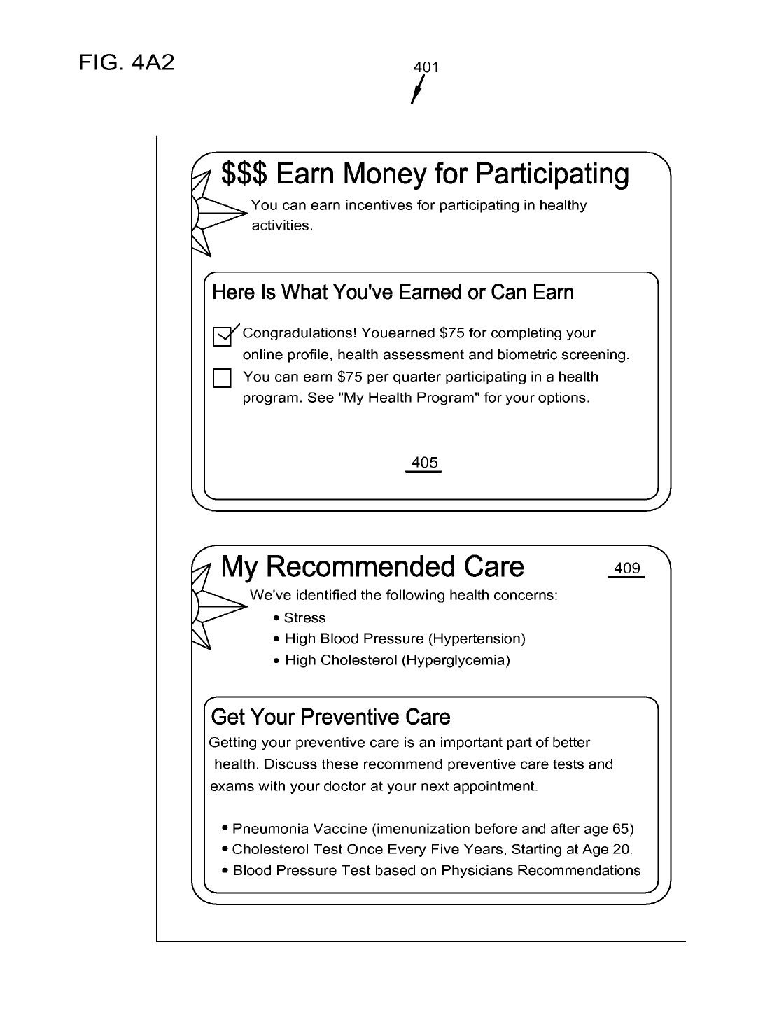

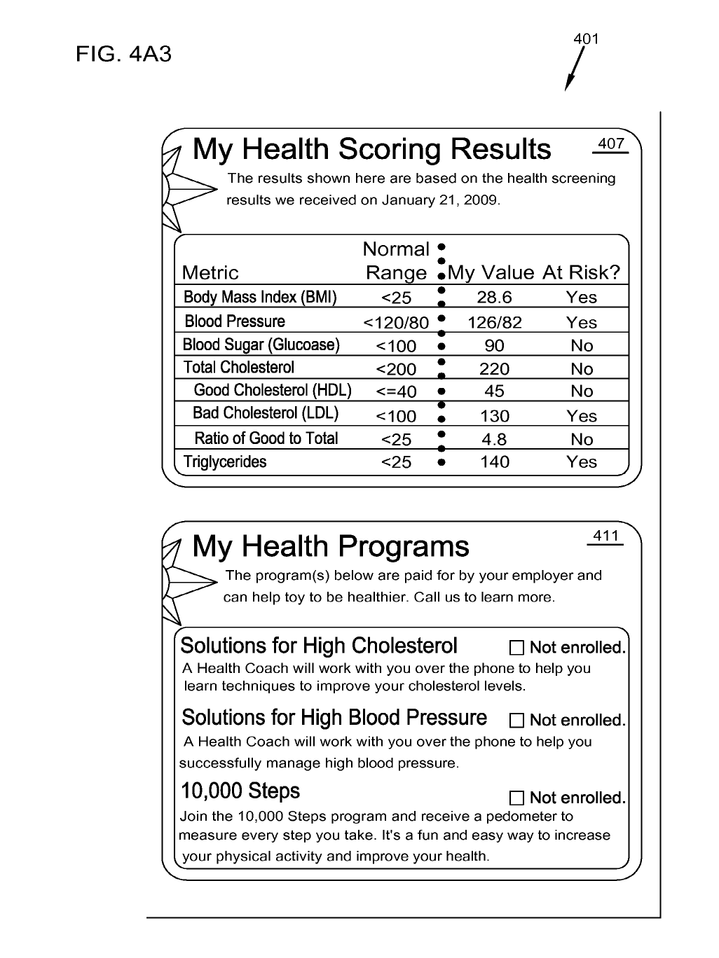

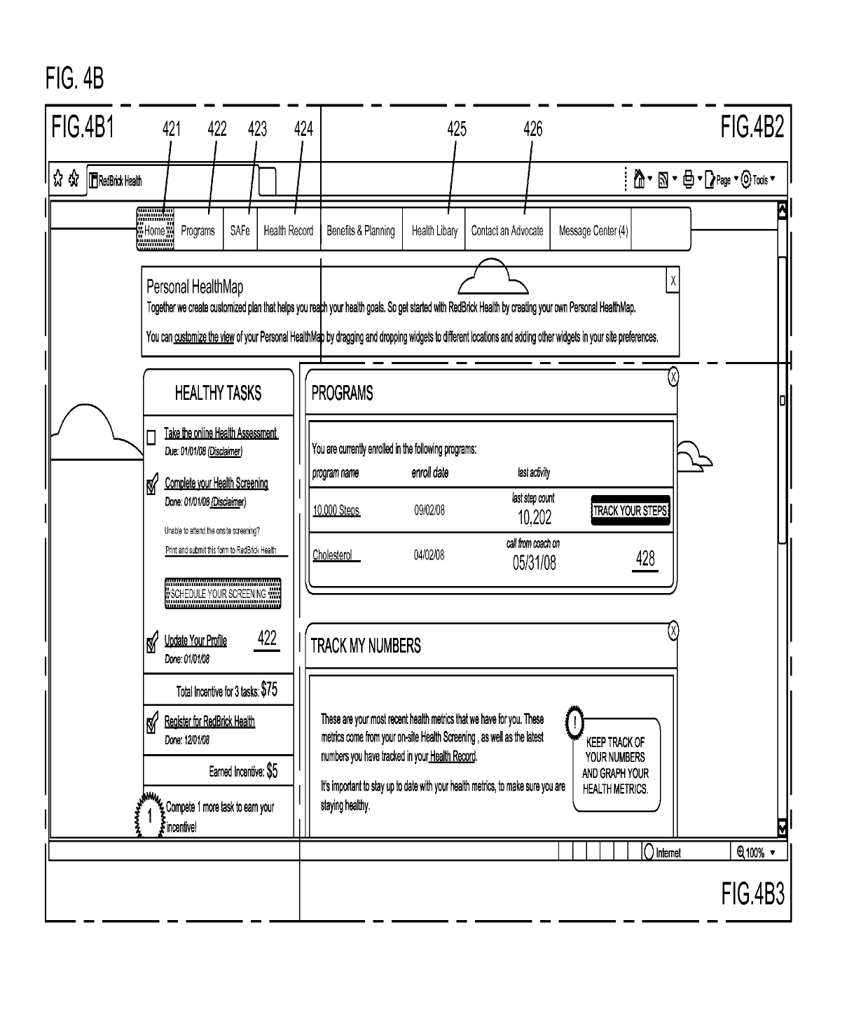

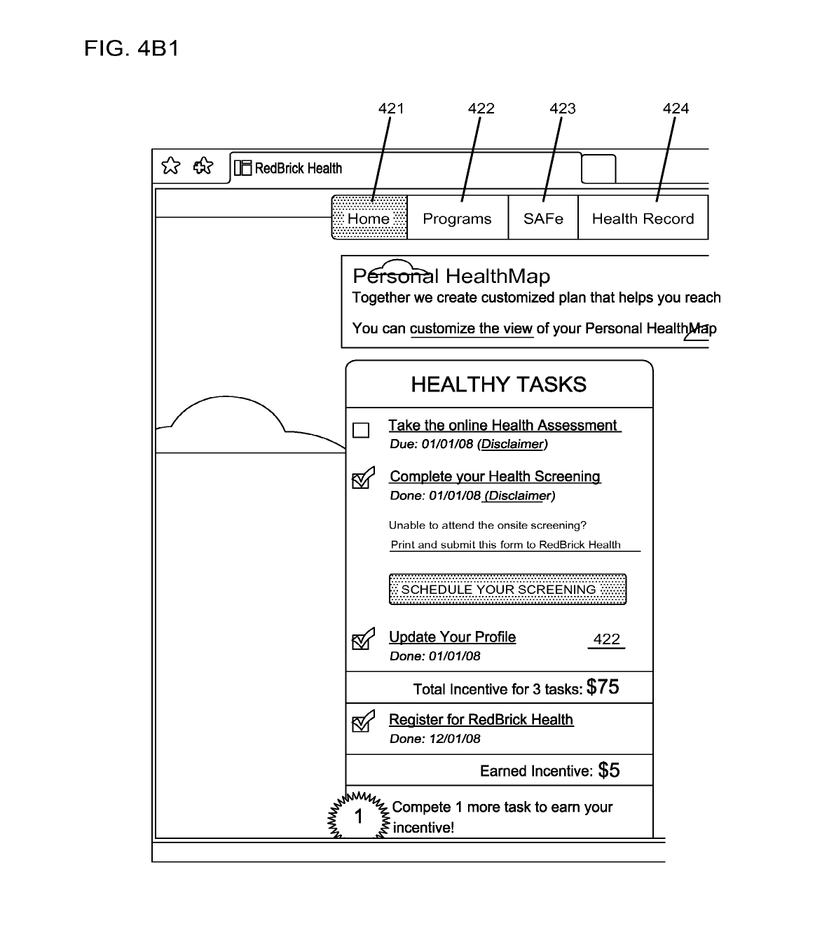

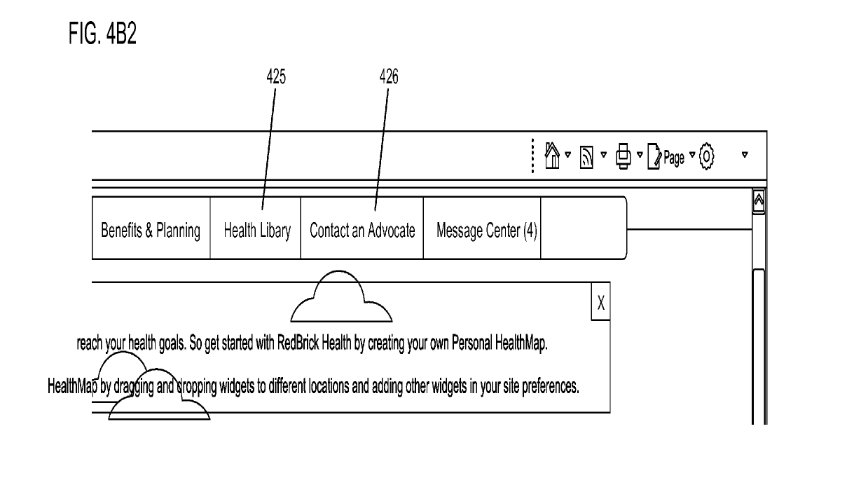

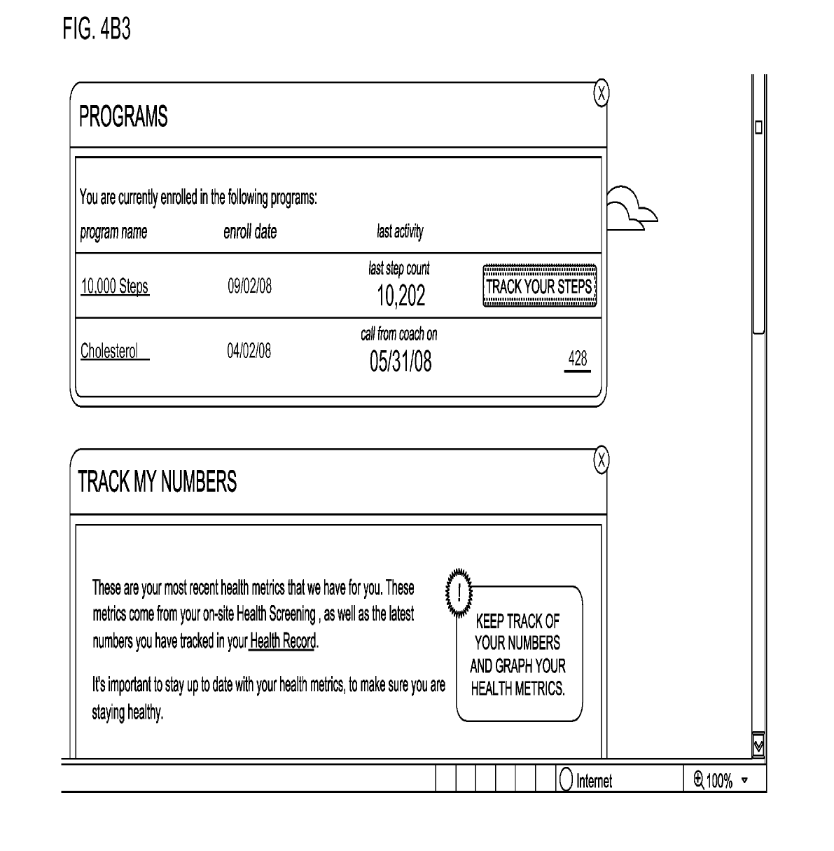

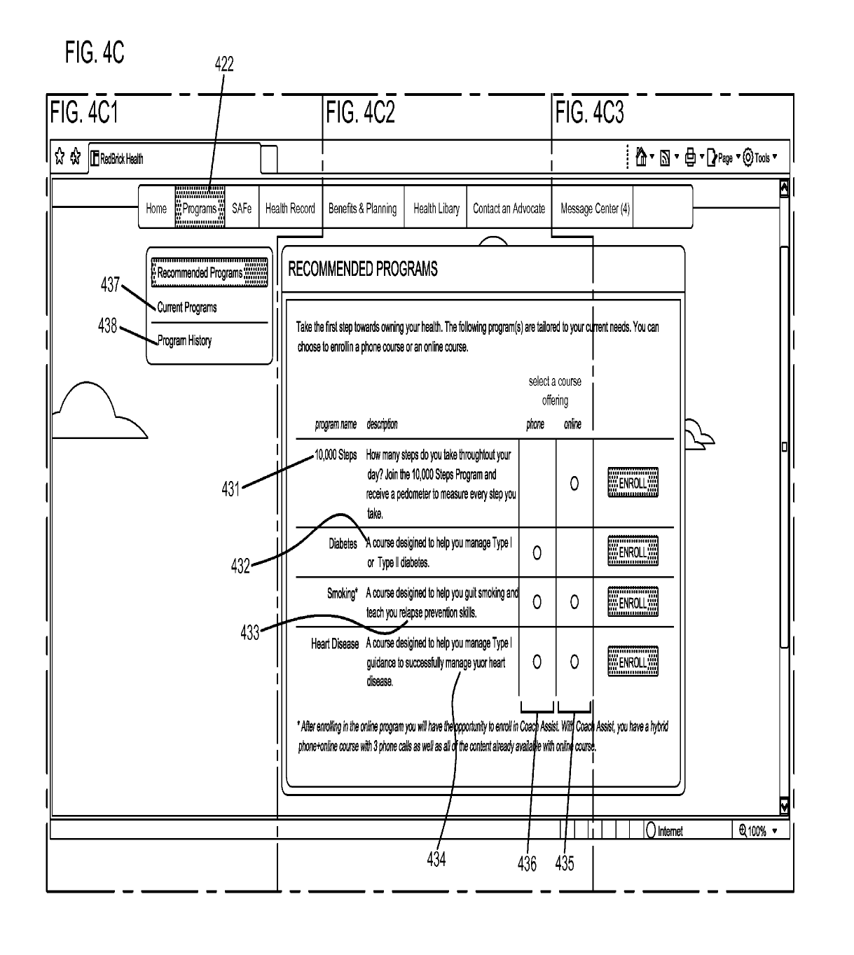

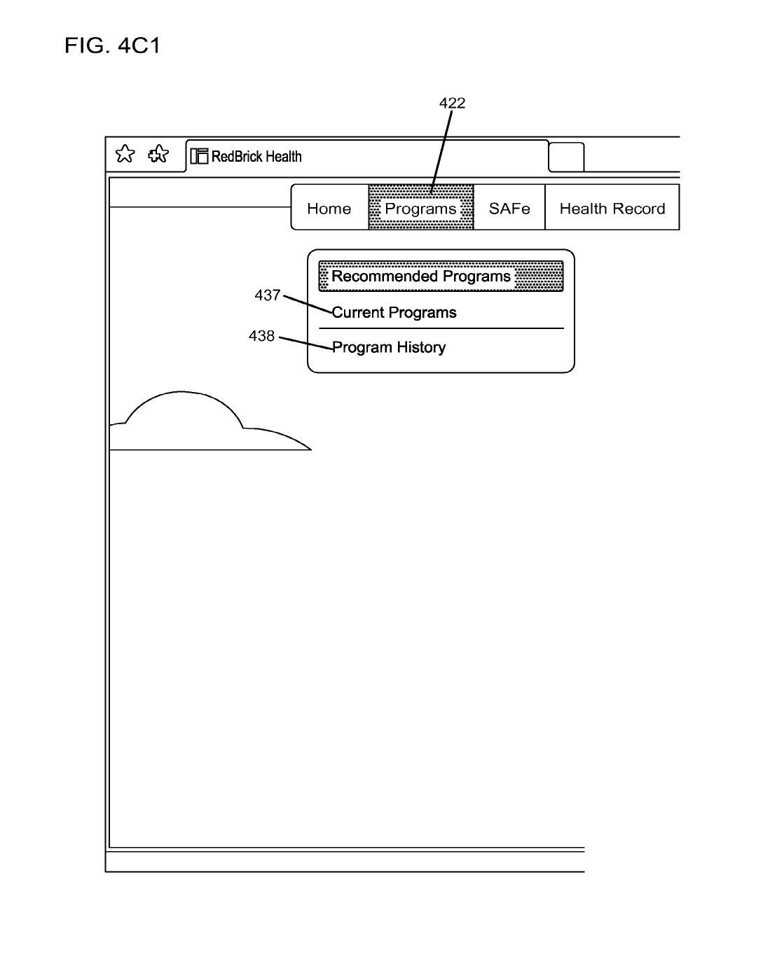

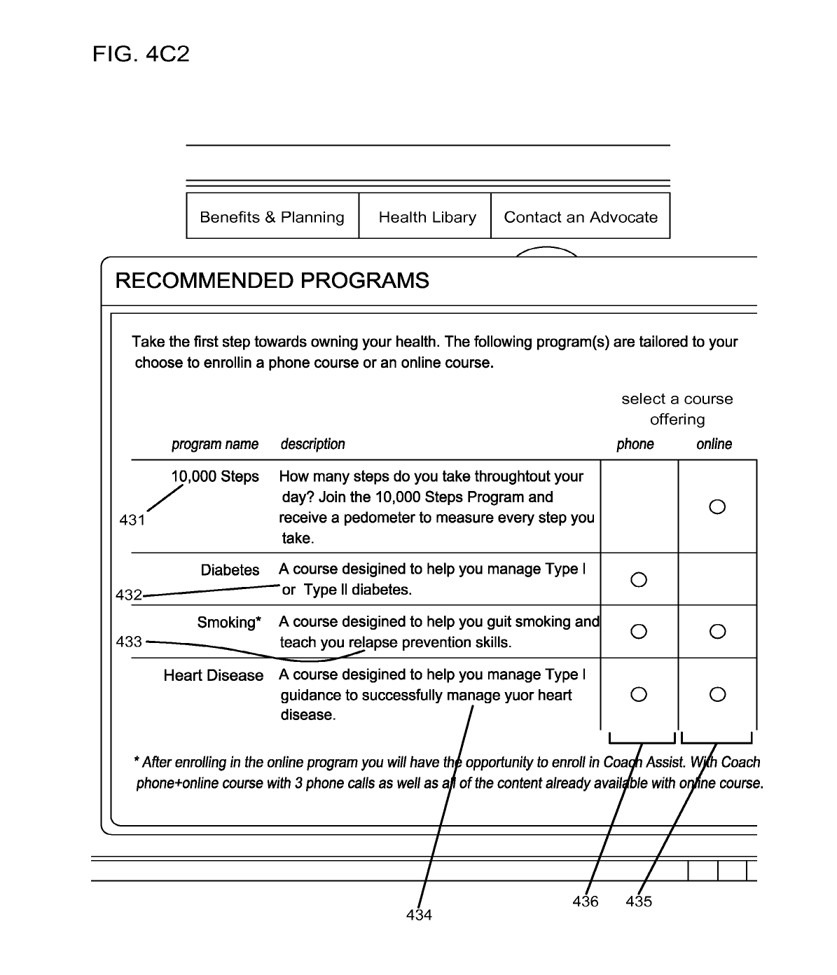

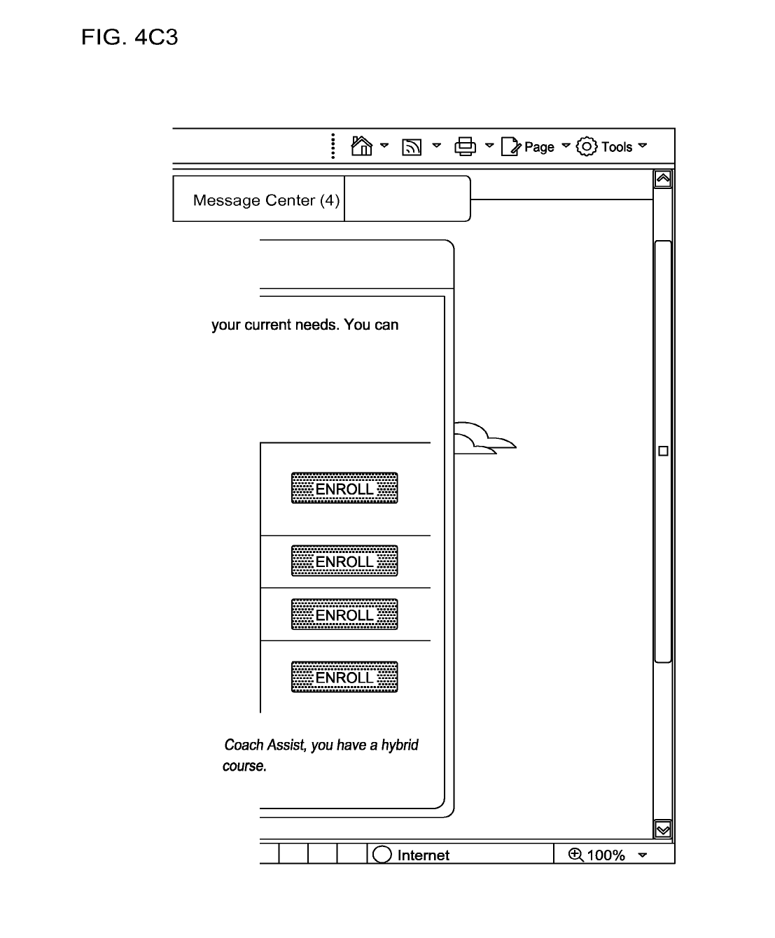

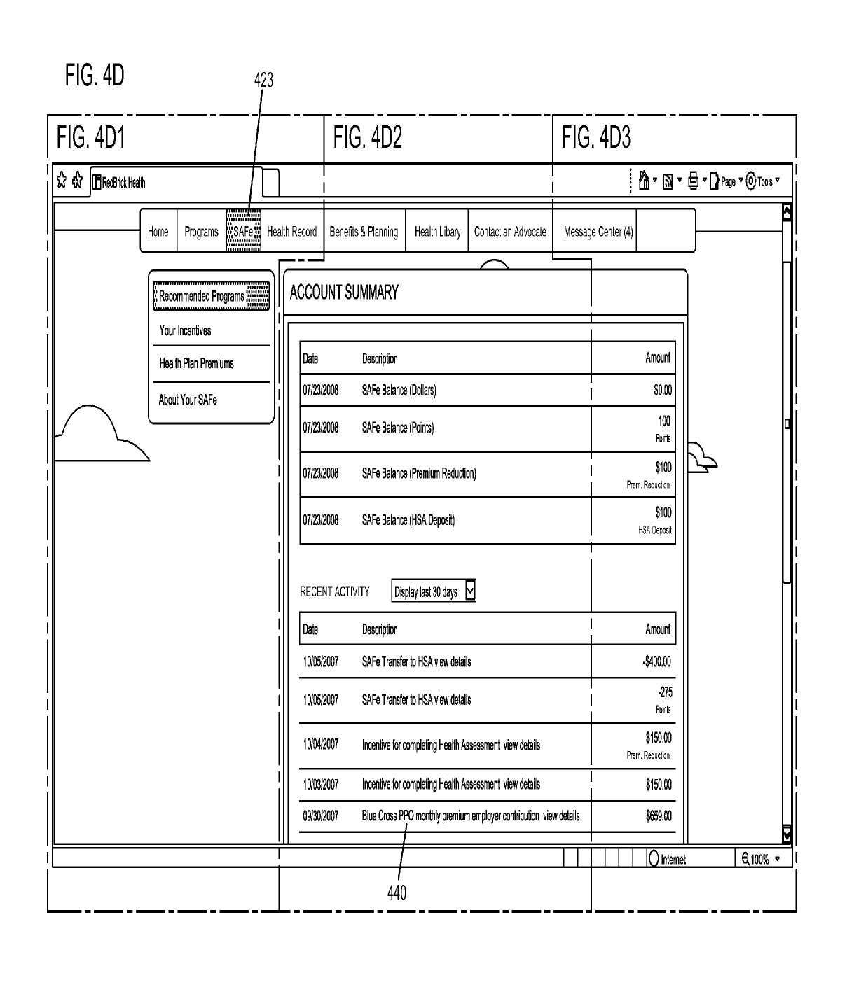

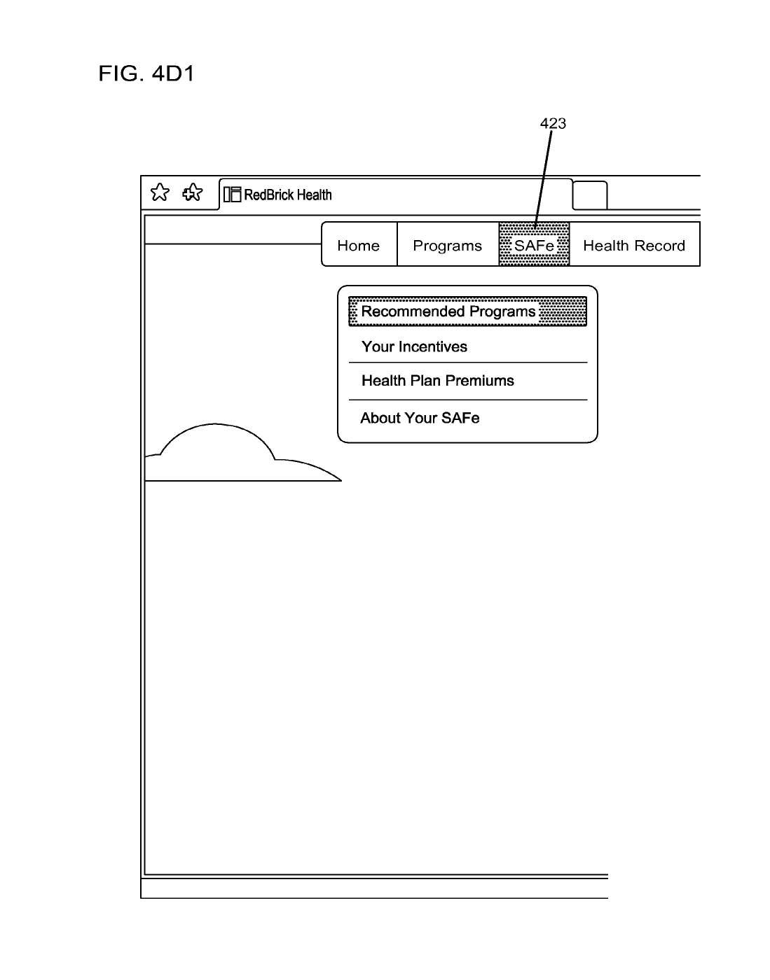

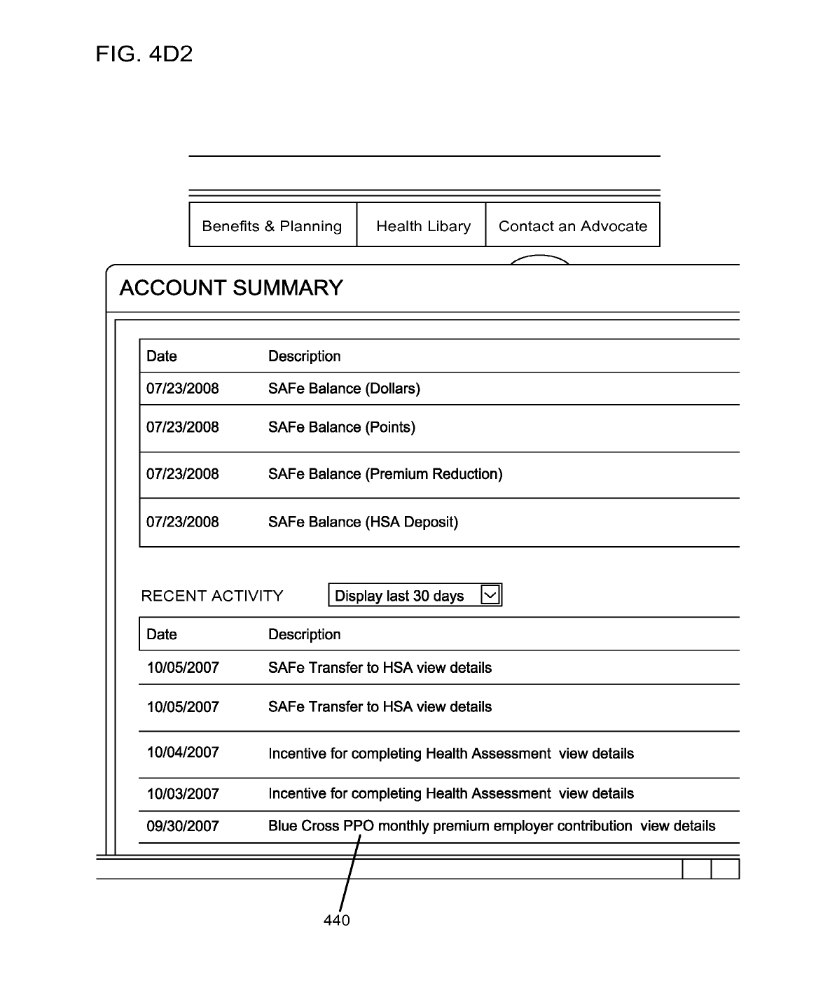

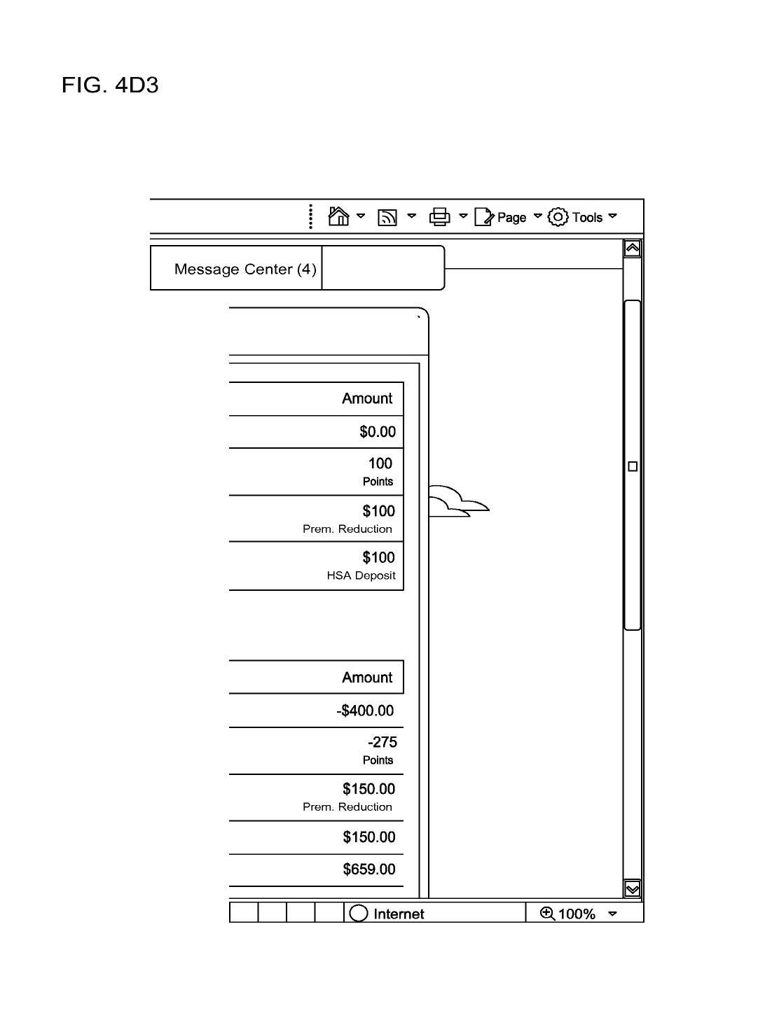

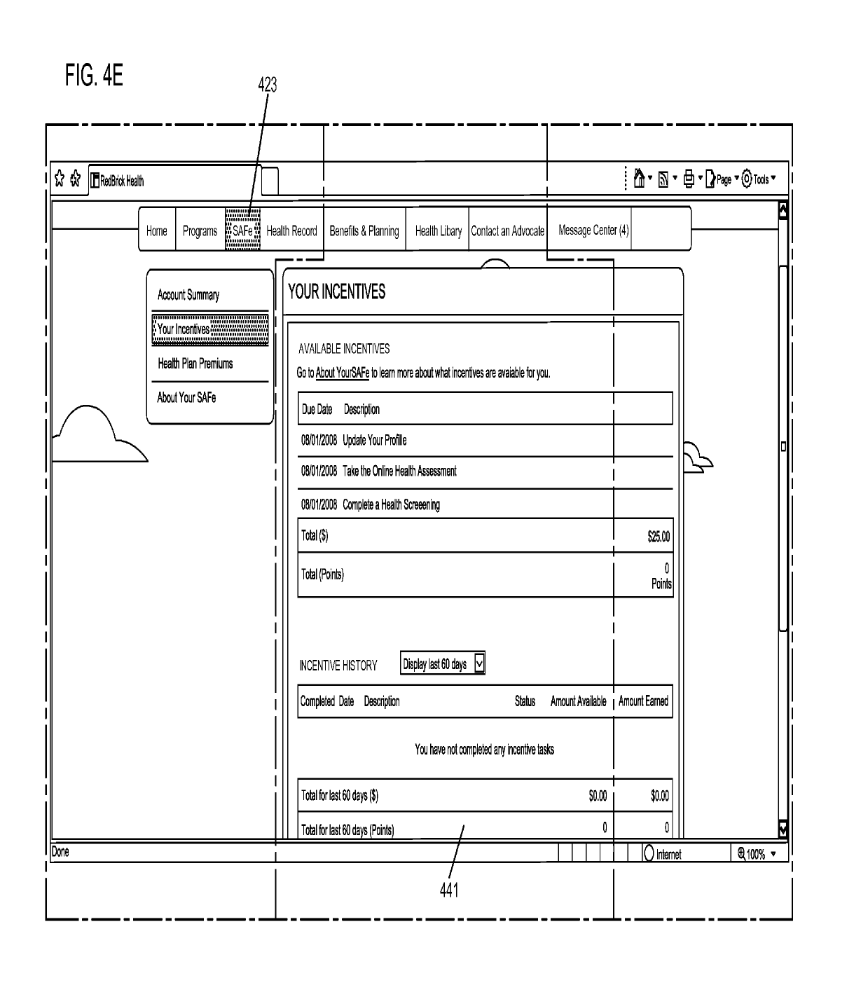

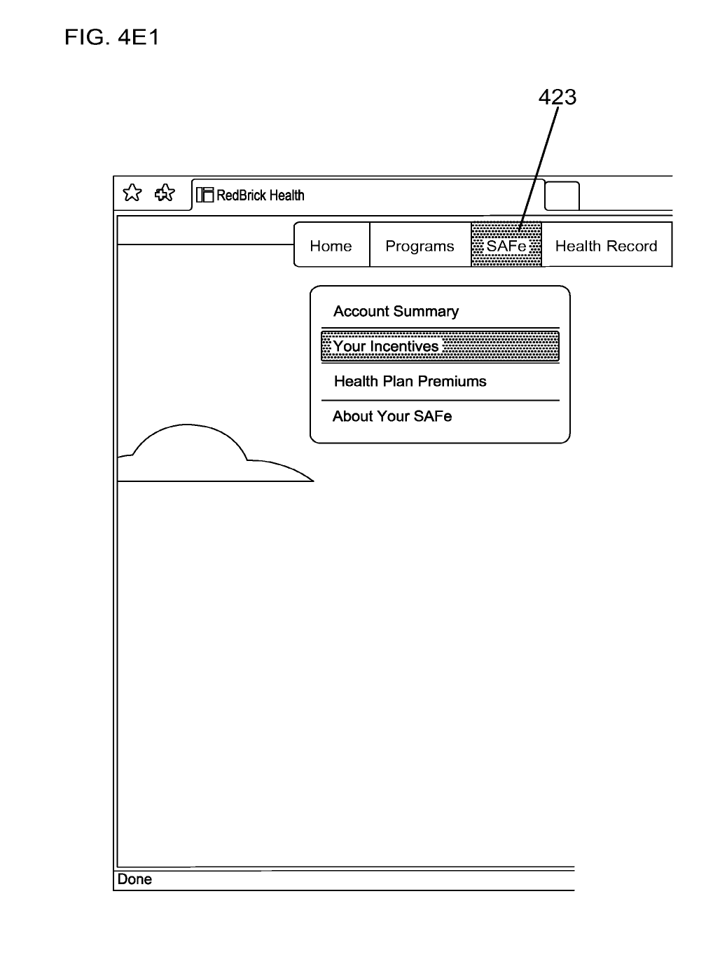

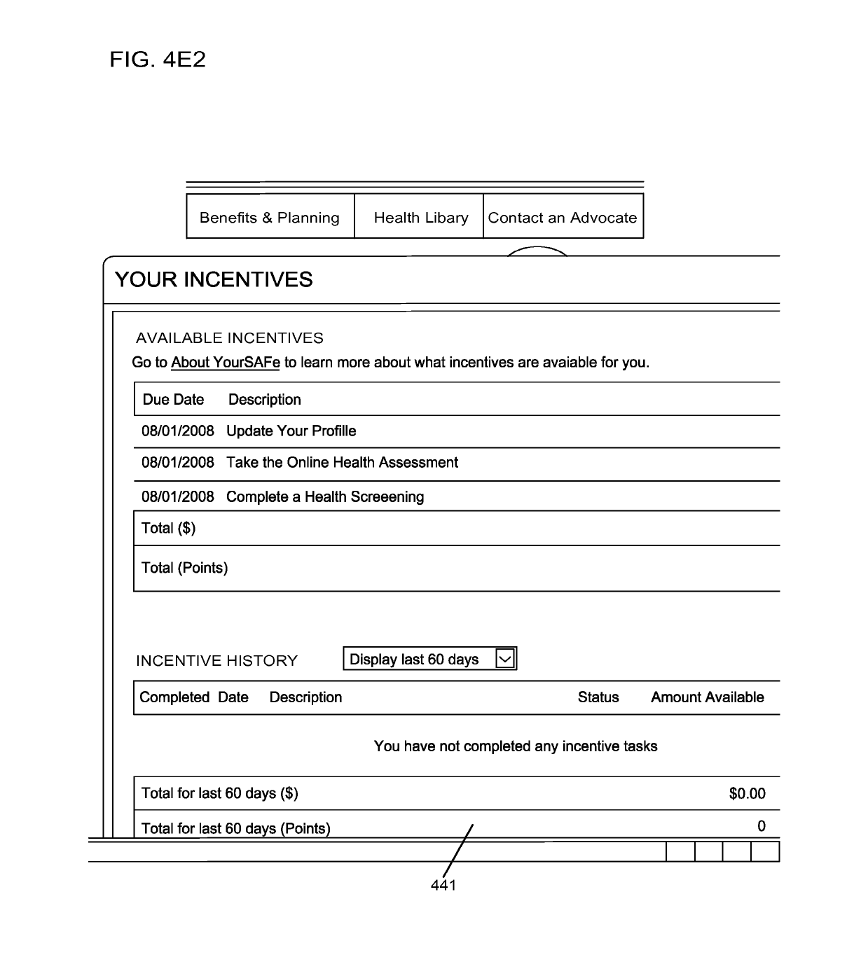

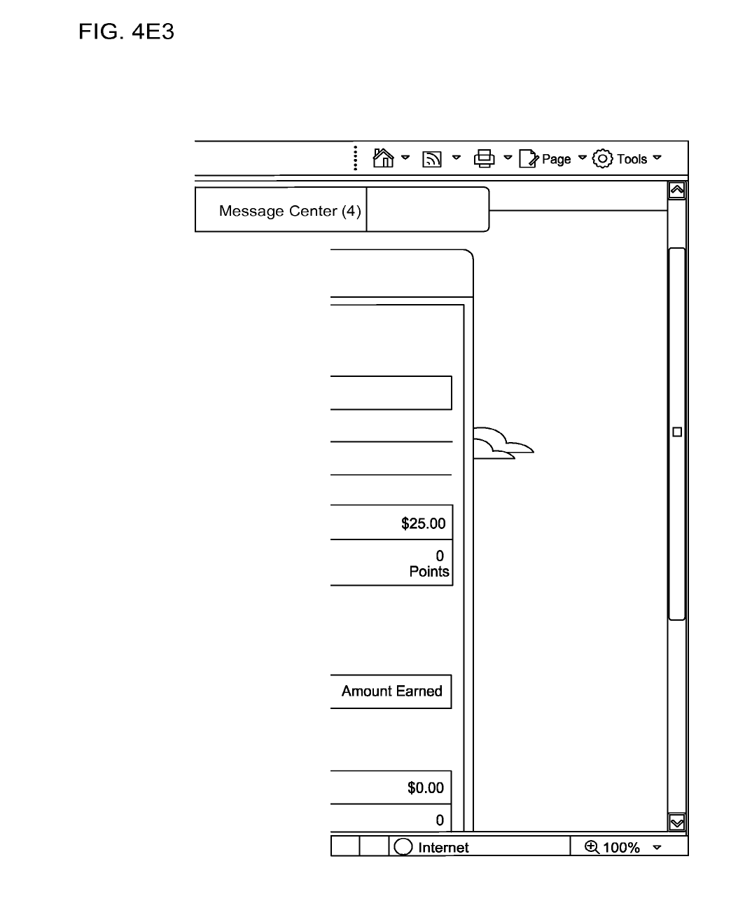

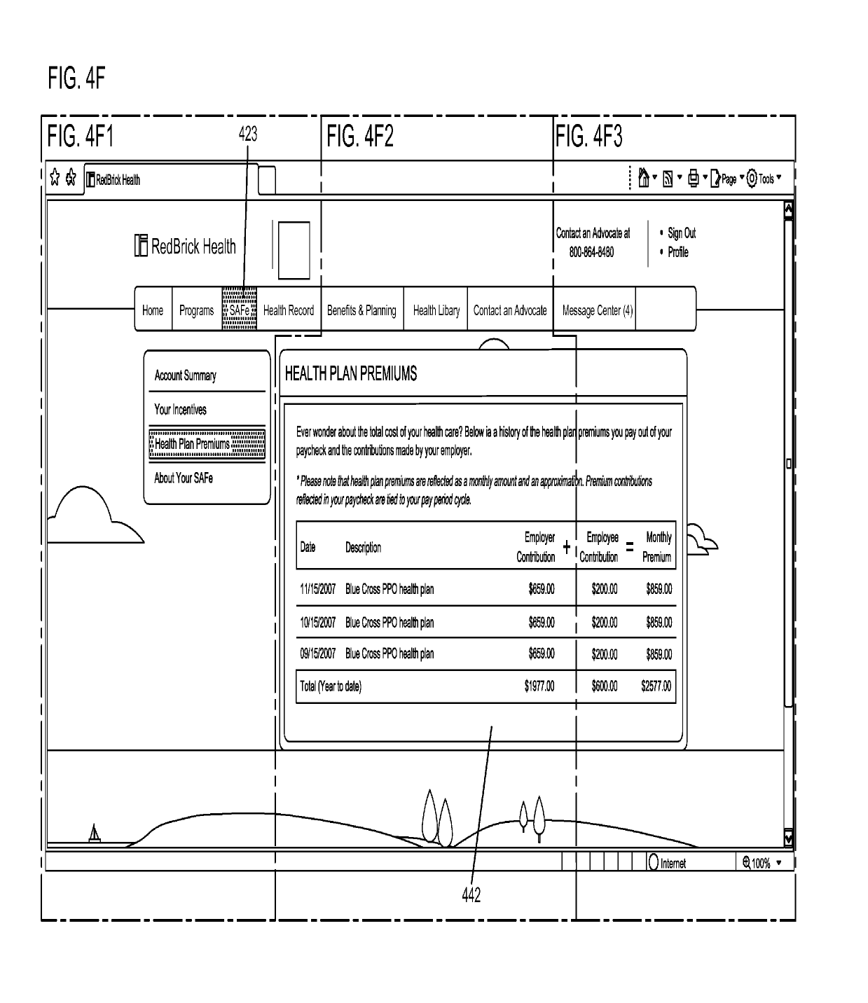

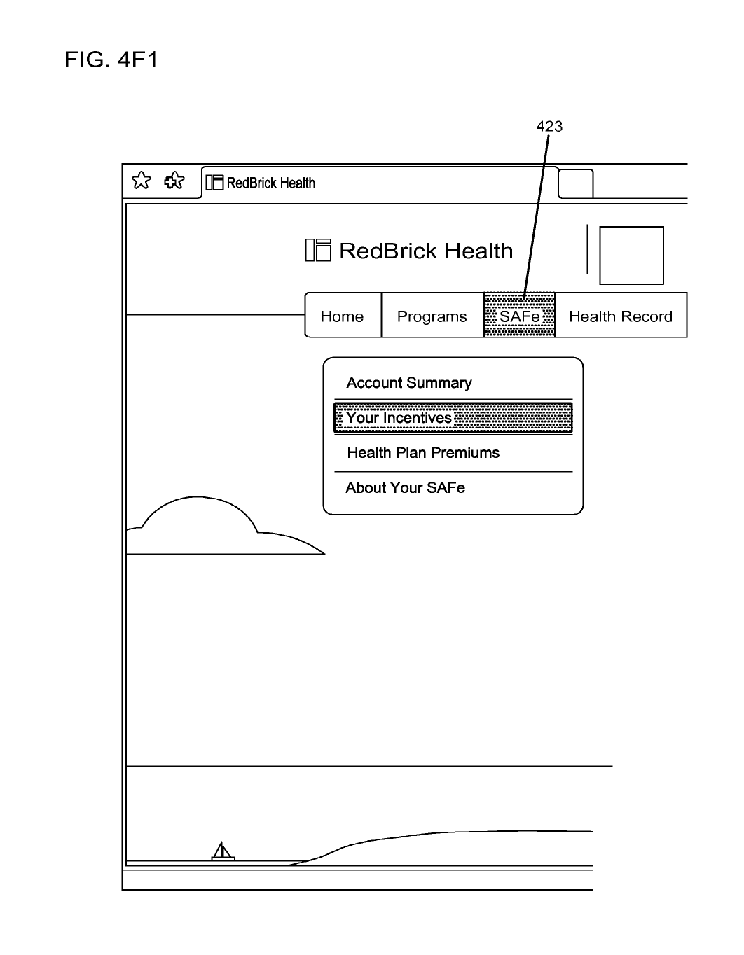

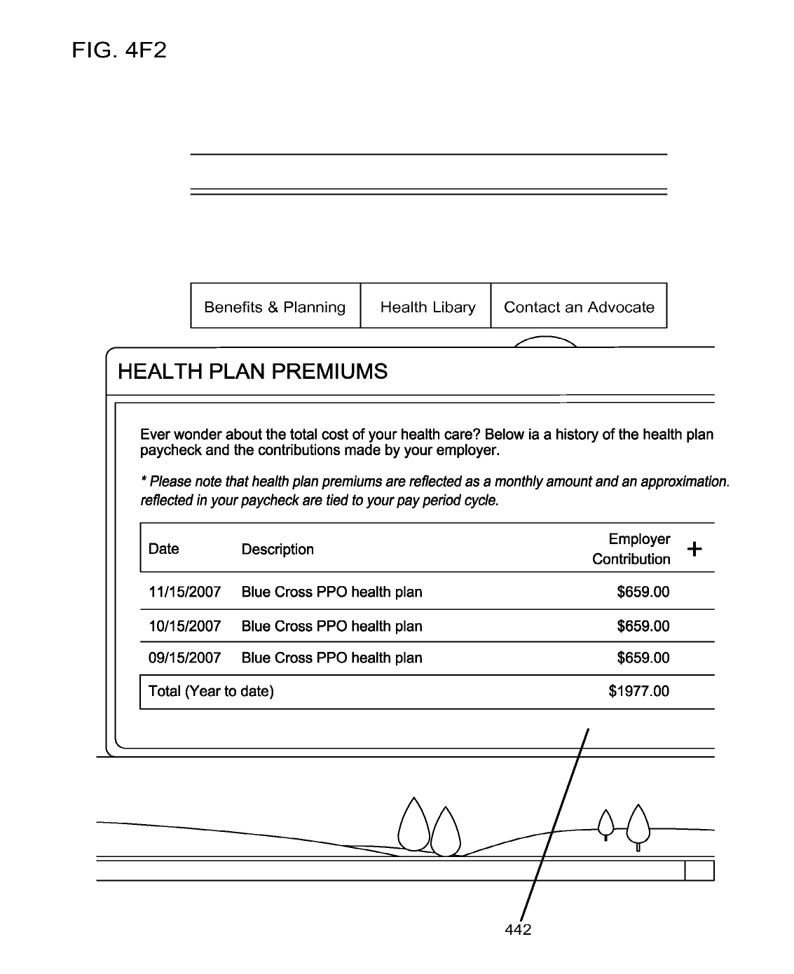

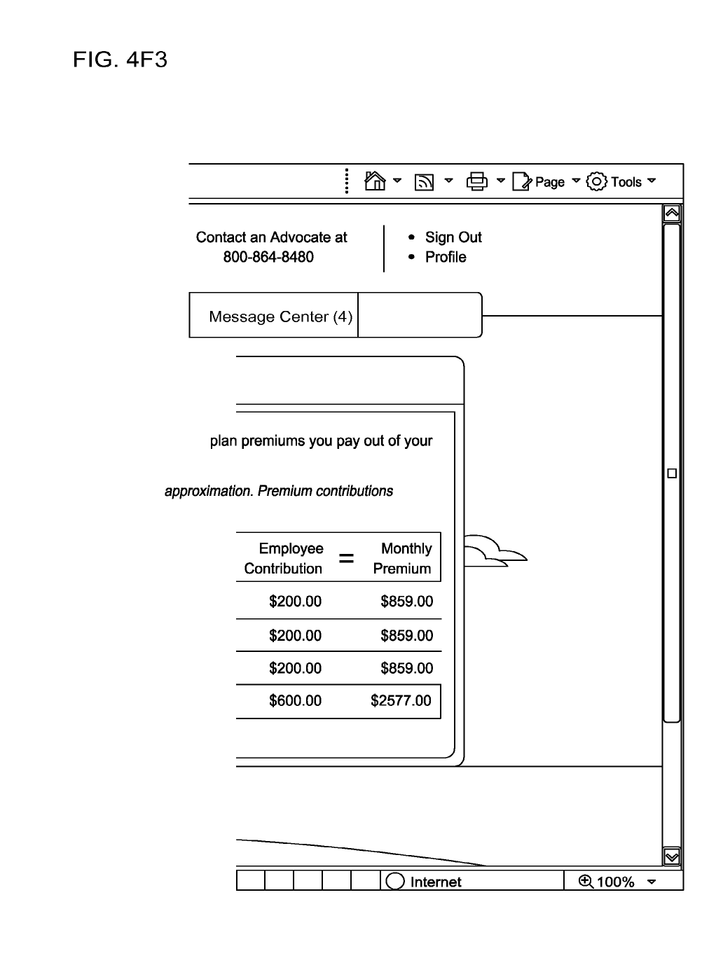

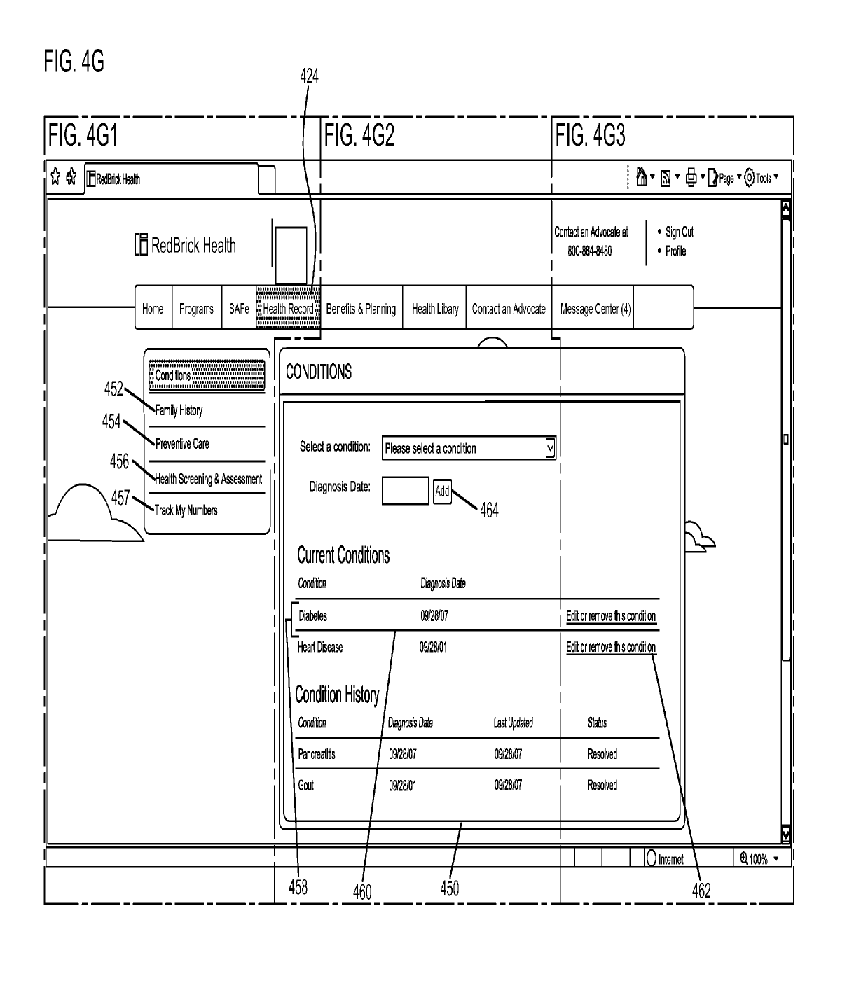

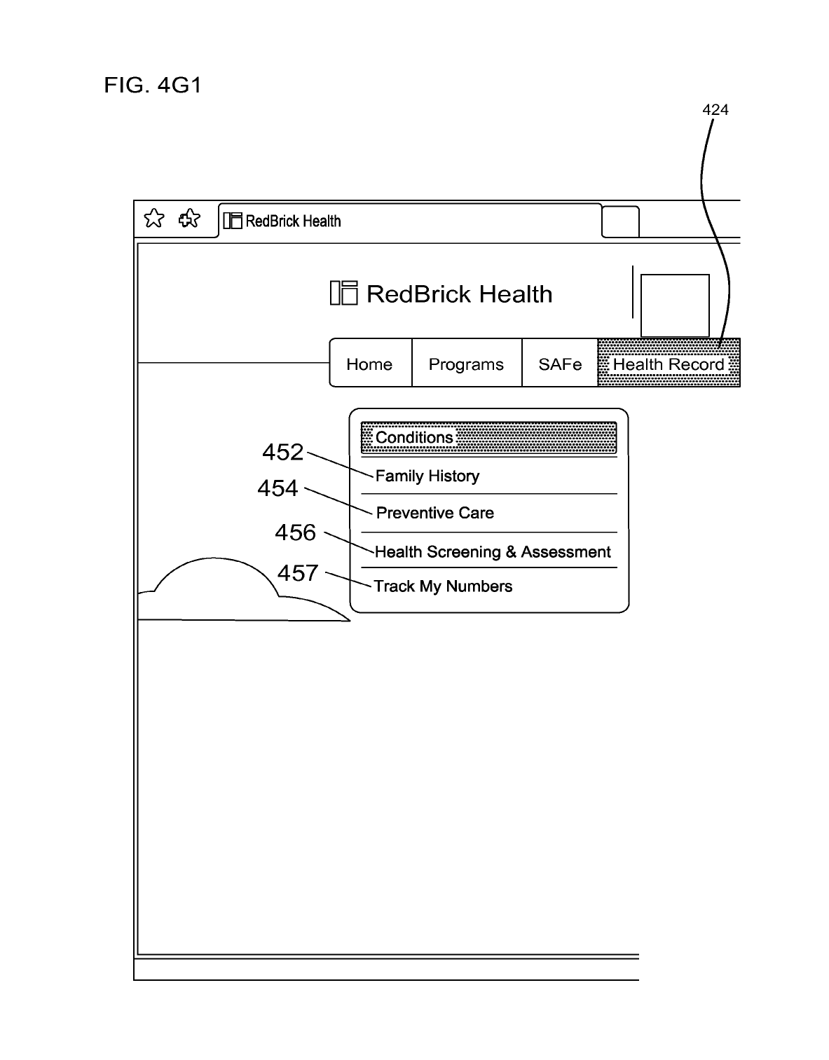

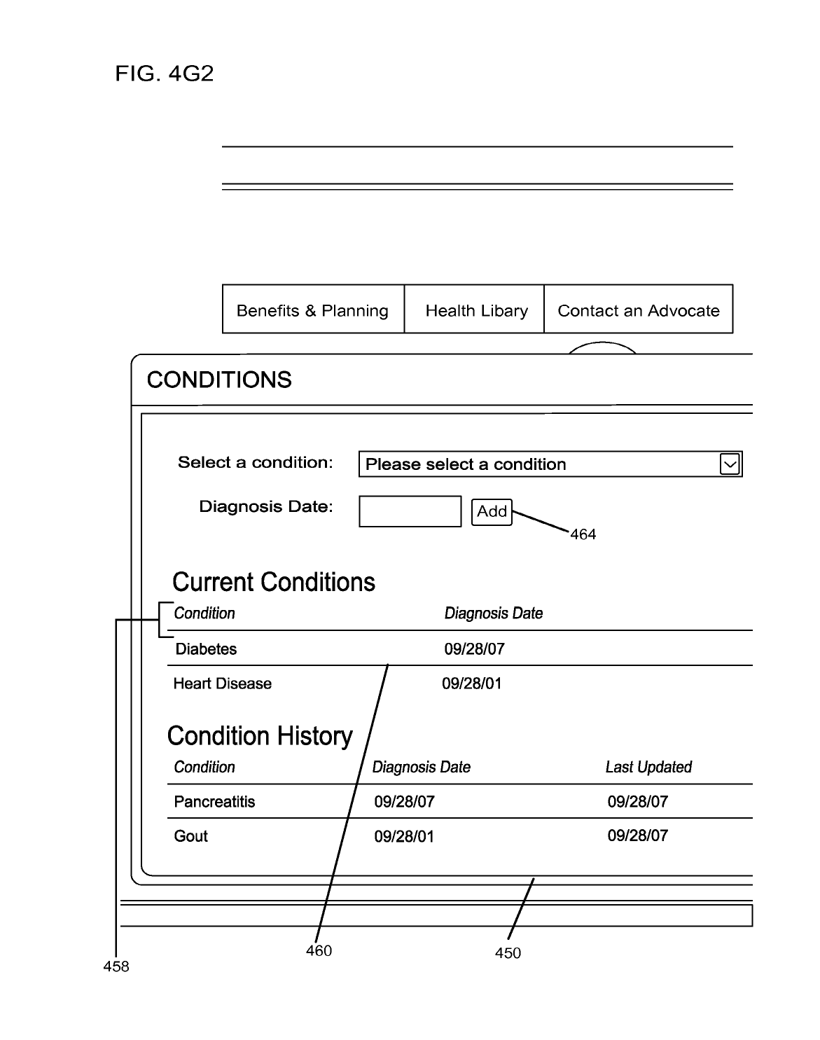

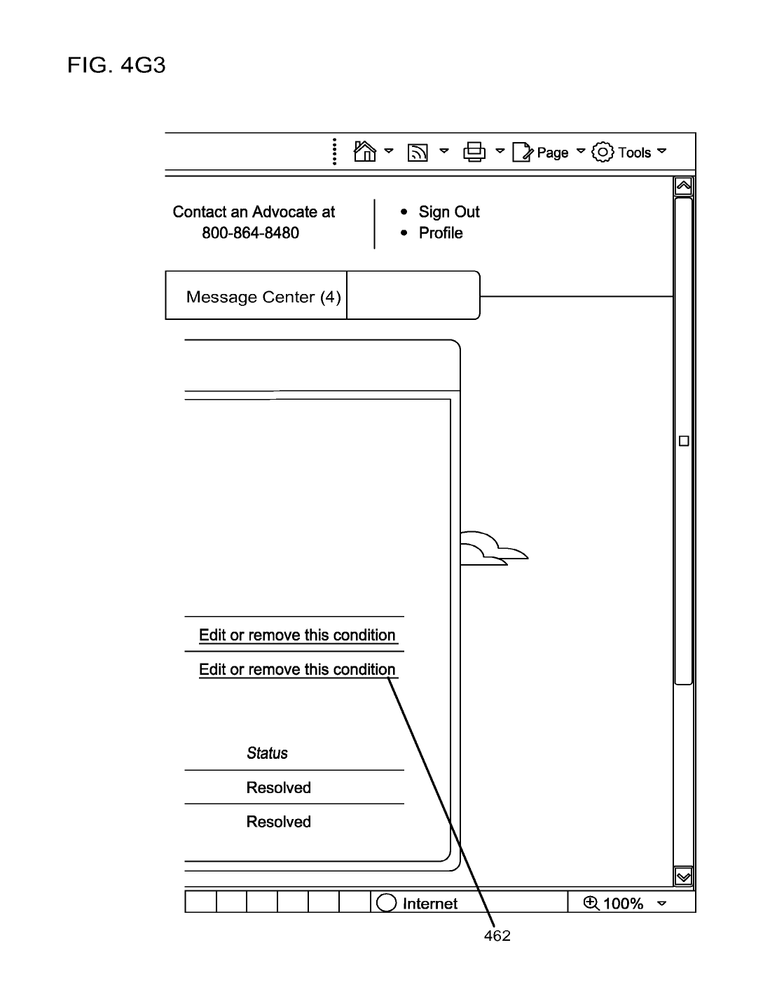

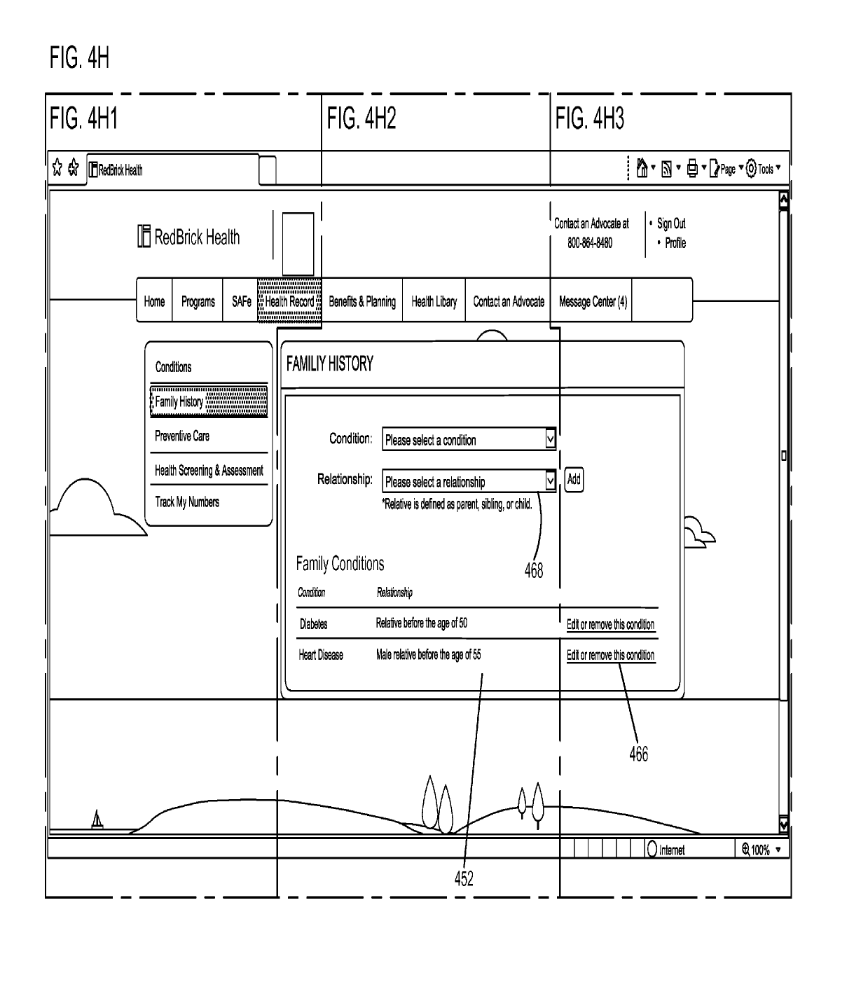

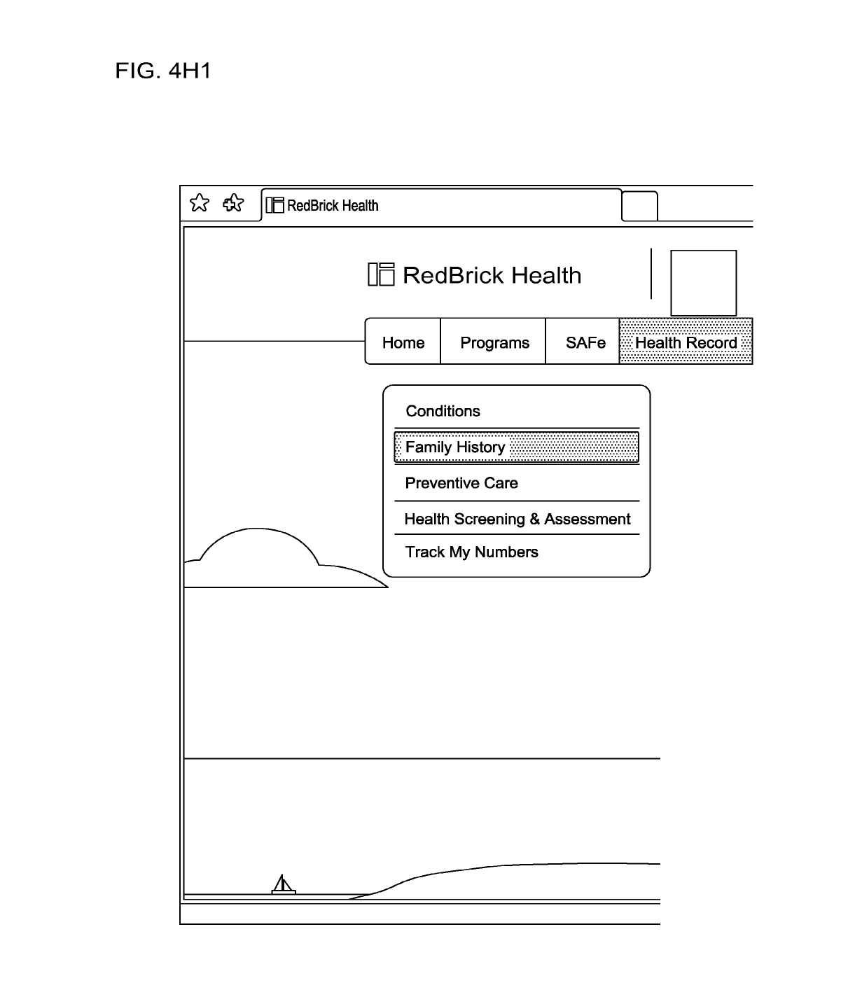

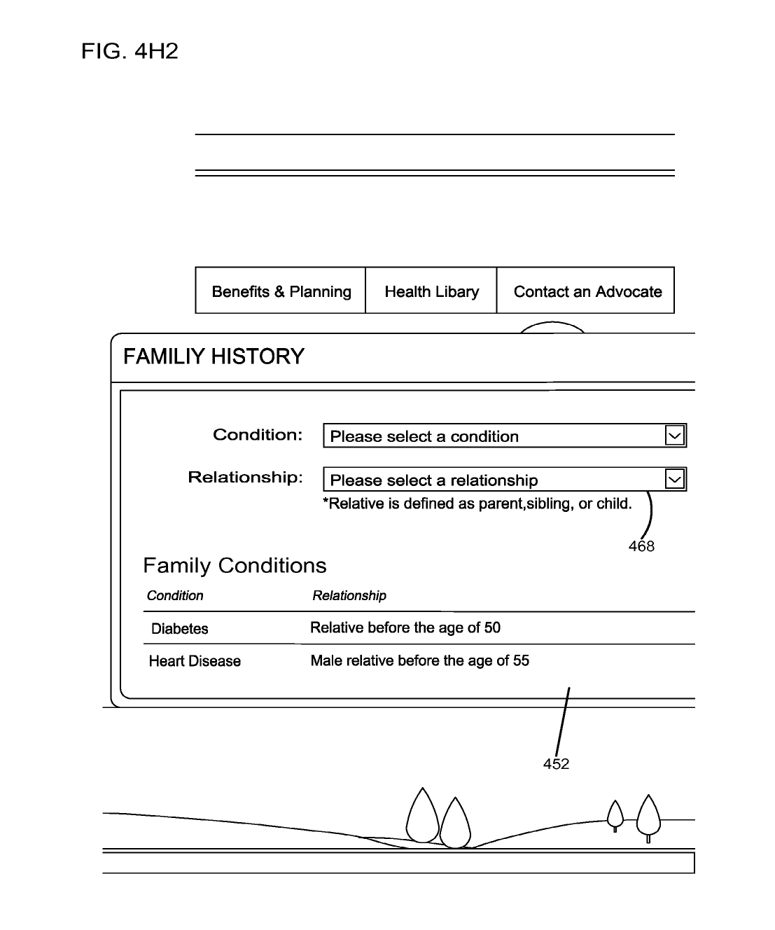

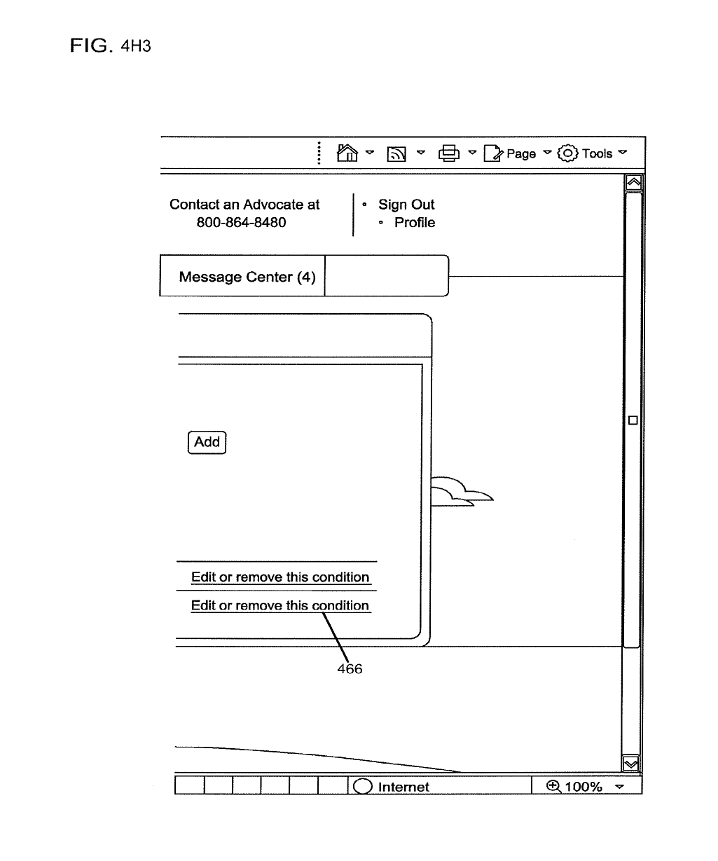

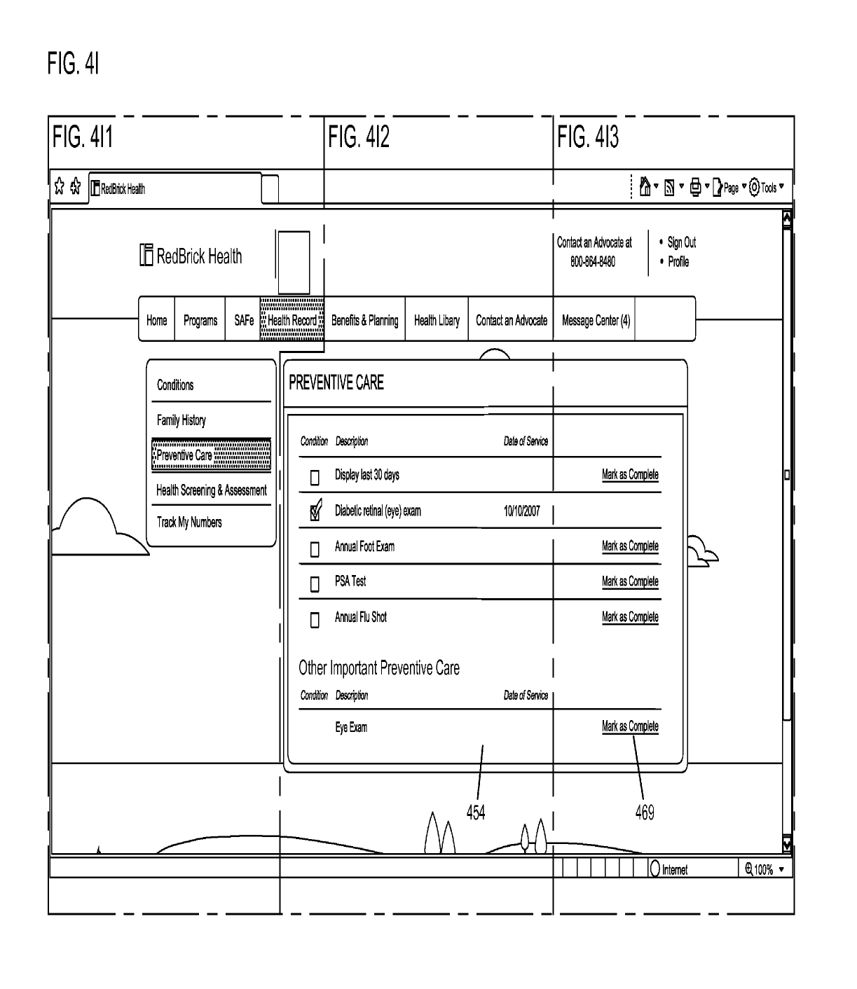

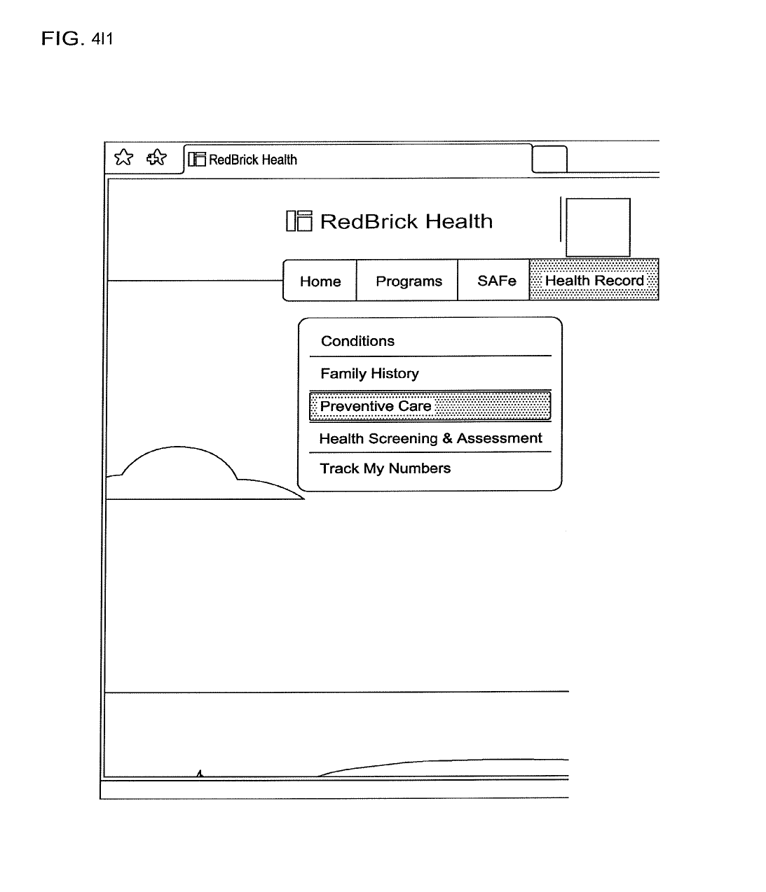

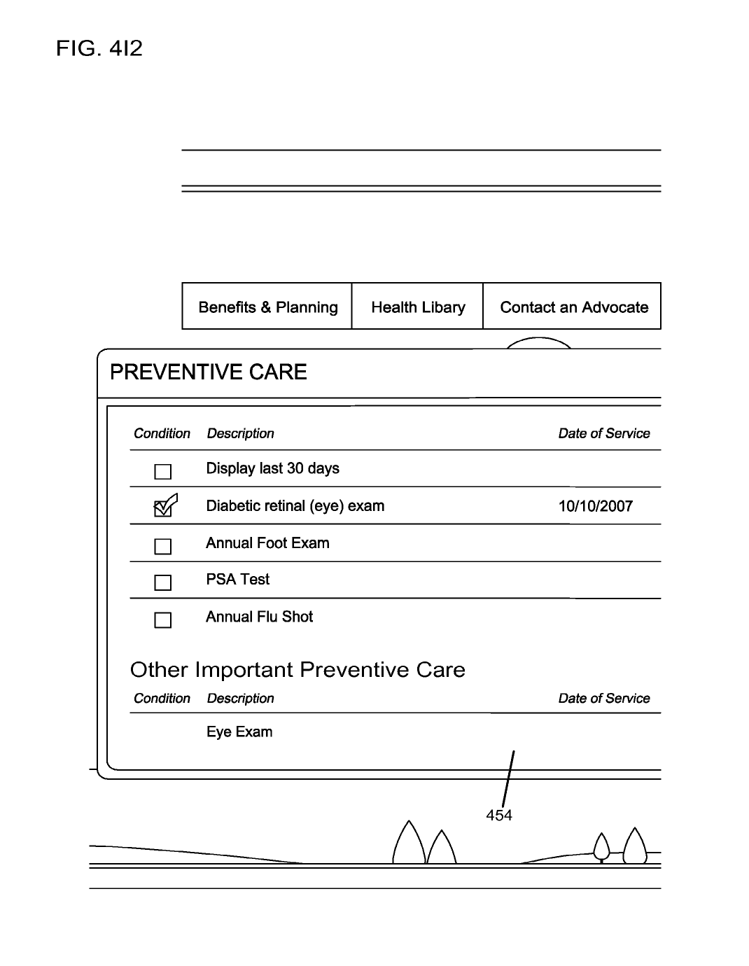

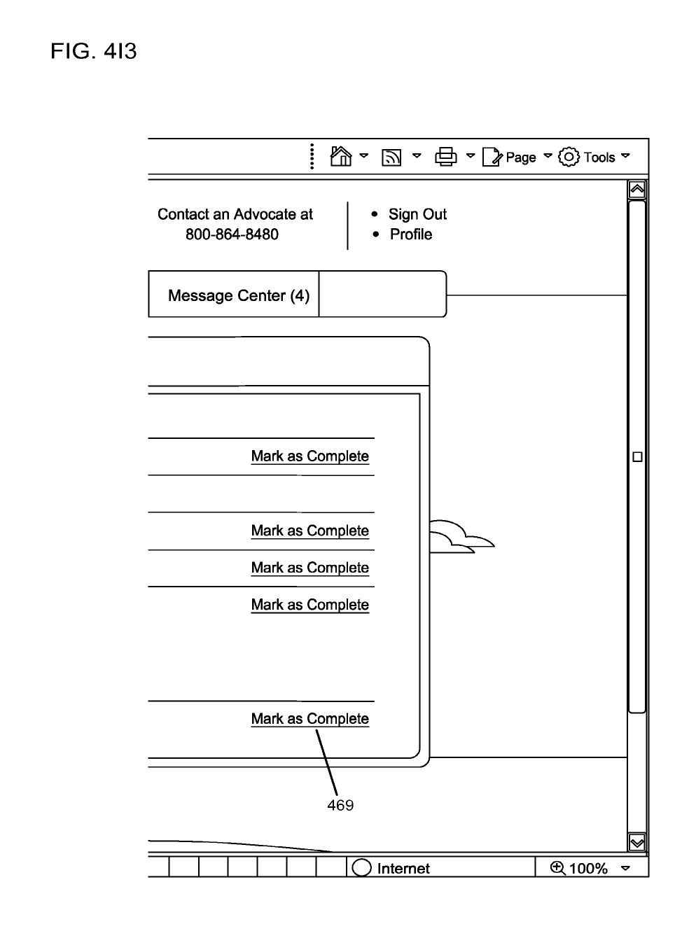

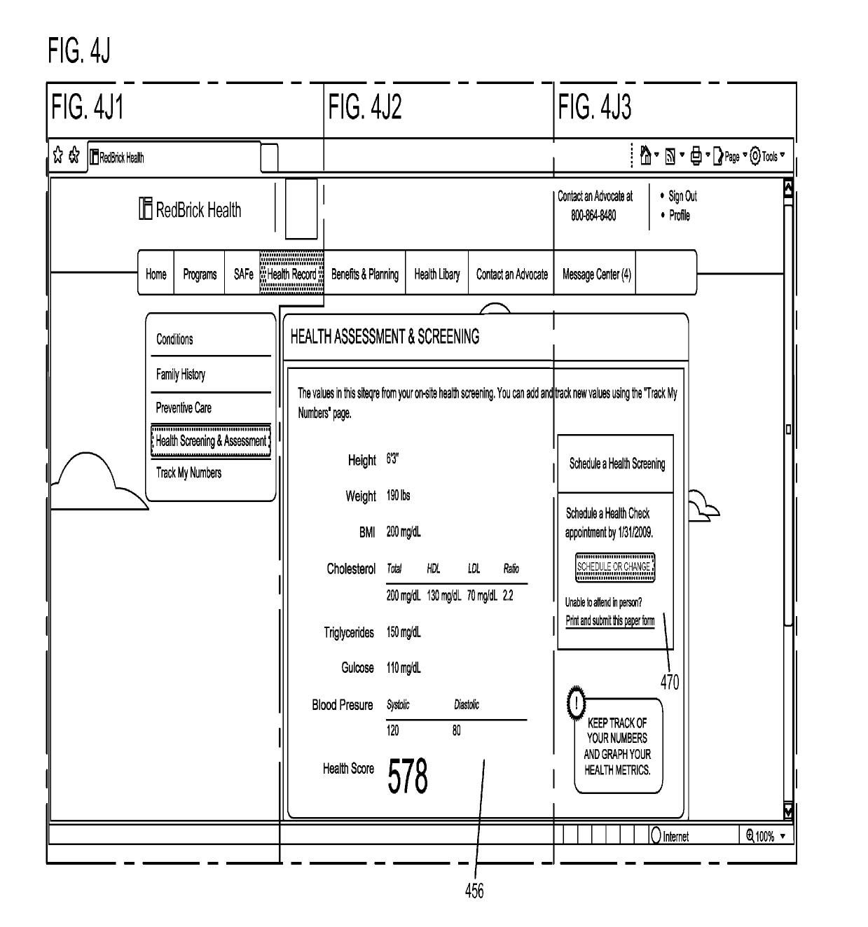

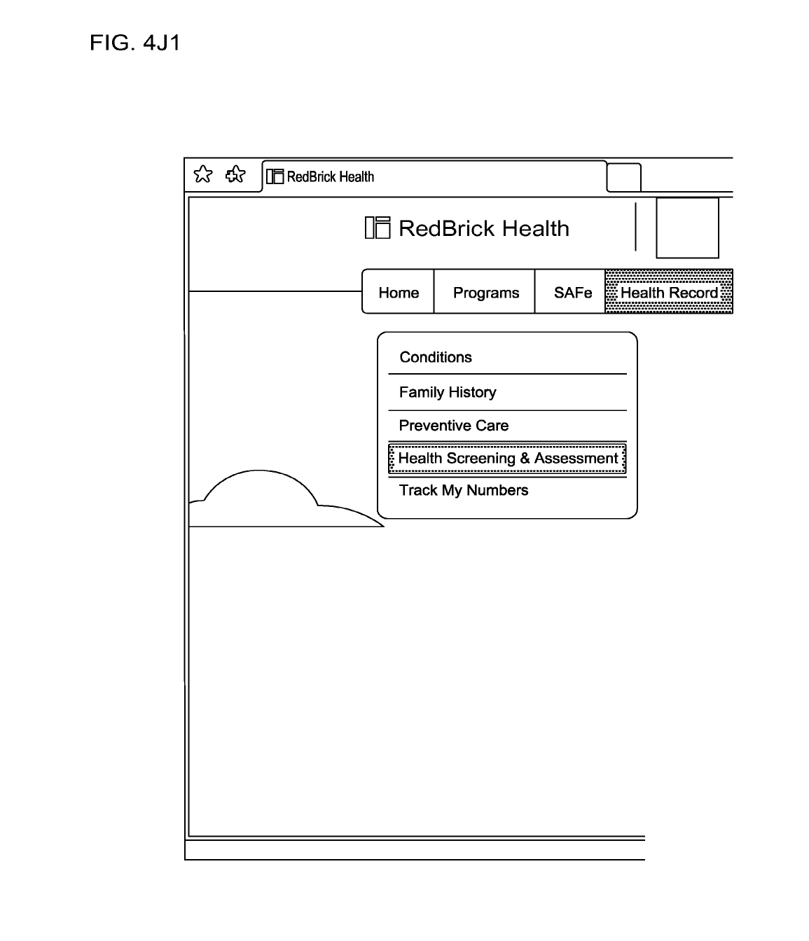

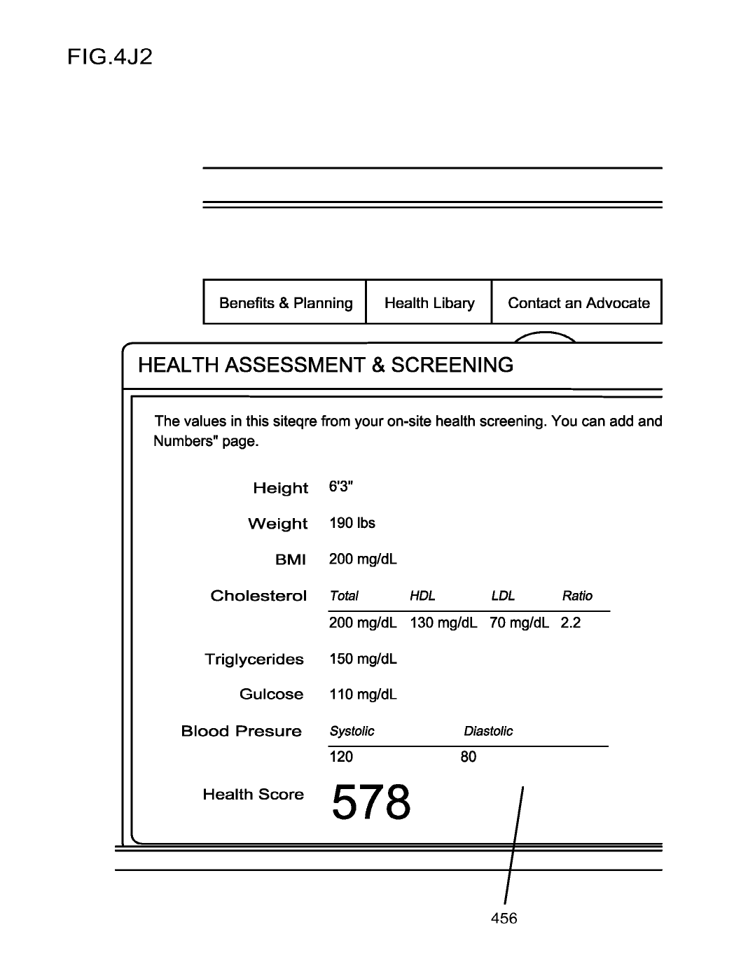

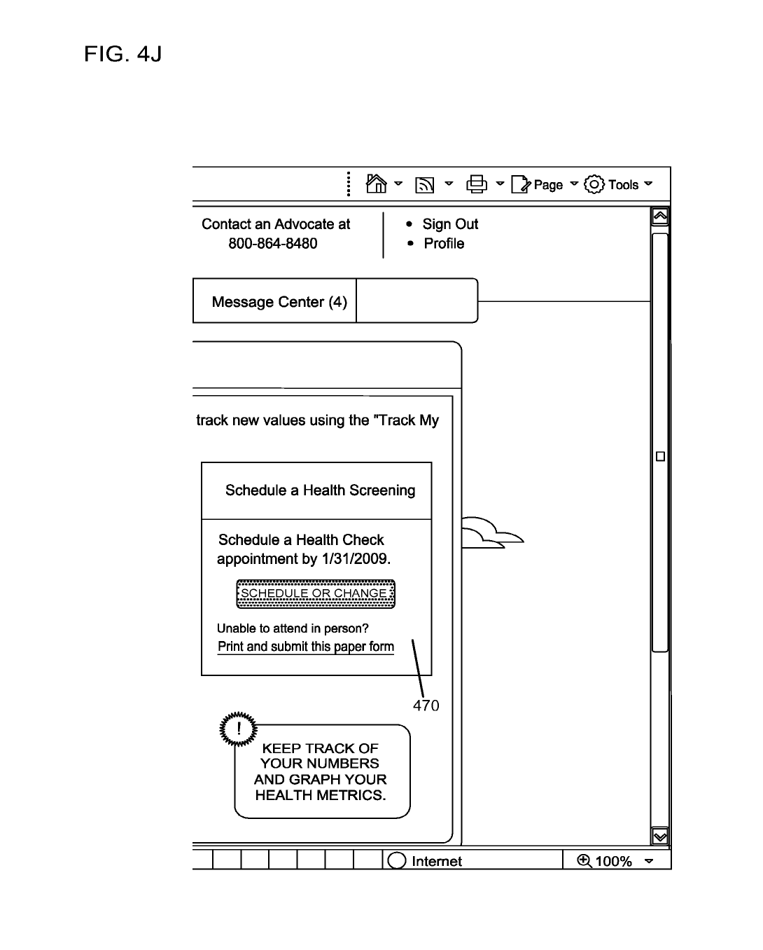

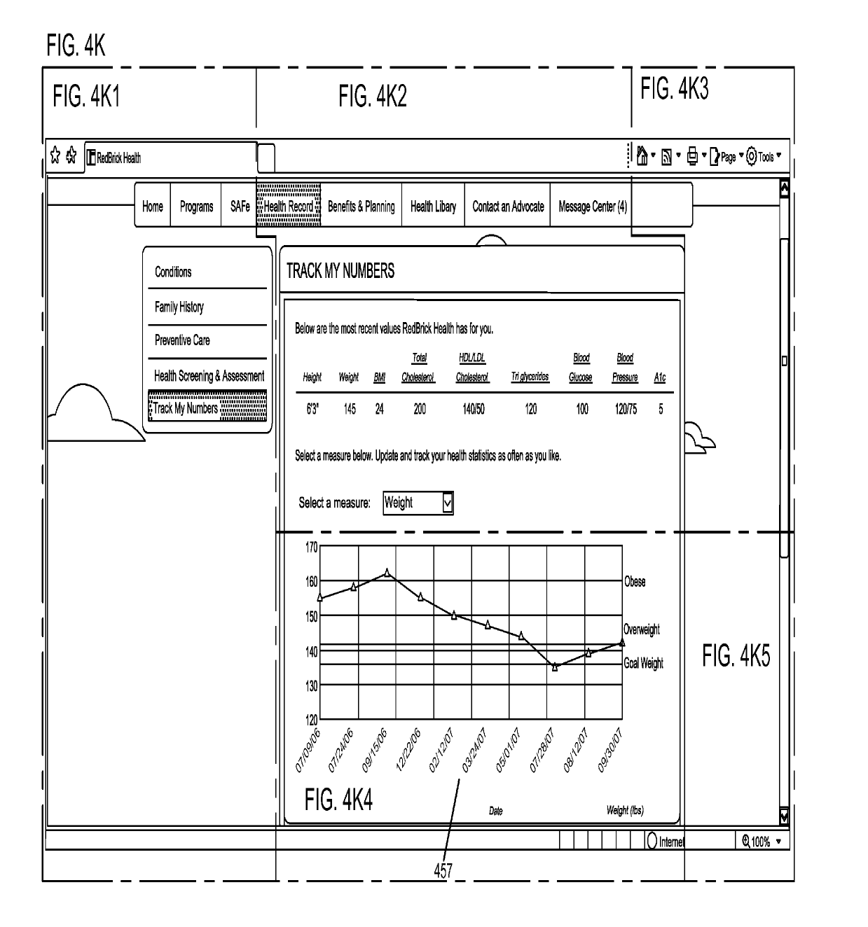

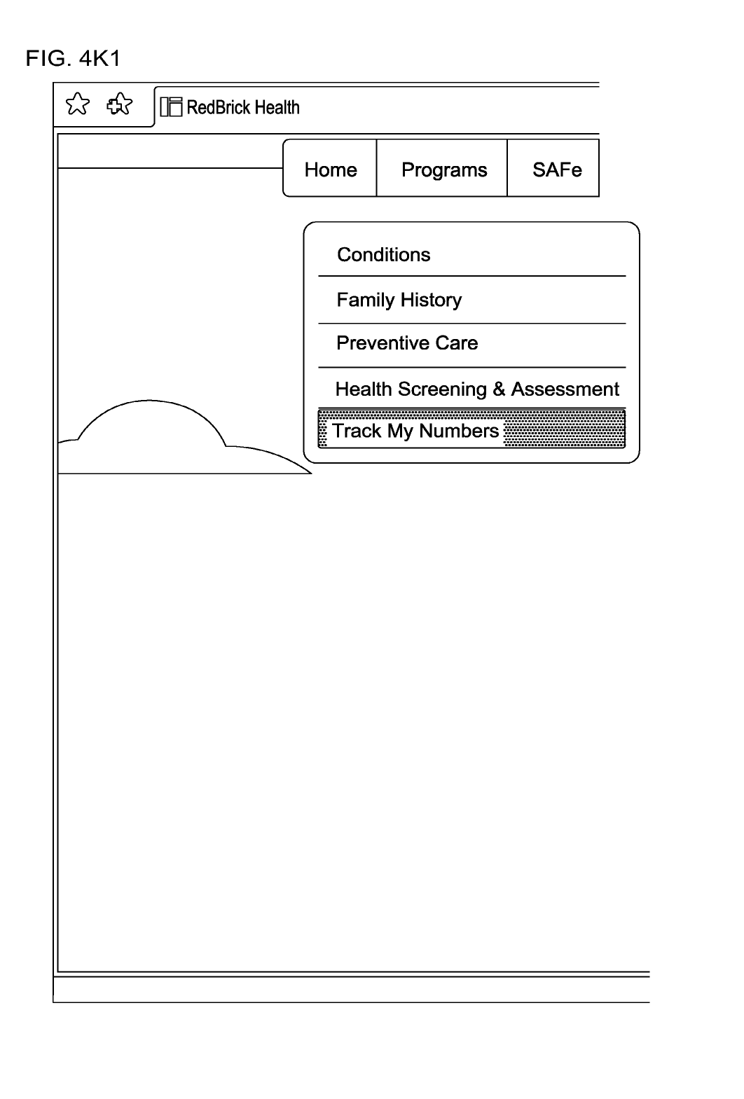

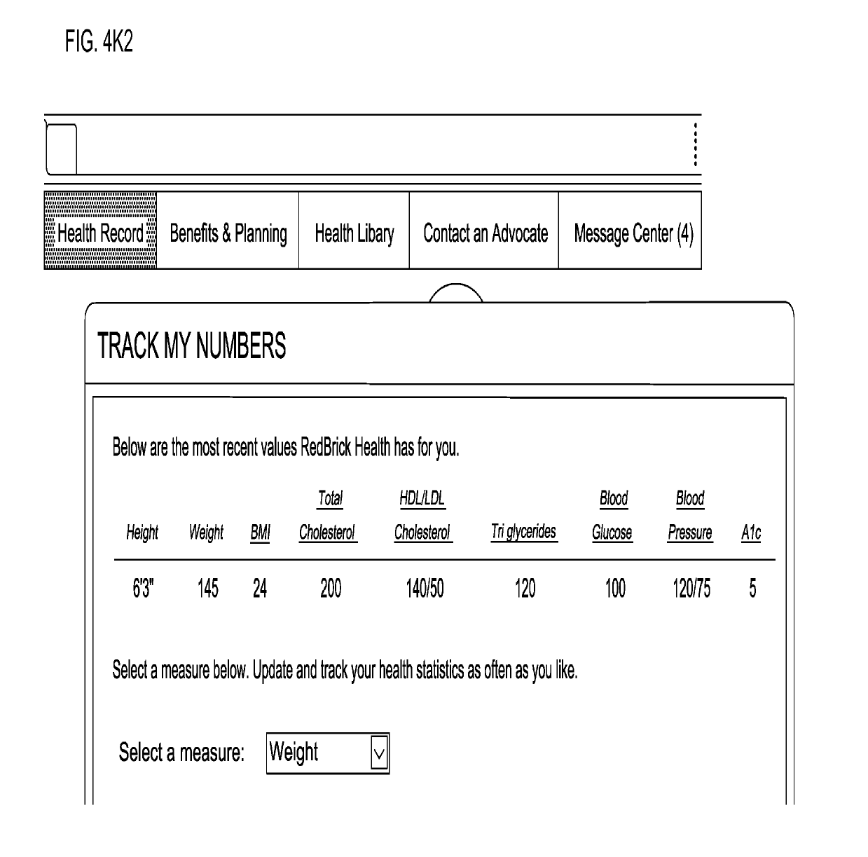

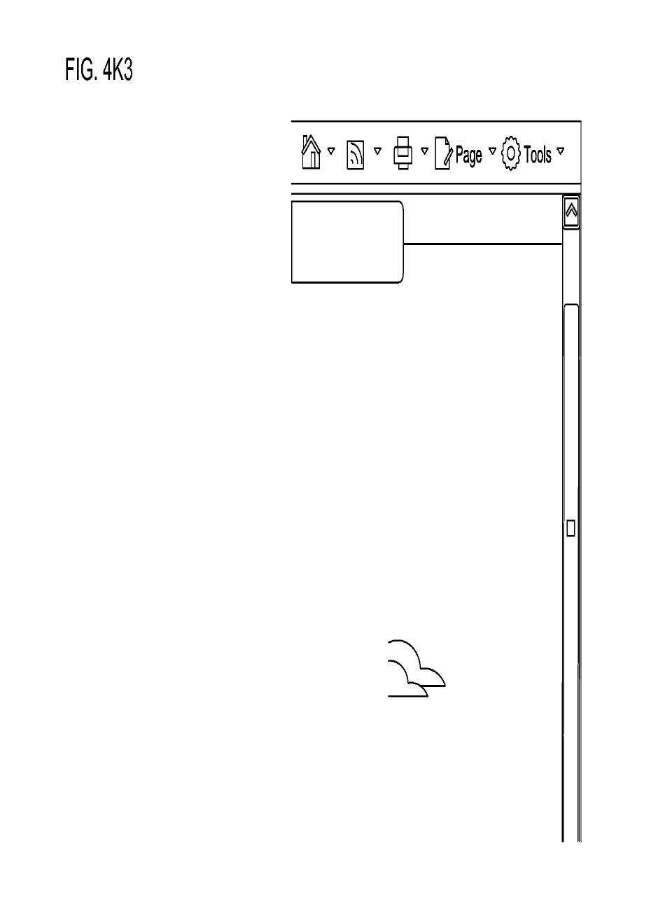

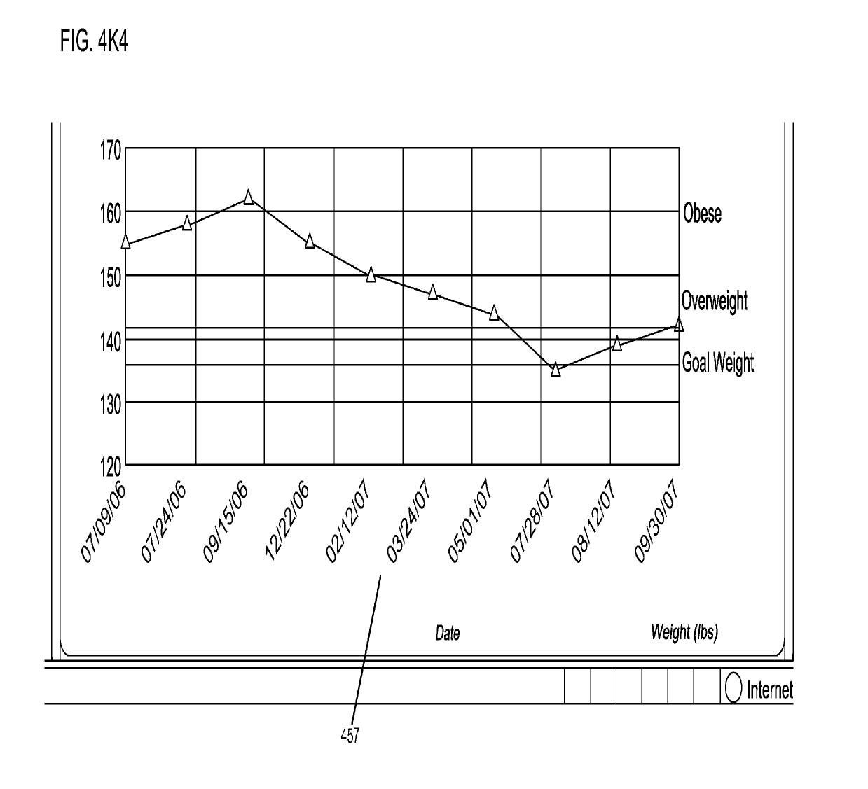

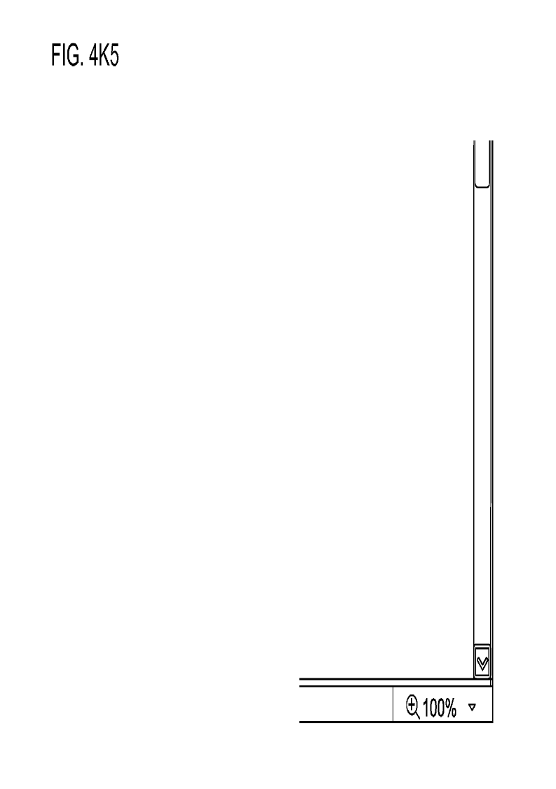

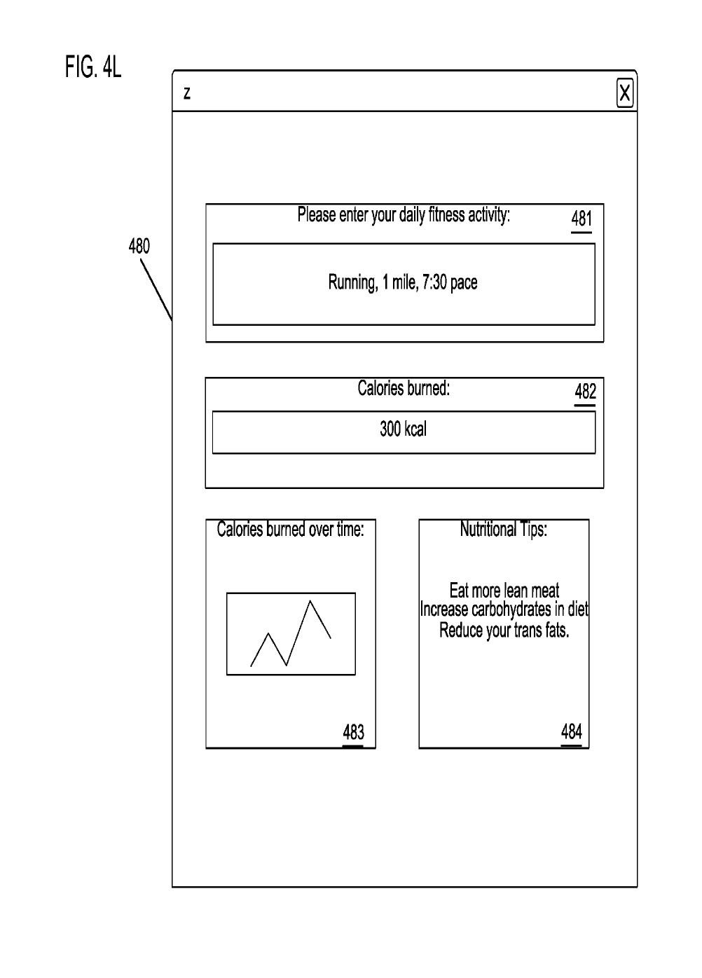

As shown in FIG. 4A, in one embodiment of the present disclosure, an individualized health management map 401 may be assembled and composed automatically by the system of the present disclosure and output to one or more output devices, e.g., 236, 256, such as a printer and/or computer monitor. The example embodiment of an individualized health management map shown in FIG. 4A may include, but is not limited to, sections for displaying information relating to a personal health score 403, listing incentive details 405, displaying information relating to the employee's personal health report 407, displaying information related to recommended care 409, and displaying information relating to health programs 411. The example sections are for illustrative purposes, and in other embodiments, an individualized health management map 401 may include more or fewer sections than those illustrated and may contain more or less or other health information than is shown.

A personal health score section 403 may include a personal health score, potential health score, and/or health rating, and may also include text explaining the ratings given. As was described above, a personal health score may be computed from all or a subset of answers to questions asked during administration of a HRA, a PAM, health and/or biometric screening, and/or claims data or other outside data. A potential health score may be computed by computing a personal health score with an assumption that some or all of an individual's health conditions and/or lifestyle behaviors have been lessened, minimized, cured or otherwise ameliorated, or by any other suitable computation method. A health rating may be computed from, for example but not limited to, a current personal health score, and/or the amount of difference between a current personal health score and a health potential score.

A section for listing incentive details 405 may include, but is not limited to, incentives earned by an employee, incentives an employee is eligible for, and how much could be saved if incentives are applied to premium payments, for instance. Incentives, as is discussed more fully below, may be earned by completion of various tasks, such as, but not limited to, completing a HRA, attending a health coaching session, improving a health metric, etc. Completion of one incentivized task may make an employee eligible for other tasks. Incentives, as is discussed more fully below, may be monetary, and may be distributed as cash or as discounts to insurance premiums, 401(k) contributions, etc.

An individualized health management map 401 may also include a health report section 407, which may include results of health screening tests such as BMI, blood pressure, blood glucose, low-density lipoprotein (LDL), high-density lipoprotein (HDL), or other health screening tests. This section 407 may also contain a list of an employee's health conditions, as determined from a HRA, health and/or biometric screening, and/or claims data or other outside data.

A recommended care section 409 may list health conditions an individual may have, such as diabetes, obesity, and/or high blood pressure, for example, and recommended care, such as doctor appointments, health coaching, preventative care, reminders to take medicine, etc., for each condition. Conditions and recommended care may be ranked by an individual's readiness to change behavior, as described more fully above.

A health program section 411 may list programs available for an individual's use, the programs the individual has signed up for or is currently undertaking, and/or the programs the individual has completed.

In some embodiments, an employee may also be able to access an individualized health management map using a computer, such as but not limited to personal computer 226, connected with a network, e.g., network 250. In some embodiments, the contents of an individualized health management map may be displayed on several pages, which, when displayed on a computer, may be navigable via input devices such as but not limited to, a mouse or keyboard. In some embodiments, a personal health map may be interactive and dynamic, changing in real-time, or other suitable time period, in response to employee input.

The health management map may generally include providing an area integrating various components of health management into a single location for viewing or for use by an individual to monitor and manage their well-being and health conditions. In one embodiment, the health management map can be a generally seamless area combining information and services from any number of health-related service providers or other third-parties. In some embodiments, because the health management map may be generally seamlessly integrated, employers and employees may be unaware that this information and these services are provided by more than a single entity. That is, to the employers and employees, the information and services provided by third-parties or otherwise may all appear integrated as if coming from a single source. Additionally, any of the information or data, or portion thereof, relating to the health management map may be stored in a location accessible by each health-related service provider or other third-party, and each health-related service provider or other third-party may be allowed to access any information it may need from the stored location to suitably provide its information or service(s). Additionally, in one embodiment, this data may be maintained and updated in any suitable interval of time, such as but not-limited to, generally “real-time,” batched daily, etc. As stated above, a suitable data store or data storage device may include, but is not limited to, a hard disk drive, floppy disk drive, CD-ROM drive, smart drive, flash drive or other types of non-volatile data storage, a plurality of storage devices, or any combination of storage devices.

FIGS. 4B-4L show an example embodiment of the present disclosure of an individualized health management map 420, displayed in a desktop computing environment, which may be accessed through the Internet or other network. Referring to FIG. 4B, information in an individualized health management map may be subdivided into several categories, accessible, in this example, by navigating through separate tabs. However, as is known, other organizational methods, such as links, for health information contained in an individualized health management map are possible. Category sections of an on-line individualized health management map may include, but are not limited to, a health programs section 422, which may provide a list of health programs, such as health coaching programs or exercise programs an employee is enrolled in; an incentives section 423, which may show incentives available to an employee; a health records section 424, which may include but is not limited to a personal health score, and results from health and/or biometric screening; a health library section 425, which may contain links to educational materials, such as online health content such as WebMD, the Health Illustrated Encyclopedia and other similar websites and medical research materials relating to symptoms and treatment for specific conditions an employee may have; and sections 426 providing contact information for health plan specialists, for example, and messages to the employee from entities such as a health plan administrator, employer and the like. Again, the example category sections are for illustrative purposes, and in other embodiments, an individualized health management map 420 may include more or fewer sections than those illustrated and may contain more or less or other health information than is shown.

FIG. 4B illustrates the home section 421, which may contain a snapshot or summary of information found in other sections, such as but not limited to, incentives completed and incentives available 427, health programs in which an employee is enrolled 428, or any other suitable information. Information displayed on the home section 421 may be customizable by the employee or employer.

FIG. 4C displays information that may be available in embodiments of an individualized health management map in the health programs section 422. For example, FIG. 4C depicts a listing, tailored to the individual, of recommended disease management or prevention programs or courses, such as an exercise program 431, a diabetes management program 432, a smoking reduction program 433, and heart disease management program 434. Programs or course may be offered online 435 or by any other suitable means of communication, such as by phone 436, and employees may select one or more (when available) of the offered communication means. Other programs or courses or program delivery methods, such as in-person coaching may be available. Other information that may be displayed in the health programs section 422 may include programs an employee is currently enrolled in 437, as well as programs or courses the employee may have completed 438.

FIGS. 4D-4F display information that may be available in embodiments of an individualized health management map in the incentives section 423. In one embodiment, an incentives section 423 may allow the viewing of, for example but not limited to, an account summary 440, which may show the number and monetary amount of incentives that an employee has qualified for in the past, as shown in FIG. 4D; incentives an employee may be eligible for or able to receive in the future 441 upon completion of health-related tasks, as shown in FIG. 4E; and monthly (or any other suitable timeframe) health premiums 442, which may be broken down into contributions paid by the employer and the contribution paid by the employee, as shown in FIG. 4F. Showing health care premiums broken down into employer and employee contributions as shown in FIG. 4F may allow employees to see the true cost of their healthcare and may motivate employees to attempt to reduce healthcare costs. Other options, such as a help or information option 443 may also be available in some embodiments.

FIGS. 4G-4K display information that may be available in a health records section 424 in some embodiments of the present invention. Referring to FIG. 4G, health records section 424 may allow for the display of, for example but not limited to, an employee's health conditions 450, family history 452, preventative care 454, health screening and assessment information and/or results 456, and health metric tracking 457. In FIG. 4G, information about an employee's health conditions is shown. Such information may include current conditions 458 as well as resolved conditions 460. Employee health information may be interactive in some embodiments, allowing the employee to edit, update, modify, etc. the health information. For example, current condition information may be edited or changed 462 by an employee. Further, new conditions can be added by an employee 464. The individualized health management map 420 may dynamically adjust to reflect this new information. FIG. 4H depicts a screen showing a family history of medical conditions 452. In some embodiments, an employee's family history for individual conditions may be edited or removed 466 and new conditions may be added 468. FIG. 4I depicts a screen showing and recommending preventative care 454 actions an employee may take to maintain health and diagnose conditions earlier when they may be easier to treat. In some embodiments, employees may input when they have completed a preventative care task 469. FIG. 4J depicts a screen showing health screening and assessment information 456. The screen 456 may show health and/or biometric information such as height, weight, blood pressure, etc., as well as a personal health score, which may be computed by methods that were disclosed fully above. An employee may be given an option of scheduling a health screening 470 at yearly or other suitable intervals. FIG. 4K depicts a health metric tracking screen 457, which may allow for tracking health metric and biometric data, such as weight, blood pressure, cholesterol levels, etc. over time.

In general, an individualized health management map may contain one or more of the following categories of information for an employee: instructions, teaching employees how to use the individualized health management map through overviews and tutorials; actions to take, providing a list of recommended health activities and steps that highlight specific behaviors and reward opportunities, as will be discussed later; education, providing information, articles, quizzes and tools specific to the health needs of each employee; personally relevant information based on each employee's current health situation, including recommended preventative care, and reminders on family history; health programs, outlining eligible programs and individual levels of engagement, including goal setting and tracking; and health records, storing and tracking health statistics, and personal health information, including, in some embodiments, a personal health score. An individualized health management map may also display a summary of information gathered from a HRA, health and/or biometric screening or other sources, such as claims data for example. Further, an individualized health management map may provide several available options, such as exercise plans, health coaching, scheduling preventative check-ups, etc. for an individual to begin a path to better health. An individualized health management map, and the activities and programs identified or provided therein, may provide suggested tasks to ameliorate or manage a variety of modifiable conditions and lifestyle issues that contribute to increased costs and/or reduced productivity.

As shown in FIG. 4C, individualized health management maps may facilitate or incorporate various health coaching programs. For example, individuals with more significant health conditions or lifestyle issues may be directed or encouraged to enroll in one or more health coaching programs. Health coaching may include, but is not limited to, online training 435, telephone conferences 436, or other interactions with a health coach for one or more of an employee's conditions. An individualized health management map may provide meeting reminders, self-directed and other educational materials designed to facilitate and supplement health coaching. Health coaching may involve self-directed programs 435, which may be accessed through an online individualized health management map. Self-directed health programs may also include a nutritional guide, which may suggest simple, convenient meal ideas, recipes and tips to help employees eat healthier. In further embodiments, self-directed health programs may also include organizing and tracking online team building, i.e., organizing a plurality of employees interested in achieving similar health goals, and organizing and tracking workplace health competitions, in which incentive rewards are given to an individual employee or team who achieves a certain health goal, such as, for example, losing the most total weight, etc.

Coaching and health programs may further involve, but are not limited to, live health and wellness ‘webinars’; coach-customer ‘personality’ matching using employee profiles and other data; incorporation of remote health monitoring technology, such as but not limited to, step counters or pedometers, blood pressure monitors, etc.; and alternative medicine programs, such as but not limited to, acupuncture, and herbal medicines. In one embodiment, one or more third-parties, such as but not limited to, Nurtur Health, Inc., which is headquartered in Farmington, Conn. or HealthMedia, Inc., which is based in Ann Arbor, Mich., may provide health coaching or self-directed programs.

In some embodiments of the present disclosure, a self-directed health program may include a personal fitness activity tracker 480, in which employees are encouraged to incorporate physical activity into their daily life and maintain a lifelong habit of daily activity, as shown in FIG. 4L. One goal of a personal fitness activity tracker 480 may be to encourage an individual to achieve at least 30 minutes, or other suitable amount, of daily physical activity. Employees may enter their daily activity data online 481, and the personal fitness activity tracker 480 may automatically calculate or estimate the number of calories burned 482 as a result of exercise, for example. Daily activity may also be recorded by an employee through other means, such as in a paper journal, and input by the employee or a third party into a personal fitness activity tracker at a later date. The personal fitness activity tracker 480 may be integrated with other components of an individualized health management map. Further, in some embodiments, a personal fitness activity tracker may provide nutritional advice 484, including meal plans, as well as continual program progress 483, tips, and other motivational support.

Further, individualized health management maps may provide a list of questions or discussion points tailored to an individual's age, medical condition, or pre-disease risk factors, for example, which may be used to guide discussion when talking to a doctor or other healthcare provider during an examination, improving health awareness and potentially providing better diagnoses. Questions or discussion points may be selected for a particular individual based on data from their HRA, health and/or biometric screening, and/or outside data.

In some embodiments, an individual's health management map may allow the individual to input new conditions, update improving or worsening conditions, and resolve conditions (when a condition has improved such as such that it is no longer a condition). Other information may be input by an individual directly into an individualized health management map, such as updated biometric information such as weight loss or gain, etc.; updated health screening information, such as cholesterol levels, etc.; and daily activity information, such as steps walked or run, exercises performed, etc.

According to one embodiment, an individualized health management map for each individual can be dynamic and evolving. That is, an individualized health management map may change correspondingly with the changing or evolving health of an individual to prioritize or reprioritize an individual's health risk factors, such that risk factors having higher probability of harmfully affecting the health of the individual are addressed first. For example, as certain risk factors are addressed by an individual and become less likely to harm him or her, other risk factors may be dynamically pushed to the forefront. For example, an individual with increased risk of heart disease may be originally eligible for and participate in a program that controls diet. After an individual has participated in a program and achieved significant results, such as weight loss, that places the individual at a lower risk for heart disease, their individualized health management map may evolve to focus on more pressing health issues for the individual, such as diabetes. As such, the individualized health management map may evolve to provide information and programs relating to other health issues and focus less on information and programs for heart disease. Individualized health management maps may also be updated at the employee population level, in which periodic re-identification, stratification, and prioritization of individuals most likely to benefit from the provided coaching services, health programs, activities, education, etc., can be used to dynamically update an employee's individualized health management map. Changes made to an individualized health management map may also be reflected in an updated personal health score.

The various embodiments of healthcare services described herein may include web services/products, customer service, coaching, health assessment, health content and health screening, and incentives. Healthcare services can generally be directed to achieving one or more of at least three goals: 1) understanding an individual's health status, 2) taking action to maintain and improve the health of an individual, and 3) tracking the progress of an individual and providing incentives for an individual to engage in their health and wellness. Ultimately, one goal is to engage consumers in being healthy and to get individuals to make healthy choices and encourage healthy behaviors, thus reducing healthcare costs.

Referring back to FIG. 1, step 107, in embodiments of the present disclosure, health incentives can be used as additional enticements to help individuals initiate, change, and maintain specific health-related behaviors. Health incentives can be used to accomplish many different goals in the context of helping individuals be healthy, for example but not limited to: promoting learning; encouraging participation in programs and activities; encouraging initiation, improvement, and maintenance of specific health behaviors; encouraging improvements in healthcare service use behavior; encouraging compliance with treatment advice; encouraging accomplishment of personal health enhancement goals; and promoting equitable healthcare financing.

For example, incentives may be used as an inducement for employees to participate in a HRA and/or health or biometric screening. Further incentives may be used to help induce employees to monitor and follow their personal health plan and/or engage in health management services. Health incentives optimized for a particular employee and employer situation may help to achieve a higher level of success in individual health as well as slow the rate of healthcare cost increases to employers. Incentives provided can be tailored to both an individual employer and employee, and may include, but are not limited to, an offset in an individual's contribution to his/her health plan, deposits into an HRA, 401(k), cash, points, paid time-off hours, and other special privileges available to all qualifying individuals, etc.

Incentives can present both advantages and disadvantages. An advantage of the method of present disclosure is that it may help to significantly enhance the advantages and downplay the disadvantages of incentives in incentive fulfillment programs. Advantages of well-designed incentive fulfillment programs may include, but are not limited to, powerful behavior effects, flexibility and adaptability, ease of set-up and operation, the possibility of combining rewards, and equitable healthcare financing. Disadvantages to be minimized can include, for example, that it may not be easy to know the “best” rewards for a particular situation; the incentives may reward the wrong behavior or may produce unintended results; the possibility to outsmart or game the incentive program; and the possibility to create entitlement or dependency. Incentives may be either rewards or penalties, although, in most embodiments, typically only will be formally defined. Penalties may range from “neutral”, i.e., simply not earning incentives if an employee does not participate in a health management program or a task is not completed, to “negative,” where an employee not participating or completing a task can be assessed a penalty, such as increased premiums. Penalties may be phased in, for instance, to encourage employee participation if initial participation is low, or may be present from the onset of the incentives-based health management program being adopted by an employer.

Incentive-earning behaviors can be entered into an incentive program system on-line by an employee or others. Employee entries can be periodically audited, automatically approved, or approved after review and/or validation. Employers can determine time limits or expiration dates of incentives for achieving a particular health result. Incentives can be distributed to employees yearly, quarterly, on a task-complete basis, upon request for distribution, or at any other suitable timeframe.

According to one embodiment, the goals of tracking the progress of the individual and helping induce the individual to engage in their health and wellness and embrace effective change in their behavior and ownership of their health can be accomplished by, among other things, developing and providing a configurable and evolvable incentive fulfillment program. The development of a customized and effective healthcare-based incentive program may include, but is not limited to, determining actions or behaviors desired to be increased or decreased with incentives; determining values that would hinder the adoption of the desired actions or behaviors; researching and selecting formal and informal rewards that are feasible for inclusion in an incentive design while producing the largest behavioral change effect; ensuring a program is equitable across an entire employee population; determining whether proposed or draft incentive rules have unintended effects; testing an incentive program using a pilot group of employees picked at random to test the design and approach; developing and refining a communications plan for an incentive program; implementing an incentive program; and evaluating the effects of an incentive plan and revising it on a periodic basis.

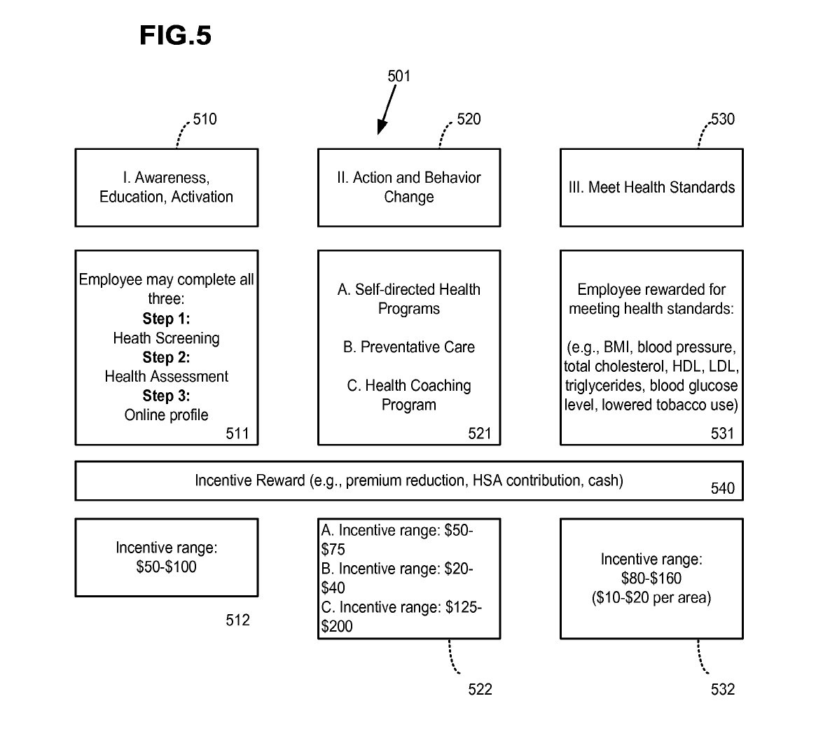

FIG. 5 illustrates a diagram of an example embodiment of the present disclosure of an incentive structure 501 designed to promote the adoption of healthy behaviors. Incentives, in some embodiments, can be separated into a plurality of incentive groups. Examples of incentive groups may include, but are not limited to, a group providing incentives for awareness and education 510, a group providing incentives for action and behavior change 520, and a group providing incentives for achievement of specific health standards 530. Embodiments of the present disclosure may have fewer or differently organized incentive groups, or use incentives without a grouping structure. In some embodiments, incentives may also be tied to activities or tasks that are disease- and/or condition-specific, so that there is a plurality of incentives for each of several diseases and/or conditions. Thus, for example, an employee may receive incentives for quitting smoking, while at the same time receive an incentive for learning about ways to cure or manage his or her heart condition.

A variety of activities can be rewarded with incentives in an employer program. Typically, incentives will be designed to promote enrollment in a program, an employee's knowledge of his or her health conditions, knowledge of behaviors designed to ameliorate that condition, and promote the management or cure of the employee's health conditions to reduce healthcare costs for an employee and employer. For example, in the example embodiment shown in FIG. 5, within the incentive group for awareness and education 510, incentives may be provided to an individual for completing one or more or all three of a health screening, health assessment, and online profile 511. An incentive reward 540 may be cash, a health savings account contribution, premium reduction, or other reward, as described above. An incentive reward given in FIG. 5 for completing all three education tasks 511, for example, may be within the range of $50-$100 dollars, as shown in box 512, but other amounts may be used. The incentive group 510 and incentive tasks within group 510 shown in FIG. 5 are for illustrative purposes only, and there may be more than

one way to provide incentives for completing a HRA, health screening and online profile. Further, incentives may given for completing any of the three tasks shown, or any other awareness or education activities or tasks or combination of activities or tasks that may be present in an embodiment of the present disclosure. Further yet, the incentives provided may not be monetary, but may be gifts, merchandise, time off or other rewards. The monetary amounts shown here are illustrative in nature and may be any suitable amount that is appropriate for an employer's budget and desired employee participation, and may be adjusted for inflation and other factors.

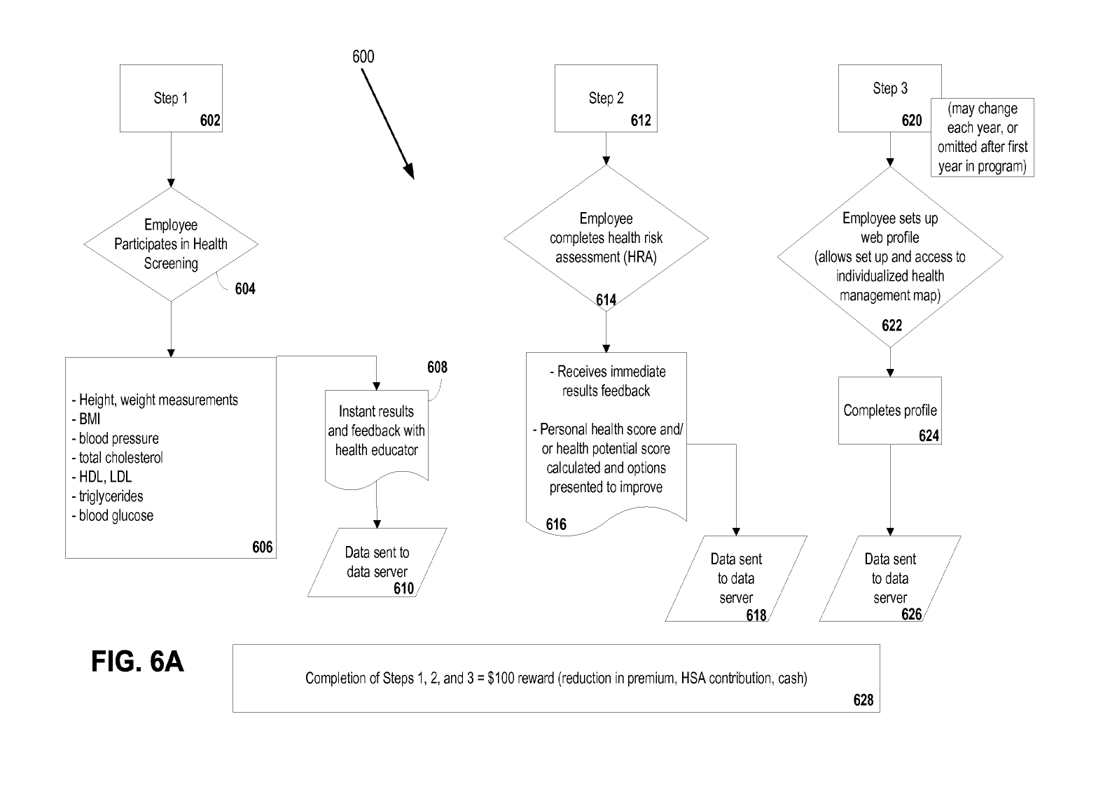

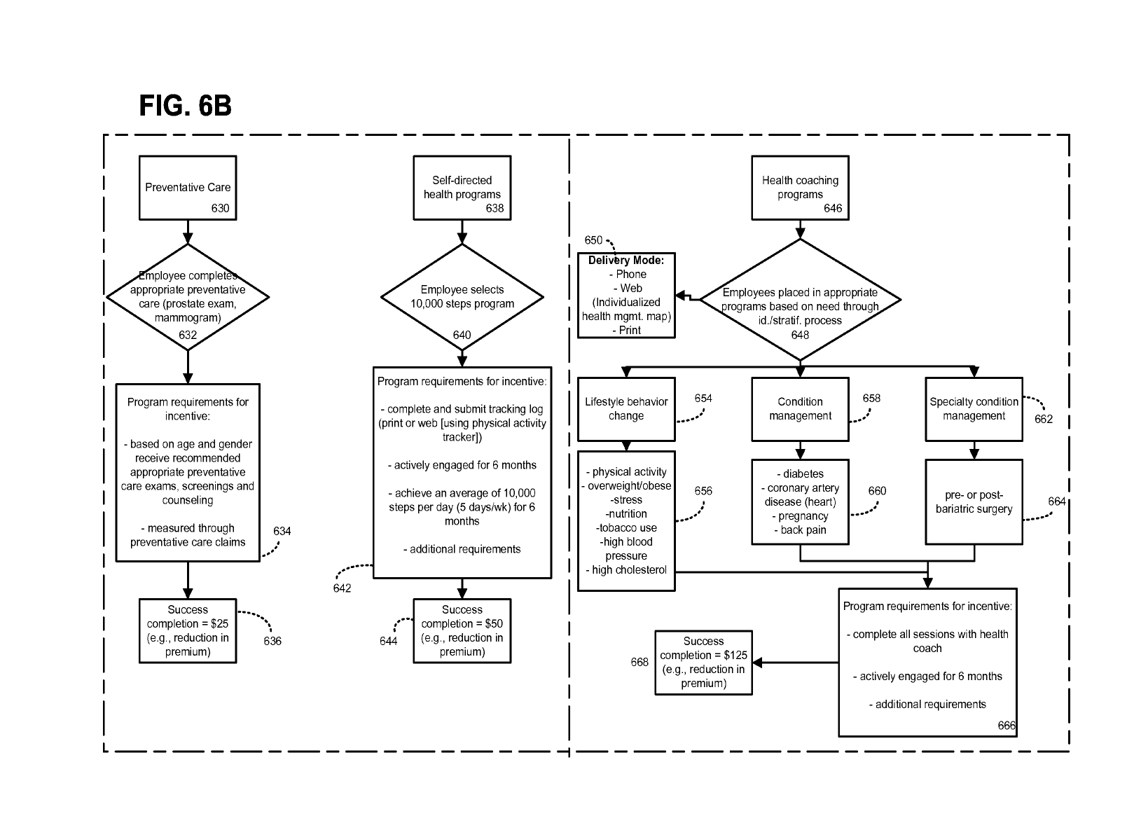

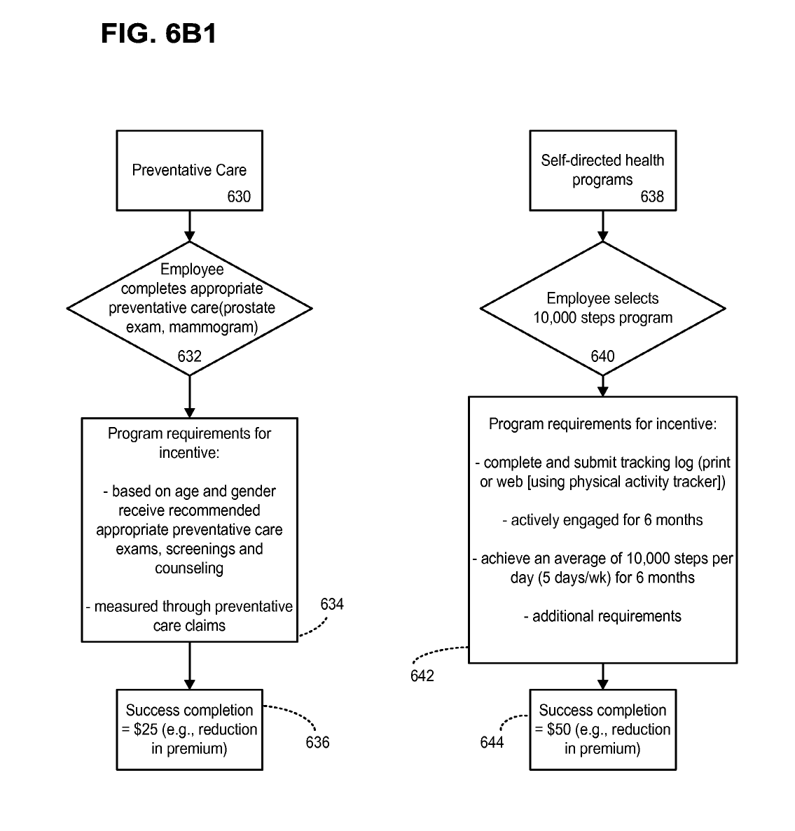

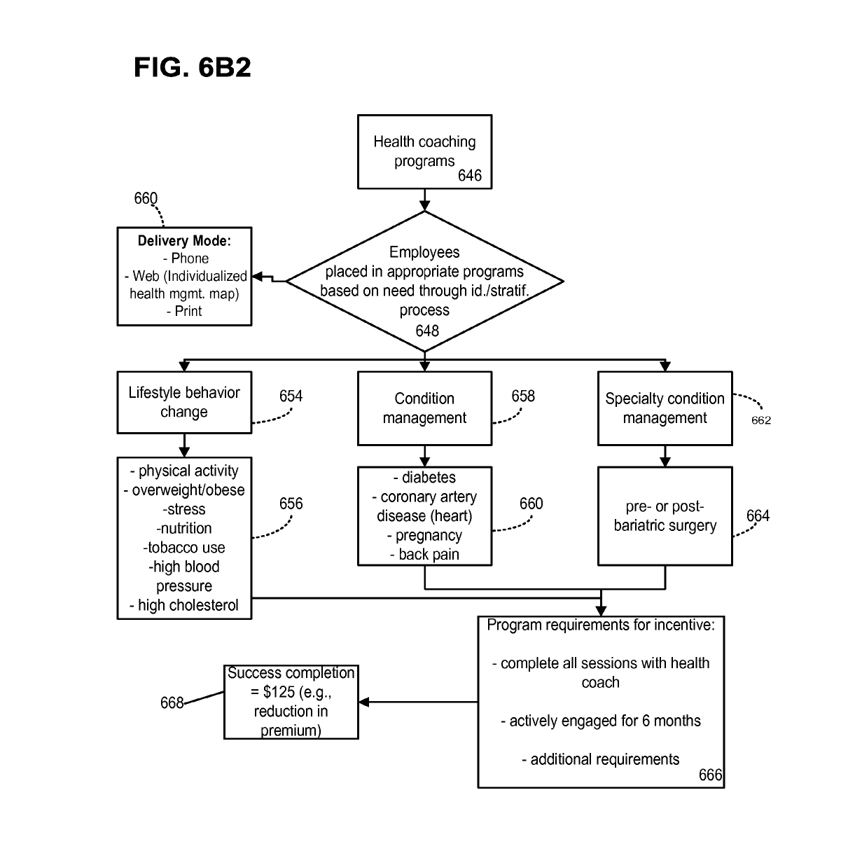

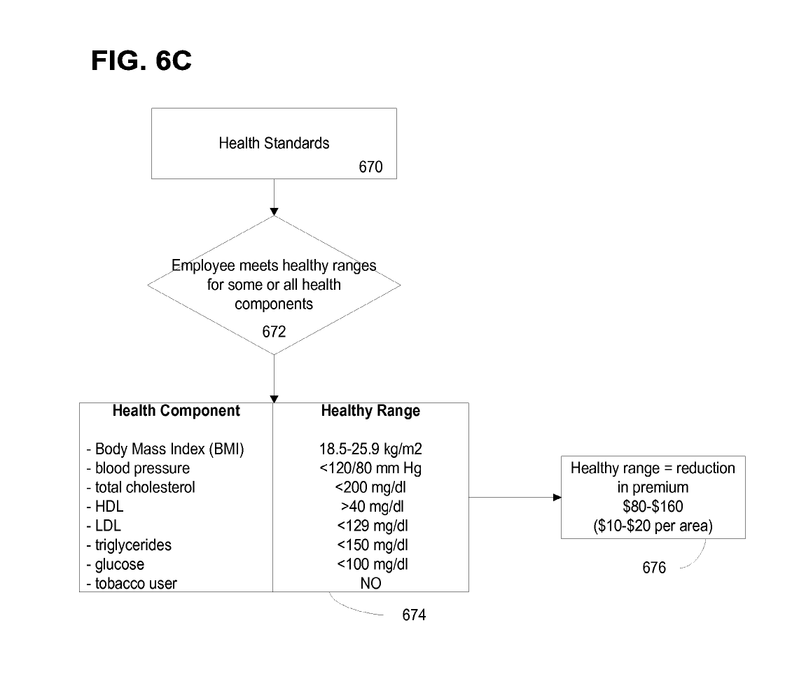

FIG. 6A shows an example embodiment of the present disclosure of a method of gathering and processing data from awareness, education, and activation activities completed by an employee 600. Particularly, FIG. 6A illustrates an example method of gathering and processing data from awareness, education, and activation activities completed by an employee who has participated in health screening, completed a HRA, and/or set up a web profile. It is recognized that data from other types of awareness, education, and activation activities may be gathered and processed, and the examples in FIG. 6A are for illustrative purposes.

In step one 602, an employee may participate in a health screening program 604. Data collected 606 may include, but is not limited to, height, weight measurements; BMI; blood pressure; total cholesterol; HDL, LDL; triglycerides; and blood glucose, etc. After collection of health screening data, (usually at the same time or appointment as collecting health screening data) results may be shared with the employee and discussed with a health educator 608. Data collected may also be sent 610 to a data server, where it can be collected and stored, for example, in mass storage device 260. In step two 612, an employee may complete a HRA 614. After or completion of the HRA, an employee may immediately receive results and feedback, including the calculation of a personal health score, a health potential score, and options presented to improve a personal health score 616, as described above. Data from the HRA and/or personal health score and potential health score may be sent 618 to a server, where it can be collected and stored, for example, in mass storage device 260. In step three 620, an employee may set up a web profile, providing personal information, passwords, etc. to allow set up and access to an individualized health management map for the employee 622. Once the employee completes the web profile 624, data may be sent 626 to the data server, where it can be collected and stored, for example, in mass storage device 260. An incentive reward may be given 628 (such as but not limited to, a reduction in healthcare premiums, HSA contribution, etc.) upon completion of all three steps 602, 612, 620. In the embodiment illustrated, an employee should complete all three steps 602, 612, 620 to receive an incentive, however, in some embodiments separate incentives may be granted upon completion of each step, and the steps may be completed in a different order than shown here.

Returning to FIG. 5, within an incentive group for action and behavior change 520, incentives may be provided to an individual for completing one or more health-related tasks 521. For example, as shown in FIG. 5, incentives may be given for completion of a self-directed health programs, preventative care, and/or a personal health coaching programs 521. Incentives may be tailored to each task 522. As shown in box 522, incentive rewards may be, for example, in the range of $50-$75 for completion/participation in a self-directed health program; $20-$40 for participation in a preventative care program; and $125-$200 for participation/completion in a health coaching program. An incentive reward 540 may be cash, a health savings account contribution, premium reduction, or other reward, as described previously. Further, incentives may given for completing any of the tasks shown, or any other action or behavior change activities or tasks or combination of activities or tasks that may be present in an embodiment of the present disclosure. The monetary amounts shown here are illustrative in nature and may be any suitable amount that is appropriate for an employer's budget and desired employee participation, and may be adjusted for inflation and other factors.

Self-directed health programs, preventative care, and/or a personal health coaching programs listed in 521 may involve, for example but not limited to, disease, health conditions or lifestyle management programs. Examples of disease management programs may be, but are not limited to, coronary artery disease management, diabetes management, etc. Examples of health conditions management programs may be, but are not limited to, cholesterol, high blood pressure, general or overall health, prenatal care, diabetes management, heart disease management, and weight loss programs, which may include surgery options. Example of lifestyle management programs may be, but are not limited to, walking programs, healthy nutrition and diet programs, diet- and exercise-based weight loss programs, smoking cessation programs, and stress management programs, etc. Completion of, or steady participation in, one or more disease, health, and/or lifestyle management programs may make an employee eligible for incentive rewards.

FIG. 6B is a diagram of an example embodiment of the present disclosure of a method of processing action and behavior change incentives for an employee. Incentives for preventative care 630 may be given upon completion of appropriate preventative care, such as but not limited to, a prostate exam or mammogram 632. However, incentives may be given before, or during the course of, a preventative care program or treatment. Preventative care programs may need to meet certain requirements for an employee to receive an incentive; for instance, the preventative care program could be age and gender appropriate and could require that the exams, screenings, or counseling, etc. are appropriate for the employee's identified condition or conditions 634. As noted above, an appropriate incentive for completion 636 of an appropriate preventative care program may be cash, such as $25, premium reductions, etc.

As described above, incentives may also be given for completing self-directed health programs 638. For example, an employee may select a walking program 640 to boost activity levels and lose weight. However, other self-directed health programs may be available for selection by an employee. The employee may be required to complete and submit a tracking log or other tracking mechanism, such as entering information using a physical activity tracker, as shown in FIG. 4L; be actively engaged for 6 months, or other suitable time period, in the program; achieve a specified average number of steps per day (e.g., for 5 days/wk); and/or any additional, alternative, or other requirements 642. As was discussed fully above, an appropriate incentive for completion 644 of a self-directed program may be cash, such as $50, premium reductions, etc.

Incentives may also be given for completing health coaching programs 646. Employees may be placed into appropriate health coaching programs through a condition identification/stratification process as shown in, for example, FIG. 3. Depending on employee preference, and/or employer budget, various delivery methods 650 may be used to deliver health coaching programs, such as but not limited to, over the telephone; via the web (such as through an individualized health management map) via sound, video and/or text-based coaching services; or in print, etc. Types of health coaching may include, but are not limited to, lifestyle behavior change coaching 654, condition management coaching 658, and specialty condition management coaching 662. Lifestyle behavior change coaching 654 may involve, but is not limited to, helping to increase physical activity, managing or reducing obesity, coping with stress, improving nutrition, lowering tobacco use, lowering high blood pressure or cholesterol level, etc. 656. Condition management coaching 658 may involve, but is not limited to, managing diabetes, coronary artery disease, pregnancy, or chronic back pain, etc. 660. Specialty condition management coaching 662 may involve, but is not limited to, helping to cope with surgeries, such as bariatric surgery, or other specialized coaching 664. Receiving an incentive for health coaching program may involve, but is not limited to, completing all sessions with a health coach, being actively engaged with the coaching for 6 months, or other suitable time period, and/or additional, alternative, or other requirements 666. As was discussed above, an appropriate incentive for completion 668 of a health coaching program may be, but is not limited to, cash, such as $125, premium reductions, etc.

Returning to FIG. 5, within an incentive group for meeting health standards 530, incentives may be provided to an individual for meeting one or more health metric standards 531. Health standards may be individually tailored for each employee or based on the health metric and/or statistics of one or more group populations and be based on goal ranges or values for various health metrics, such as, for example, BMI, blood pressure, total cholesterol, HDL, LDL, triglycerides, blood glucose level, lowered tobacco use, etc. Incentives may be given to meet each health standard for an employee's particular condition or on conditions of one or more group populations. For example, as shown in FIG. 5, total incentives for meeting health standards for any employee may be in the range of $80-$120, and may be broken down into $10-$20 increments for meeting various individual health standards for an employee's various health conditions. An incentive reward 540 may be cash, a health savings account contribution, premium reduction, or other reward, as described above. Further, incentives may be earned for completing any of the tasks shown, or meeting any health standard or combination of standards that may be present in an embodiment of the present disclosure. The monetary amounts shown here are illustrative in nature and be any suitable amount that is appropriate for an employer's budget and desired employee participation, and may be adjusted for inflation and other factors.

FIG. 6C is a diagram of an example embodiment of the present disclosure of a method of processing incentives for achieving health standards goals. Meeting and achieving health standards 670 may involve meeting healthy ranges for some or all of a plurality of, or subgroup of a plurality of, health components 672. Health components may include, but are not limited to, metrics such as BMI, blood pressure, total cholesterol, HDL, LDL, triglycerides, blood glucose, and tobacco use, and each metric may have a range that is considered normal or healthy 674. As was discussed more fully above, if metrics are maintained within a healthy range, incentives, such as monetary rewards or a reduction in premium may be provided to the employee. In one embodiment, for example, incentives totaling between $80-$160, with incentives for meeting individual metrics of between $10-$20 may be provided. However, other suitable values or rewards may be provided.

An incentive program may also involve incentives received through team efforts or team goal setting, in which incentives are given based on the performance of a plurality of team members toward a goal, such as weight loss or increased exercise. In some embodiments of the system of the present disclosure recordkeeping and assignment of incentives or rewards to teams or individual team members based on, for example, a team “winning,” doing well in, or participating in a challenge may each be done automatically by the system, based on computation of overall or average team health metric inputs, such as weight loss or exercise amounts, determined from individual or team inputs of their results, for example, using the health management map and/or activity tracker, described in detail above. In some embodiments, incentives or rewards to teams or individual team members may also be based on individual team member results. In other embodiments, individuals may enter their health metrics or other results via other means of communication, such as written or via phone, which may be entered into the system at a later date for determining the recipients of incentives and rewards. In some embodiments, individuals or employees may create their own teams. In further embodiments, the systems of the present disclosure may help individuals or employees recruit and join teams. Alternatively, the systems of the present disclosure may create teams for participating individuals or employees, for example, randomly. The systems may also provide utilities for monitoring team ranking and progress and/or individual contributions to team ranking and progress.

Incentives may be awarded at any appropriate time. For example, incentives may be awarded immediately upon enrollment, during participation of, or at completion of a health-related task or program, such as a health screening, coaching program, or quitting smoking, etc. In other embodiments, the award of incentives may be delayed until a point in time after completion of a health-related task or program or phased-in upon reaching one or more milestones during participation of a health-related task or program, such as but not limited to, 1) at enrollment, 2) at the mid-point of participation in one or more health programs, and 3) at program completion. An example of a delayed incentive could be the application of a reduction in the employee's health premium for the next pay period or when changes to payroll parameters are otherwise typically performed (such as daily, weekly, or other suitable intervals) or at a time when bonus payments are normally awarded. However, award incentives may be delayed any suitable time for any suitable reason, such as employee or employer needs and/or preferences, types of incentives, etc.

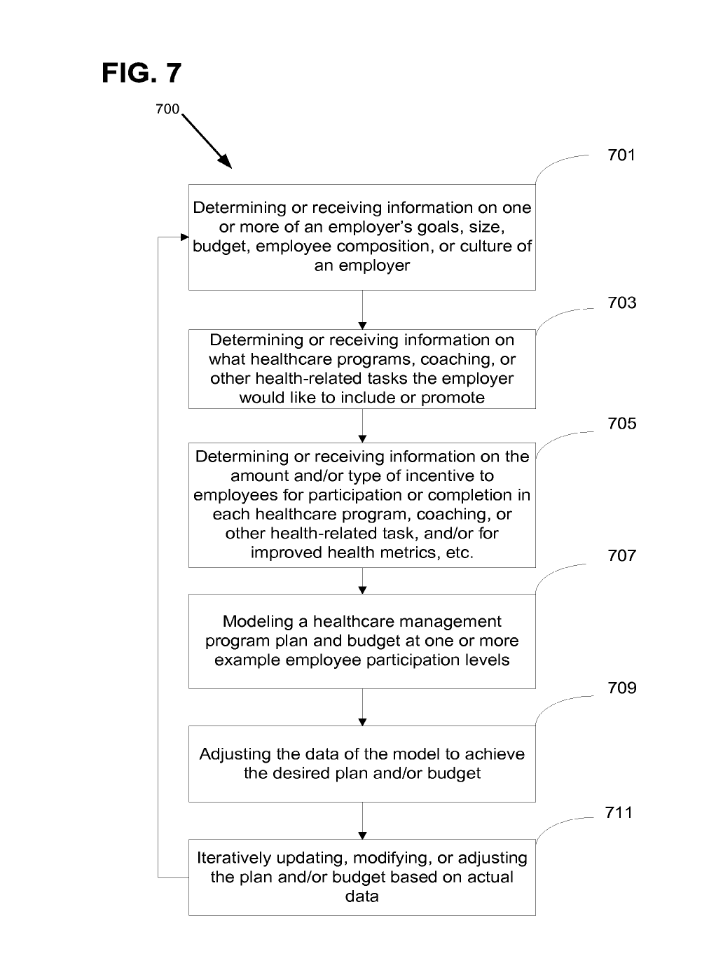

A method of developing a healthcare management program plan and/or budget 700 is illustrated in FIG. 7. The method may include determining or receiving information regarding one or more of an employer's goals, size, budget, employee composition, or culture of an employer 701 or other information, determining or receiving information regarding what healthcare programs, coaching, or other health-related tasks the employer would like to include or promote 703, determining or receiving information regarding the amount and/or type of incentive the employer would like to provide for participation or completion in each healthcare program, coaching, or other health-related task, and/or for improved health metrics, etc. 705, modeling a healthcare management program plan and budget at one or more example employee participation levels 707, adjusting the data of the model to achieve the desired plan and/or budget 709, and iteratively updating, modifying, or adjusting the plan and/or budget based on actual data 711 or other data. While illustrated as having steps 701, 703, 705, 707, 709, and 711, it is recognized that not every step is required and that additional steps may be included. Similarly, steps 701, 703, 705, 707, 709, and 711 do not need to be performed in the order shown, and some steps may be performed prior to, or later than, illustrated in FIG. 7. One or more steps of the method of developing a healthcare management program plan and/or budget 700 may be performed using a computing system environment, such as system environment 225, and particularly may be performed using a server 246 or other suitable computer or computing device.

Referring to step 701, a healthcare management program plan and/or budget may be tailored individually to each employer or other participating entity. For example, the healthcare management program plan and/or budget can be tailored to an employer based on, for example, the goals, size, budget, employee composition, and/or culture of the employer, or other relevant information that may be used to determine what may be important or desirable factors for building a healthcare management program plan and/or budget for that employer. For example, different employers may have different health goals that they would like to promote, such as but not limited to, a non-smoking workplace or a non-sedentary workforce, that may dictate which incentive groups, incentive activities, and/or incentive values are provided in that employer's healthcare management program plan and/or associated with a certain portion of the overall budget. Similarly, the size and budget of the employer can affect the overall healthcare management program plan. For example but not limited to, a small employer with a lower budget may provide resources toward less expensive health management tools, and lesser incentives, whereas a larger employer with a larger budget may provide more expensive programs and incentives. However, it is recognized that with respect to budget, healthcare cost savings from adoption of a healthcare management program, such as that described herein, may partially, or completely mitigate the costs of the healthcare management program, and may further result in surplus savings to the employer over time. The employee composition of a particular employer may also affect the particular incentives and health management programs offered; for instance, if a particular workforce has an atypical distribution of age, gender, particular employee health conditions or the like, specific healthcare programs may be provided that target or focus on those ages, genders, particular employee health conditions or the like. Workplace culture may include, but is not limited to, corporate leadership, employee support practices, and/or the physical environment of the workplace, all of which may affect achievable health goals and incentives offered in the healthcare management program plan. In some embodiments, for example, some workplaces may have a strong team “competition” culture, and incentive and health management programs may be designed to incorporate employee teams and competitions.

Based on information received in step 701 or from other sources, it can be determined what healthcare programs, coaching, or other health-related tasks the employer would like to include or promote, as shown in step 703. A variety of healthcare programs, coaching, or other health-related tasks can be provided and may include at least the healthcare programs, coaching, or other health-related tasks previously described, in detail, herein. As alluded to above, the goals, size, budget, employee composition, and/or culture of the employer, or other relevant information may be used to help select or determine what healthcare programs, coaching, or other health-related tasks the employer would like to include or promote.

Similarly, as shown in step 705, the amount and/or type of incentive the employer would like to provide for participation or completion in each healthcare program, coaching, or other health-related task, and/or for improved health metrics, etc. can be determined. A variety of incentives amounts or types may be provided and may include at least the incentive amounts or types previously described, in detail, herein As indicated above, the goals, size, budget, employee composition, and/or culture of the employer, or other relevant information may be used to help select or determine the amount and/or type of incentive the employer would like to provide. The amount or type of incentives offered may also be tailored to achieve a desired amount of employee participation. Too low of an employee participation level may result in too little healthcare savings to the employer, and too high of an employee participation level may result in incentives exceeding the budgeted amount provided for incentive programs. Higher or more valuable incentive amounts or types may encourage more participation.

Referring to steps 707 and 709, based on the information from steps 701, 703, and 705 or other information, a healthcare management program plan and budget may be modeled at one or more example employee participation levels 707, and the model may be adjusted to achieve the desired plan and/or budget 709. In some embodiments, a healthcare management program plan and budget may initially be modeled based on factors such as, but not limited to, assumptions or estimates of employee participation, incentive budget, and the cost of health programs. In some embodiments, the model may be dynamically modified before or during operation of the healthcare management program.

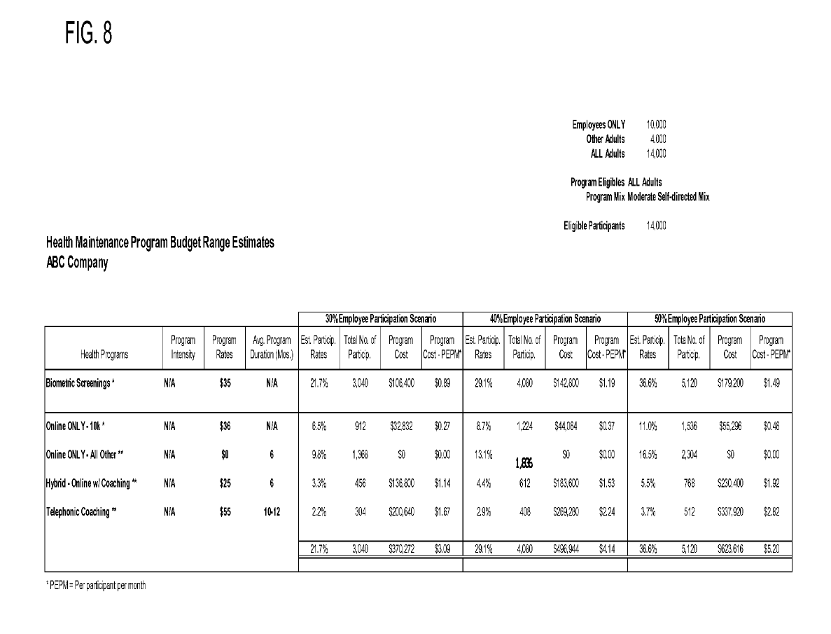

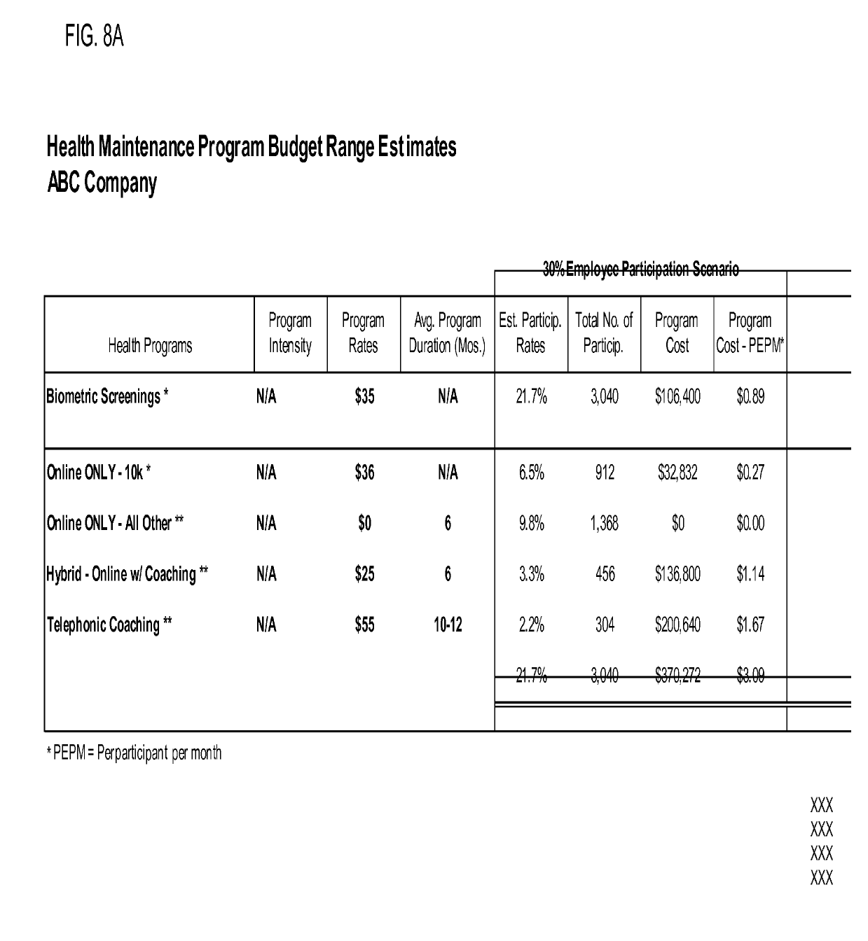

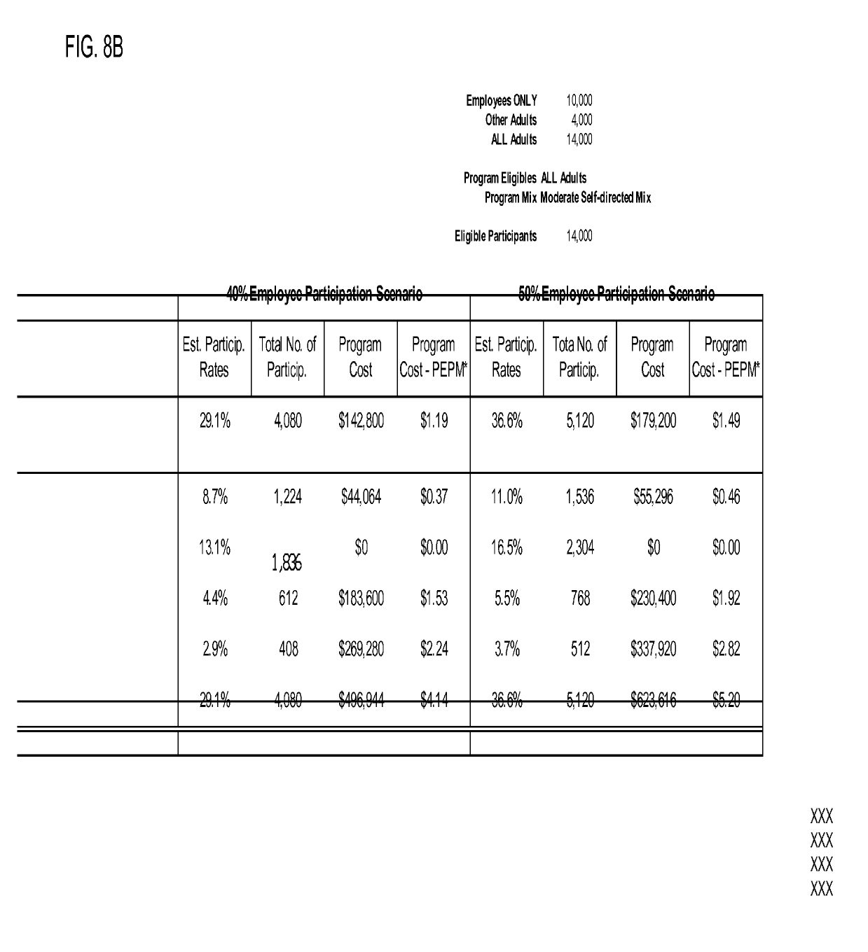

FIG. 8 illustrates an example modeled healthcare management program plan and budget for healthcare programs 800 for the fictional company “ABC Company.” The modeled plan and budget 800 the offering of four different types of health programs (i.e., biometric screenings, online only programs, hybrid programs, and telephone coaching programs), each with an example associated program rate ranging from $0-$55. Each employee participating in a health management program may be associated with certain costs, such as but not limited to, incentives used or costs enrolling in health programs. Similarly, some health programs, such as individualized coaching, may be more expensive than others, such as on-line coaching programs or self-guided coaching programs. The plan and budget has been modeled for three example employee participation levels (i.e., 30%, 40%, and 50%). Because people other than employees may be covered under the employer's healthcare, such as but not limited to, spouses and dependents of the employees, an employee participation level may translate into a lower overall participation level. For example, as shown in FIG. 8, a 30% employee participation level may translate into a 21.7% overall participation rate. Other estimates may be used for determining participation level. Based on each estimated employee participation level, the cost 803 for each healthcare program type may be modeled. While only employee participation levels of 30%, 40%, and 50% are shown modeled in FIG. 8, it is recognized that other levels of employee participation can be modeled. Similarly, while FIG. 8 illustrates a model plan and budget for healthcare programs 800, other costs may be modeled including, but not limited to, the incentives programs, types, and amounts, the initial or start-up costs, and/or the savings to the employer (e.g., over time) due to participation in the various embodiments of a healthcare management program described herein. For example, as part of a model, an estimated incentive payout per employee can be determined based on assumptions or estimates of employee participation. This can allow an employer to optimize its budget to help employees and at the same time achieve its goals of health cost reduction. In one embodiment, the model may be used to predict the effect of various levels of employee participation and the overall cost of the program. In one embodiment, the model or data being modeled may be adjusted, and in some embodiments, adjusted in generally real-time, as shown in step 709, to allow for employers to predict and budget for health management costs. That is, the estimates of employee participation, number or types of health programs or incentives offered, etc., may each be adjusted to determine the resulting healthcare management program plan and budget for a particular employer.

Referring now to step 711, in one embodiment, employee participation models can be dynamically and/or iteratively updated and made more accurate with, for example, real-world or actual data, including but not limited to, actual data related to employee participation, healthcare programs used or not used, incentives paid out, goals reached, costs, pilot studies from the workplace being modeled, etc. Further, in some embodiments, a healthcare management program plan and budget may only be partially defined at the onset of a health management plan, for example, only including incentives for completing HRAs, health screening, and/or enrolling in the plan. Other portions of the healthcare management program plan and budget, such as health programs and incentives for achieving healthcare goals, can be more defined after data from HRAs and individualized health management map building is obtained and analyzed to identify, for example but not limited to, the overall severity of risk factors in the employee population or overall employee motivation, i.e., how many employees or a groups of employees are willing to engage in health programs and who are most likely to use an incentive to modify their behavior. Accordingly, for example, incentives can be increased in amount to encourage at-risk populations to participate, or incentives may be lowered in situations where an employee population is already highly motivated.

Further, in one embodiment, a healthcare management program plan and budget may be dynamically updated, for example periodically, such as quarterly, annually, or at any other suitable interval. The healthcare management program plan and budget may be evaluated to determine if it is meeting the goals and budget of an employer. Depending on the analysis of the evaluation, an employer may reconfigure the healthcare management program plan and budget so the program more closely meets employer goals and budget.

Further, in some embodiments, one or more reports may be generated, after a health assessment of participating employees and/or at suitable intervals, such as yearly, detailing factors that most directly affect overall employee health. These reports may allow the future direction of an employee population's overall health and health behavior to be strategically shaped to allow for effective cost reduction and employee health gains. Reports may continue to be generated at intervals throughout the life of a health management program for an employer. Examples of types of reports that may be generated include, but are not limited to, assessment reports, activity reports, or results reports. A assessment report may be used to provide a health baseline to measure further health progress or assessment reports against. An assessment report may support employer health and overall cost goal setting, population health and lifestyle risk analyses, and potential financial impacts of over overall employee population health. An activity report may be used monitor employee engagement and behavior change, capture activity measures, such as overall change in health metrics, and/or assess health program adoption to enable adjustments to improve long-term program and service impact. A results report may be used to measure health program outcomes, overall success of a health management program, and/or provide a measure of the financial impact of a health management program. It is recognized that other types of suitable reports may be generated containing any type of suitable or relevant information for allowing the employer to monitor the healthcare management program or the employee to monitor their participation and/or progress in the healthcare management program. Reports may be generated quarterly, annually, or at any other suitable interval, or on demand.

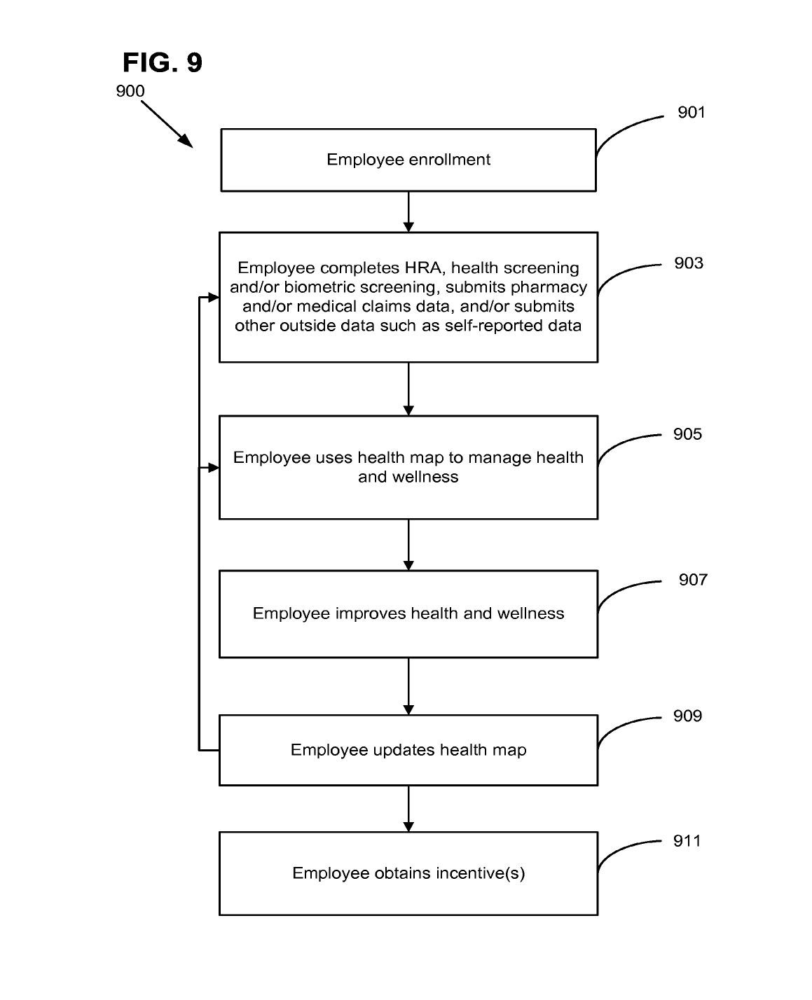

A method of using an incentive-based, consumer-owned healthcare services and management program by an employee or other individual 900 is illustrated in FIG. 9. The method may include employee enrollment in step 901, completing a HRA, health screening and/or biometric screening, submitting pharmacy and/or medical claims data, and/or submitting other data, such as self-reported data in step 903, using a health management map to manage health and wellness in step 905, improving health and wellness in step 907, updating the data in the health management map in step 909, and obtaining one or more incentives in step 911. While illustrated as having steps 901, 903, 905, 907, 909, and 911, it is recognized that not every step is required and that additional steps may be included. Similarly, steps 901, 903, 905, 907, 909, and 911 do not need to be performed in the order shown, and some steps may be performed prior to, or later than, illustrated in FIG. 9. One or more steps of the method of using an incentive-based, consumer-owned healthcare services and management program by an employee or other individual 900 may be performed using a computing system environment, such as system environment 225, and particularly may be performed using computer 226 or server 246 or other suitable computers or computing devices.

Referring to step 901, an employee or other individual may begin using an incentive-based, consumer-owned healthcare services and management program by enrolling in, signing-up for, etc. the program. In some embodiments, the employee may be enrolled automatically simply by being an employee or otherwise associated with an employer or other entity employing the incentive-based, consumer-owned healthcare services and management program. In other embodiments, the employee may be required to take the initiative to enroll in the program.

Referring to step 903, after enrollment, or as part of the enrollment process, an employee may complete a HRA, health screening and/or biometric screening, submit pharmacy and/or medical claims data, and/or submit other data, such as self-reported data related to their health or wellness. The details of each of these have been described in detail above.

Referring to step 905, the employee can use a health management map, as described in detail above, to manage the employee's health or wellness. For example, the employee may use the health management map to view data related to their HRA, health screening and/or biometric screening, pharmacy and/or medical claims data, and/or other data related to their health or wellness. Additionally, the employee may use the health management map to review, enroll in, and use a variety of healthcare programs, coaching, or other health-related tasks, such as but not limited to at least the healthcare programs, coaching, or other health-related tasks previously described, in detail, herein. Other ways the health management map may be used by the employee will be recognized based on the detailed description of the health management map previously provided herein.

In step 907, the employee may actively improve his/her health or wellness, for example by using information provided in the health management map and/or through use of healthcare programs, coaching, or other health-related tasks, or simply by taking better care of his/herself. Improving one's health or wellness can include a variety of different things, including but not limited to, improved biometrics, removing a condition or conditions, lowering the severity of a condition or conditions, becoming more active, feeling healthier or otherwise emotionally healthier, etc.

As the employee's health or wellness improves, the employee may update the data in the health management map accordingly in step 909. In some instances, the employee may enter data directly into the health management map in order to update the status of his/her health or wellness. In other embodiments, the employee may need to use another conduit to update the health management map, such as but not limited to, a nurse, doctor, or other health provider, or may need to provide proof of the updated status of the increased health or wellness. In some instances, the employee may not be required to do anything, and the health management map may be automatically updated for them, for example by a nurse, doctor, or other health provider, the employer, administer of a healthcare program or coaching, etc. or automatically by the system based on data input to the system, such as but not limited to data relating to improved biometrics.

In some embodiments, the employee may continually use the health management map to manage his/her health or wellness, improve his/her health or wellness, and update the health management map, as shown in FIG. 9. In some embodiments, the employee may periodically, such as but not limited to, yearly, complete a further or updated HRA, health screening and/or biometric screening, submit new pharmacy and/or medical claims data, and/or submit other data, such as updated self-reported data related to their health or wellness. Such updated data may be used to efficiently update the employee's health management map and monitor the employee's progress. In some embodiments, the updated HRA, health screening and/or biometric screening, pharmacy and/or medical claims data, and/or other data may be used to verify the employee has improved health and wellness.

Referring now to step 911, in one embodiment, based on the improved health and wellness of the employee and/or the information used to update the health management map, the employee can obtain one or more incentives, such as the incentives described in detail above.

Although the present invention has been described with reference to preferred embodiments, persons skilled in the art will recognize that changes may be made in form and detail without departing from the spirit and scope of the invention.

We claim:

1. A system for developing a health management map for a user, the system comprising:
a computer configured to:
receive first data related to one or more health conditions or lifestyle behaviors for the user; and
develop an interactive health management map, accessible over a network, for the user based on the first data, wherein the health management map includes an integration of tools available for use by the user to monitor and manage the user's health or well-being.

2. The system of claim 1, wherein the tools are provided by one or more product or service providers.

3. The system of claim 2, wherein the computer is further configured to store data relating to the health management map in a computer accessible storage device accessible by each of the one or more product or service providers.

4. The system of claim 2, wherein the tools of the health management map include information relating to a personal health score for the user.

5. The system of claim 2, wherein the tools of the health management map include information relating to incentive details for the user.

6. The system of claim 2, wherein the tools of the health management map include information relating to a personal health report for the user, the personal health report at least one of storing, tracking, or monitoring the health statistics of the user.

7. The system of claim 2, wherein the tools of the health management map include information relating to recommended care for the user.

8. The system of claim 7, wherein the recommended care is specific to the user.

9. The system of claim 2, wherein the tools of the health management map include information relating to a health program available to the user.

10. The system of claim 7, wherein the health program available to the user is specific to the user.

11. The system of claim 8, wherein the computer is further configured to receive second data related to an updated health condition or lifestyle behavior for the user.

12. The system of claim 11, wherein the computer is further configured to update the health management map based on the second data.

13. The system of claim 12, wherein updating the health management map comprises updating the tools available for use by the user.

14. A system for developing an incentive-based healthcare program comprising:
a computer configured to:
receive first data comprising budget information for the program; and
develop a program for providing incentives to a user enrolled in the program to improve the user's health or well-being, the incentives based on the first data.

15. The system of claim 14, wherein the first data further comprises data relating to one or more of goals for the program, goals for the users in the program, number of users in the program, composition of the users in the program, or culture of the users in the program.

16. The system of claim 14, wherein the computer is further configured to receive second data related to updated budget information for the program.

17. The system of claim 16, wherein the computer is further configured to update the program based on the second data.

18. The system of claim 17, wherein updating the program comprises updating the incentives based on the second data.

19. The system of claim 14, wherein the computer is further configured to receive information relating to healthcare programs, coaching, or other health-related tasks that are to be included in the program.

20. The system of claim 19, wherein the computer is further configured to receive information relating to the amount of incentive to provide for participation in a healthcare program, coaching, or other health-related task.

21. The system of claim 14, wherein the computer is further configured to receive information relating to the amount of incentive to provide for improved health or well-being of the user.

22. The system of claim 14, wherein the computer is further configured to model the program at an example user participation level.

23. The system of claim 22, wherein the computer is further configured to adjust the model based on updated data.

24. The system of claim 14, wherein the computer is further configured to update the program based on actual user data.

25. A system for healthcare services having a behavior-based financing framework, the system comprising:
a computer configured to create an incentive budget;
means for acquiring and understanding an individual's health status;
an individualized health management map focusing on the individual's modifiable health conditions and lifestyle behaviors determined from the acquired health status and providing means for tracking the individual's progress toward improved health; and
an incentive program conforming to the incentive budget for providing incentives for the individual to engage in their health and well-being.

26. The system of claim 25, wherein the incentive program is configurable and evolvable.

27. The system of claim 26, wherein the incentive program is configurable and evolvable based on increasing individual participation.

28. The system of claim 26, wherein the incentive program is configurable and evolvable based on changes to the incentive budget.

29. The system of claim 25, wherein the incentives comprise a reduction in healthcare premiums for the individual.
